(19) United States
(12) Patent Application Publication
(10) Pub. No.: US 2021/0347115 A1
(43) Pub. Date: Nov. 11, 2021

(54) SYSTEMS AND METHODS OF PRINTING WITH FIBER-REINFORCED MATERIALS

(71) Applicant: MAKE COMPOSITES, INC., Burlington, MA (US)

(72) Inventors: Konstantinos A. Fetfatsidis, Tewksbury, MA (US); Michael T. Kelly, Wilmington, MA (US); Tony James Kayhart, Cambridge, MA (US); Scott Benton Foret, Somerville, MA (US)

(73) Assignee: MAKE COMPOSITES, INC., Burlington (US)

(21) Appl. No.: 17/284,099

(22) PCT Filed: Oct. 25, 2019
(86) PCT No.: PCT/US2019/058226

§ 371 Date: Apr. 9, 2021

Related U.S. Application Data
(60) Provisional application No. 62/750,399, filed on Oct. 25, 2018.
(60) Provisional application No. 62/750,404, filed on Oct. 25, 2018.
(60) Provisional application No. 62/829,638, filed on Apr. 4, 2019.
(60) Provisional application No. 62/829,306, filed on Apr. 4, 2019.
(60) Provisional application No. 62/829,445, filed on Apr. 4, 2019.
(60) Provisional application No. 62/838,210, filed on Apr. 24, 2019.
(60) Provisional application No. 62/838,906, filed on Apr. 25, 2019.
(60) Provisional application No. 62/838,921, filed on Apr. 25, 2019.

(51) Int. Cl. B29C 64/188; B29C 64/165; B29C 64/218; B29C 64/118; B29C 64/295; B29C 64/321; B29C 64/393; B29C 64/40; B33Y 10/00; B33Y 30/00; B33Y 70/10; B33Y 50/02; B33Y 40/20

(52) U.S. Cl. CPC B29C 64/188; B29C 64/165; B29C 64/218; B29C 64/118; B29C 64/295; B29C 64/321; B33Y 40/20; B29C 64/40; B33Y 10/00; B33Y 30/00; B33Y 70/10; B33Y 50/02; B29C 64/393

(57) ABSTRACT

In one aspect, the disclosure relates to a method of fabricating a three-dimensional object. The method includes transporting a first material, in a first state, the first material comprising a thermoplastic matrix and M reinforcing fibers, wherein the first material has a first cross-sectional profile; depositing, heating, and consolidating a segment of the first material such that it is placed in a second state having a second cross-sectional profile; and repeating the foregoing steps until a unitary composite object has been formed by M segments of the first material. In one embodiment, consolidation is performed to achieve a porosity of less than about 2%. In one embodiment, a ratio of volume of the reinforcing fibers to matrix first material ranges from about 0.5 to about 0.7.

This application claims priority to and the benefit of U.S. provisional patent application No. 62/750,399, filed on Oct. 25, 2018 and entitled “Systems and Methods for Heating During 3D Printing Processes,” U.S. provisional patent application No. 62/750,404, filed on Oct. 25, 2018 and entitled “Systems and Methods for Pressure Control During 3D Printing Processes,” U.S. provisional patent application No. 62/829,638, filed on Apr. 4, 2019 and entitled “Systems and Method of Contactless Heating for Composite Fabrication,” U.S. provisional patent application No. 62/829,306, filed on Apr. 4, 2019 and entitled “Systems and Methods of Fabricating Composite Based Workpieces and Increasing Structural Integrity Thereof,” U.S. provisional patent application No. 62/838,906, filed on Apr. 25, 2019 and entitled “Heating and Cooling Systems and Methods for Composite Part Fabrication,” U.S. provisional patent application No. 62/829,445, filed on Apr. 4, 2019 and entitled “Systems and Methods of Printing with Fiber-Reinforced Materials,” U.S. provisional patent application No. 62/838,921, filed on Apr. 25, 2019 and entitled “Multiple Applicator System for Composite Parts,” and U.S. provisional patent application No. 62/838,210, filed on Apr. 24, 2019 and entitled “Systems and Methods of Composite Tape Placement Using Integrated Spool and Tape Head”, the disclosures of all of the foregoing are herein incorporated by reference in their entirety.

### BACKGROUND

Designing and building specialized manufacturing systems and facilities is expensive. Further, creating custom tooling for new products is also a costly endeavor. Clearly there are numerous barriers facing the release of new products that can improve the quality of our lives. This issue applies to final product designs, but also serves as an impediment to prototyping and manufacturing new products.

The advancement of medicine, sports, aviation, safety equipment, and other industries and technologies can all benefit from rapid prototyping and manufacture of new products. To that end, various technologies are undergoing further development to facilitate rapid prototyping and manufacturing parts having enhanced strength and weight characteristics. Advances in computer added design, three-dimensional printing, such as Fused Filament Fabrication (FFF), and others are creating new design options and making new technologies available to engineers.

Unfortunately, some of these technologies are difficult to combine or otherwise use in an integrated fashion. The use of consumables that need to be input in a prescribed manner can result in snags, breaks, and other unwanted events which can delay a given fabrication session. Further, the use of various heat sources and mechanical assemblies in close proximity to each other can cause deleterious effects as a result of waste heat and unwanted heat transfer. In addition, obtaining the requisite levels of heating and doing so on a commercial basis is difficult and often those heat sources can have shortened operational lives or otherwise direct heat to subsystems for which it is detrimental.

Further, prototyping or manufacturing parts using polymer materials and associated printing techniques often result in parts that lack the necessary structural integrity for a given application. This can be due to weaknesses in the material itself or the presence of unwanted voids, gaps or bubbles. The present disclosure addresses the foregoing needs and others.

### SUMMARY

In one aspect, the disclosure relates to a method of fabricating a three-dimensional object. The method includes transporting a first material, in a first state, the first material comprising a thermoplastic matrix and M reinforcing fibers, wherein the first material has a first cross-sectional profile; depositing, heating, and consolidating a segment of the first material such that it is placed in a second state having a second cross-sectional profile; and repeating the foregoing steps until a unitary composite object has been formed by M segments of the first material.

In one embodiment, voids or channels are limited by placing the M segments of first material such that the first and second cross-sectional profiles are majority of M segments are substantially identical. In one embodiment, consolidation is performed to achieve a porosity of less than about 2%. In one embodiment, a ratio of volume of the reinforcing fibers to matrix first material ranges from about 0.5 to about 0.7. In one embodiment, M is less than about 300.

In one aspect, the method may further include selecting a first temperature to be X % greater than a melting point temperature of a second material; heating the second material to the first temperature; and delivering, using a first nozzle, the heated second material to a print bed. In one embodiment, the diameter of the first nozzle ranges from about 0.2 mm to about 6 mm. In one embodiment, X % ranges from about 10% to about 30%. In one embodiment, consolidating the segment of the first material is performed using a roller, wherein the roller is positioned to receive heat from a heat source upon a first side of the roller, the method further comprising rotating the roller such that a second side is positioned to consolidate a segment of the first material. In one embodiment, the second side of the roller is cooler than the first side of the roller when the second side initially contacts the first material.

In one aspect, the method may further include forming, with an FFF-based applicator, a first support that includes one or more layers of a second material, the first support defines a first surface; and forming, with an FFF-based applicator, a second support that includes one or more layers of a second material, the second support defines a top surface, wherein the unitary composite object is sandwiched between the first support and the second support. In one embodiment, the first material is transported from a spool, through a bore and out from an applicator head, wherein the spool rotates about a spindle and about a first axis. The method may further include synchronizing rotation of spool and applicator head about the first axis.

In one aspect, the second material is selected to resist deformation from consolidation of the first material relative to the second material, wherein a physical property measured in a first direction relative to the second material has a value that differs by an amount greater than P % when compared to the same physical property measured in a second direction relative to the second material. In one embodiment, P is greater than about 10. In one embodiment, a physical property measured in a first direction relative to the first material has a value that differs by an amount greater than Q % when compared to the same physical property measured in a second direction relative to the first material. In one embodiment, Q is greater than about 10. In one embodiment, depositing the segment of the first material of is performed relative to a print bed that receives one or more segments of the first material.

In one aspect, the method may further include measuring changes in one or more of a consolidation force or a consolidation pressure relative to consolidation of first material by a roller. In one aspect, the method may further include adjusting position of roller or height of print bed relative to a region of the first material in response to measured consolidation force or a consolidation pressure deviating from a range of acceptable values. In one aspect, the method may further include adjusting position of roller or height of print bed to prevent gaps between a first segment of deposited first material and a second segment of the first material about to be deposited relative to the first segment.

In part, the disclosure relates to composite part fabrication system. The system includes a housing; a print bed disposed within the housing; a gantry disposed above the print bed; a rotatable print head; and a rotatable prepreg thermoplastic tape deposition head comprising a first heat source and one or more compaction rollers, the deposition head translatable relative to print bed using the gantry.

In one aspect, the disclosure relates to a method of fabricating a part using a three dimensional printer comprising a print head including a compacting roller, a pressure sensor, and a print bed. The method includes providing thermoplastic filament including chopped fiber, extruding the thermoplastic filament onto the print bed, using the print head from the three dimensional printer, to fabricate at least a portion of the part, upon extruding an amount of the thermoplastic filament, applying a compacting force using the compacting roller, and moving the print head or the print bed to maintain an amount of pressure between the print head and the print bed.

In one aspect, the disclosure relates to a method of fabricating a part using a three dimensional printer comprising a print head including a compacting roller, a pressure sensor, and a print bed. The method includes providing thermoplastic filament including chopped fiber, extruding the thermoplastic filament onto the print bed, using the print head from the three dimensional printer, to fabricate at least a portion of the part, determining an amount of pressure between the print head and the print bed; and upon a determination that the amount of pressure between the print head and the print bed exceed an upper value, modifying the position of the print bed to reduce the amount of pressure. In one embodiment the upper value or range of values is selected from a range of from about 50 kPa to about 300 kPa. In one embodiment the upper value or range of values is selected from greater than about 100 kPa and less than about 1000 kPa. In one embodiment, the consolidation step is performed in between about 1 to about 100 milliseconds. In one embodiment, the consolidation step is performed in between about 10 to about 100 milliseconds. In one embodiment, the consolidation step is performed in between about 20 to about 200 milliseconds.

### Contactless Heating

In part, the disclosure relates to a heat delivery apparatus. The apparatus may include a plurality of light sources; a housing defining a geometric profile, wherein each of the plurality of light sources are arranged relative to the geometric profile, wherein the housing arranges the light sources into an array; and a printed circuit board (PCB) disposed relative to the housing, wherein the PCB provides an interface for each of the plurality of light sources; wherein geometric profile positions each of the plurality of light sources to define a single focal point for the matrix of light sources; and wherein each of the plurality of light sources is individually addressable through each interface of the PCB. In one embodiment, each light source is an infrared (IR) light emitting diode (LED). In one embodiment, the housing further includes one or more apertures for mounting the housing to a surface. In one embodiment, the housing is a heat sync for the plurality of IR LEDs. In one embodiment, the housing includes liquid cooling to remove heat from the PCB and one or more of the IR LEDs. In one embodiment, the geometric profile is concave or convex. In one embodiment, the apparatus further includes one or more reflectors and a wave guide to receive light from the plurality of light sources and direct the light to a target region, wherein the reflectors are positioned relative to one or more surfaces of waveguide to redirect light to the target region.

In one embodiment, the arrangement of light sources is symmetric in the array. In one embodiment, the offset distance of light sources varies relative to the geometric profile. In one embodiment, the apparatus further includes a print head, the housing disposed relative to the print head, wherein the focus is to a zone through which composite tape is transported. In one embodiment, the apparatus further includes a cooling subsystem, wherein the cooling subsystem is disposed adjacent the housing. In one embodiment, the zone includes a nip region. In one embodiment, the apparatus further includes a controller, wherein the control is programmed to regulate print speed such that a first print speed increases temperature at a target region and a second print speed decreases temperature at a target region, wherein the first print speed is less than the second print speed.

In part, the disclosure relates to a method of applying a polymer material that includes reinforcing fibers. The includes one or more of laying down one or more portions of prepreg tape; energizing one or more light sources in an array of light sources; focusing light from the array to one or more regions of the prepreg tape such that one or more regions of tape are heated thereby. In one embodiment, a first temperature is generated at focal point by activating, individually, one or more of the light sources disposed within the array. In one embodiment, the light source is an IR LED. In one embodiment, the method further includes analyzing the configuration of materials placed within a target area. In one embodiment, the method further includes monitoring one or more locations in printing system for temperature changes and regulating one or more light sources in response to changes therein. In one embodiment, the method further includes directing light to surface of tape using a reflector; and receiving scattered light from reflector at a temperature sensor.

### Heating and Cooling Subsystem Features

In part, the disclosure relates to methods and systems form managing heat transfer using various techniques and subsystems as part of a 3D printing and/or automated fiber placement system that operates within housing, one or more zones, such as temperature controlled zones, or otherwise has components collocated relative to each either in which the heat from one system negatively impacts the operation of another system. Further, the systems and methods disclosed herein improve part production by mitigating one or more unwanted heat transfers.

In one aspect, the disclosure relates to a method of fabricating a part. The method includes heating, via a heat source of an applicator, a portion of polymer-based tape at a first target region, wherein first target region is bounded by previously laid down tape or a build plate; placing the portion of the plurality of polymer material on the build plate or the previously laid down tape; detecting, using a detector, a temperature at the target region; determining that the temperature has deviated from a threshold temperature; and triggering an action in response to deviating from threshold temperature range.

In one embodiment, the action is signaling an alarm. In one embodiment, the action is activating a cooling module to reduce the temperature at the target region. In one embodiment, the action is regulating heat source of applicator positioned relative to heat source. In one embodiment, the first target region is proximate to a tape applicator. In one embodiment, the temperature is a temperature range, wherein the temperature range is from about 180° C. to about 450° C. In one embodiment, the method further includes heating the build plate to a temperature that ranges from about 80° C. to about 200° C. In one embodiment, the method further includes transporting coolant through a slip ring to cool one or more components of the applicator. In one embodiment, the method further includes monitoring temperature in second target zone disposed within a housing; and activating a cooling system to lower temperature in second target zone when temperature is above a zone temperature threshold. In one embodiment, the zone threshold is about 60° C.

In one aspect, the disclosure relates to a 3D part fabrication system. The system includes a housing; a build plate slidably disposed relative to the housing along one or more directions; a prepreg applicator that includes a heat source, the applicator disposed within the housing; a temperature sensor disposed within the housing; a cooling module in electrical communication with the sensor constructed and configured to cool one or more zones disposed within the housing; an electrical control system in communication with the sensor and the cooling module.

In one embodiment, the system further includes computer-executable logic, encoded in memory electrical control system, for executing heat management in the 3D printing system, wherein the computer-executable program logic is configured for the execution of: heating, via the applicator, prepreg tape; sensing, using temperature sensor, whether a temperature in one or more zones has exceeded a limit; upon a determination that the limit is exceeded, activating the cooling module to reduce the temperature of one or more zones.

In one embodiment, the computer-executable program logic is further configured for the execution of: logging temperature values and storing them to provide diagnostic information for fabricated parts. In one embodiment, the cooling module uses a cooling dock to vent heat from the applicator. In one embodiment, the cooling module uses coolant piped in through a slip ring to cool the applicator.

In various embodiments, different electrical subsystems and device that are part of a given fabrication system embodiment disclosed herein are cooled or transitioned from higher temperature zones to manage temperature of such subsystems and devices to remain below about 60° C. Exemplary devices and subsystem for which this applies may include, without limitation, a tape head and an FFF head, except at the nip region (tape head) and nozzle (FFF head) or other regions in which higher temperature facilitate changes to consumable being used to make the part. The nip region, nozzle region and other similar regions typically have higher temperatures such that polymer-based material being processed can be melted, bonded, made malleable or otherwise transformed for a given heat-based fabrication/material application step.

In part, the disclosure relates to a tape applicator for depositing and compacting tape. The tape applicator comprising a compaction roller; a heat source oriented towards a nip region proximate to the compaction roller; and a temperature sensor configured to detect a temperature of the nip region. In one embodiment, the tape applicator includes a lens disposed between the heat source and a focus of the lens, wherein the lens directs light from the heat source towards a nip region proximate to the compaction roller.

In part, the disclosure relates to a method of fabricating a part using a system that includes an applicator and a print bed, wherein the applicator includes a compaction roller, a heating element, and a temperature sensor. The method may include applying heat from the heating element to the compaction roller and a thermoplastic tape; depositing the thermoplastic tape from the applicator onto the print bed or a previously deposited segment of compacted thermoplastic tape; compacting the thermoplastic tape using the compaction roller; determining a temperature in a region using the temperature sensor; and managing the heat from the heating element based on the determined temperature.

Printing/Manufacturing with Fiber-Reinforced Materials Features

In part, the disclosure relates to a combination composite part. The part includes a first support including one or more layers of a polymer material, the first support defines a first surface. The first support may also include a second support including one or more layers of the polymer material, the second support defines a top surface. The first support may also include a unitary structural core sandwiched between the first support and the second support, the unitary structural core including multiple layers of consolidated segments of prepreg tape, the prepreg tape including a matrix material and M reinforcing fibers spanning length of each consolidated segment. Alternatively, a part formed from prepreg tape or a matrix with reinforcing fibers disposed in a polymer matrix or other matrix can also be fabricated and other parts as disclosed herein. One or more parts can include or be formed to satisfy various manufacturing tolerances and parameters, including each of those disclosed herein and combinations thereof.

Various implementations of combination composite part may include one or more of the following features. In one embodiment, the porosity of unitary structural core is less than about 2%. In one embodiment, the one or more layers of the polymer material include compacted polymer filaments. In one embodiment, the unitary structure core has a thickness T and may further include one or more stacks of the polymer material, the one or more stacks adjacent and attached to a plurality of consolidated segments along the thickness. The combination composite part the one or more stacks sandwiched between and integral with the first support and the second support. The combination composite part may further include a third support including one or more layers of a polymer material, the third support defining a side surface. In one embodiment, the first surface, the second surface, and the third surface define at least a partial cover of the unitary structural core. In one embodiment, T ranges from about 0.1 mm to about 250 mm. In one embodiment, T ranges from about 1 mm to about 100 mm. In one embodiment, T ranges from about 5 mm to about 5 mm. In one embodiment, T is less than about 100 mm.

In one embodiment, the combination composite part may further include a first interface zone between a first region of the unitary structural core and the first support, wherein the matrix material and the polymer material are bonded, attached, or cross-linked with each other along one or more positions on or in the first interface zone. The combination composite part may further include a second interface zone between a second region of the unitary structural core and the second support, wherein the matrix material and the polymer material are bonded, attached, or cross-linked with each other along one or more positions on or in the second interface zone. In one embodiment, the width of each segment ranges from about 4 mm to about 10 mm. In one embodiment, porosity of combination composite part core is less than about 5%.

One general aspect of disclosure relates to a method of manufacturing a combination composite part. The method may include printing, using an FFF-based subsystem, a first cover surface. The method may also include depositing prepreg tape including a thermoplastic matrix and M reinforcing fibers on the first cover surface. The method may also include cutting prepreg tape to form a first prepreg tape segment. The method may also include heating one or more regions of the first prepreg tape segment. The method may also include compacting the first prepreg tape segment disposed on the first cover surface. The method may also include printing, using the FFF-base subsystem, a first boundary layer that tracks and abuts an edge of the first prepreg tape segment.

Implementations may include one or more of the following features. The method may further include repeating depositing, cutting, heating, and compacting a plurality of prepreg tape segments until a unitary structural core has been formed on the first support. In one embodiment, M ranges from about 3,000 to about 24,000. The method may further include printing, using the FFF-based subsystem, a second cover surface, wherein the first cover surface and the second cover surface are in contact with unitary structural core. The method may further include depositing a length of prepreg tape that extends beyond a boundary of the first cover surface; and cutting the length of prepreg tape such that cut end thereof is disposed within first cover surface. The method may further include printing one or more three-dimensional structures on areas of first cover surface that have not been covered with prepreg tape. In one embodiment, the heating step is performed by contactless heating of one or more prepreg tape segments.

One general aspect includes a method of reinforcing a three-dimensional printed workpiece with structural fibers. The method may include one or more of the following transporting a material, in a first state, the material including a thermoplastic matrix and M reinforcing fibers, wherein the material has a first cross-sectional profile. The method may also include depositing, heating, and consolidating a segment of the material such that it is placed in a second state having a second cross-sectional profile. The method may also include repeating the foregoing steps until a unitary composite workpiece has been formed by M segments of the material, wherein voids or channels are limited by placing the M segments of material such that the first and second cross-sectional profiles are majority of M segments are substantially identical. In one embodiment, M is less than about 1000. In one embodiment, M is less than about 750. In one embodiment, M is less than about 500. In one embodiment, M is less than about 300. In one embodiment, M is less than about 200. In one embodiment, M is less than about 100. In one embodiment, M ranges from about 10 to about 250.

Implementations of one or more methods may include one or more of the following features. The method may further include depositing the material without use of a nozzle. The method may further include depositing the material without use of a flattening agent. In one embodiment, the first cross-sectional profile is selected to avoid circular and elliptical, profiles. In one embodiment, consolidation is performed to achieve a porosity of less than about 2%. In one embodiment, the ratio of volume of the reinforcing fibers to matrix material ranges from about 0.5 to about 0.7. The method may further include printing one or more surfaces relative to the thermoplastic matrix to form a cover or partial cover relative to the unitary composite workpiece. The method may further include filling in one or more tape-free regions with a polymer material, wherein the polymer material contacts one or more regions of tape containing regions of part.

In part, the disclosure relates to a method of fabricating a three-dimensional part. The method may include one or more of sectioning the three-dimensional part into an interior region and a perimeter region; and printing layers of part incrementally using a first nozzle to deposit polymer segments in the perimeter region and a second nozzle to deposit polymer segments in the interior region, wherein polymer segments from first nozzle include less than or equal to 1,500 fibers, wherein polymer segments from second nozzle include greater than 1,500 fibers. In one embodiment, the second nozzle has a wider output port relative to the first nozzle. The method may further include heating one or more surfaces receiving the polymer segments to cause segments to spread or flatten.

The method may further include vibrating one or more surfaces receiving the polymer segments to cause segments to spread or flatten. The method may further include printing one or more polymer segments with the first nozzle or second nozzle being within a distance that ranges from about 0.03 mm to about 0.1 mm from target location for depositing the segment. The method may further include impregnating polymer matrix with one or more fibers prior to printing a polymer segment. In one embodiment, the polymer segment includes about 2000 or more continuous fibers. In one embodiment, printing layers of part incrementally using a first nozzle includes heating a polymer material to a temperature that is greater than melting point of such material by a threshold X. In one embodiment, X ranges from about 10% to about 35% of melting point of such material.

In part, the disclosure relates to a method of fabricating a three-dimensional part. The method may include selecting a first temperature to be X % greater than a melting point temperature of a first polymer material; heating the first polymer material to the first temperature; and delivering, using a first nozzle, the heated polymer material to a print bed. In one embodiment, the diameter of the first nozzle ranges from about 0.2 mm to about 6 mm. In one embodiment, X % ranges from about 10% to about 30%. In one embodiment, the distance between nozzle output and target location ranges from about 0.03 mm to about 0.1 mm. The method may further include applying heat to delivered polymer material to flatten bead formed on print bed or previously delivered polymer material. In one embodiment, the first nozzle is adjacent a second nozzle. In one embodiment, the second nozzle is adjacent a third nozzle. The method may further include applying a force to flatten delivered polymer material.

### Multiple Applicator Features

In part, the disclosure relates to a system that includes a group of modular heads, tools or applicators that can be swapped during different processing stages and stored or docked when not in use. In various embodiments, the system is configured to provide tool, head, and applicator changing capability (i.e., an ability to automatically switch or swap which head is used during certain steps of the printing process). One or more systems can be used to allow applicators, tool heads, and other devices to be coupled to a mount or other structure that can be moved through space in a controlled manner to print, scan, or otherwise move relative to a print area and parts being fabricated thereon.

In part, the disclosure relates to an applicator management system for fabricating 3D parts. The system may include a first applicator; a housing; a mount, wherein the mount is moveable in one or more directions within the housing; a build plate disposed within the housing, wherein position of build plate is adjustable in one or more directions; and an applicator changer coupled to the moveable mount; wherein the applicator changer includes a first interface to operatively engage the first applicator and a second applicator. In one embodiment, the system further includes a holding bracket mounted to the housing, wherein the holding bracket includes a plurality of receivers for storing each applicator. In one embodiment, the first applicator is a polymer-tape based applicator. In one embodiment, the system further includes the second applicator. In one embodiment, the second applicator is an FFF-based applicator. In one embodiment, the second applicator is a metal-based printing applicator.

In one embodiment, the second applicator is selected from the group consisting of an inspection applicator, a metrology applicator, a cutting applicator, a combination applicator that includes functions of two or more applicators, and a drill applicator. In one embodiment, the build plate translates along the z-axis defined by the inner perimeter of the housing. In one embodiment, the first interface is selected from the group consisting of a magnetic coupler, a ball lock, a tongue and groove system, an interference fit coupler, and an electric coupler. In one embodiment, the first interface further operatively engages a third applicator. In part, the disclosure relates to a system for constructing a three dimensional object.

The system includes an end-to-end manufacturing system; a motion gantry including a mount moveable in one or more directions defined by the motion gantry; a build plate moveably coupled relative to the motion gantry, wherein the build plate is moveable in one or more directions; and an applicator changer coupled to the mount. In one embodiment, the system includes a first applicator and a second applicator mounted to the motion gantry; and wherein the applicator changer includes an interface constructed to receive applicators.

In one embodiment, the applicator changer is constructed to receive a first applicator of a plurality of applicators, wherein the first applicator is selected from a group of applicators consisting of a tape tool head, a fused filament fabrication (FFF) tool head, a metal fabrication tool head, and a measuring tool head. In one embodiment, the applicator changer retains one or more applicators using a ball lock. In one embodiment, the applicator changer includes a pressure sensor which detects an amount of pressure exerted onto the dimensional object being constructed on the build plate. In one embodiment, the system includes a mandrel, wherein the mandrel includes a build surface that is rotatable during part fabrication. In one embodiment, the system includes a rotatable mandrel disposed in the housing. In one embodiment, the system includes a positioner suitable for translating one or more of a part and a region of the build plate

In part, the disclosure relates to a method of managing applicator usage during a fabrication process. The method includes fabricating a mold or tooling with a first applicator; docking the first applicator in an applicator dock; coupling a second applicator stored in the applicator dock to a moveable mount; and moving the second applicator according to one or more routes to form a part relative to the mold or tooling. In one embodiment, the first applicator is an FFF-based applicator or a metal fabrication applicator. In one embodiment, the second applicator is a polymer-tape based applicator that includes a plurality of reinforcing fibers.

A given system embodiment, may be used to efficiently fabricate complex composite structures made of multiple types of materials without the use of multiple different printing systems, pausing the fabrication process to manually swap heads, or fitting a large number of heads onto the motion platform (or the gantry itself) at the same time.

In some embodiments, the heads, tools, and applicators include or cooperate with subsystems to print metal parts or form metal regions such as electrical traces or other sections of a given part from a metal. Various types of metals and metal printing processes can be used.

### Integrated Spool and Tape Head Features

In part, the disclosure relates to methods and systems for managing, storing, dispensing, rotating, and directing transport of a consumable material, such a tape or filament, in a system used for fabricating a three-dimensional part. In one embodiment, the consumable material is stored on a storage device, such as a spool, and delivered using an applicator such as a print head or automated fiber-dispensing device. In one embodiment, the storage device and the applicator rotate relative to one more axes in a synchronized manner. In one embodiment, the storage device is a spool sized to receive prepreg tape that includes continuous reinforcing fibers and a matrix. In part, the disclosure relates to unitary structures that include a shared elongate member and an applicator coupled to one end and a spool coupled to another end such that the spool and applicator rotate around a shared longitudinal axis in concert.

In one aspect, the disclosure relates to a composite part fabrication system. In one embodiment, the composite part fabrication system includes a rotatable elongate member defining a first bore, the rotatable elongate member having a first end and a second end, an applicator coupled to an applicator mount, a spool mount that includes a shaft, and a spool, wherein spool is rotatably disposed on the shaft, the spool sized to receive a flexible material, wherein the applicator mount defines a first opening in communication with the first bore, wherein the spool mount defines a second opening in communication with the first bore, the spool mount coupled to the first end, the applicator mount coupled to the second end.

In one embodiment, the system further includes a slip ring defining a second bore, the rotatable elongate member rotatably disposed in the second bore. In one embodiment, the slip ring includes a cylindrical bearing. In one embodiment, the flexible material is a tape that includes a polymer matrix and a group of reinforcing fibers. In one embodiment the system further includes one or more rollers, the one or more roller rotatably attached to the spool mount, wherein flexible material contacts one or more rollers along a transport path to the applicator. In one embodiment, the first bore, the first opening, and the second opening define a portion of a transport path for the flexible material. In one embodiment, the rotatable elongate member, applicator and spool are aligned and rotatable with regard to a shared axis of rotation. In one embodiment, the system further includes a slip ring defining a third bore, the third bore positioned to receive the flexible material from the spool prior to the tape reaching the applicator.

In one embodiment, the slip ring is electrically connected to one or both of a power line and a control signal line for the applicator. In one embodiment, the elongate member rotates within the slip ring. In one embodiment, the system further includes a plurality of engagement elements, the plurality of engagement elements arranged to rotate the elongate member relative to the slip ring when linked to a rotor. In one embodiment, the system further includes a bracket attached to the slip ring. In one embodiment, the system further includes a positioner of and a releasable coupling mechanism attached to bracket, wherein releasable coupling mechanism attaches to a positioner. In one embodiment, the system further includes a linkage; and a motor including a rotor, wherein the rotor is coupled to the elongate member and rotatable therewith through the linkage. In one embodiment, the flexible material is a composite prepreg tape, wherein spool is rotatable in a direction substantially perpendicular to the shared axis of rotation. In one embodiment, the system further includes a clock spring defining a second bore, the rotatable elongate member rotatably disposed in the second bore. In one embodiment, the flexible material is a polymer filament suitable for FFF-based printing.

In a second aspect, the disclosure relates to a method of fabricating a workpiece. In one embodiment, the method includes transporting a material, in a first state, the material that includes a thermoplastic matrix and a plurality of reinforcing fibers from a spool such that the spool rotates in a first direction, depositing, heating, and consolidating a segment of the material, using an applicator in a second state, rotating the applicator one or more times in second direction, rotating the spool one or more times in the second direction, wherein rotation of applicator and spool are synchronized, repeating the foregoing steps until a unitary composite workpiece has been formed, wherein the workpiece includes the material.

In part, the disclosure relates to a composite part fabrication system. The system includes a spool, the spool storing a flexible material; a first mount/support defining a first bore a second mount/support defining a second bore; a plurality of stanchions, the plurality of stanchions sandwiched between the first mount and the second mount, wherein at least a portion of first bore is aligned with a portion of second bore to define a flexible material transport path; an applicator coupled to an applicator mount; a spool coupled to the spool mount, wherein applicator and spool are rotatably coupled to rotate together. In one embodiment, the system includes an elongate member coupled to the applicator on a first end and the spool on the second end.

Although, the disclosure relates to different aspects and embodiments, it is understood that the different aspects and embodiments disclosed herein can be integrated, combined, or used together as a combination system, or in part, as separate components, devices, and systems, as appropriate. Thus, each embodiment disclosed herein can be incorporated in each of the aspects to varying degrees as appropriate for a given implementation.

### BRIEF DESCRIPTION OF DRAWINGS

The figures are not necessarily to scale, emphasis instead generally being placed upon illustrative principles. The figures are to be considered illustrative in all aspects and are not intended to limit the disclosure, the scope of which is defined only by the claims.

FIG. 1 is schematic diagram of print head that includes a heat source in accordance with the disclosure.

FIG. 2A is a schematic diagram of a manufacturing process and system for composite material placement in accordance with an illustrative embodiment of the disclosure.

FIGS. 2B and 2C are schematic diagrams of initialization of a manufacturing process and system for composite material placement wherein certain compaction failure modes are reduced in accordance with an illustrative embodiment of the disclosure.

FIGS. 3A, 3B and 3C are schematic diagrams of print head embodiments that includes a heat source in accordance with the disclosure.

FIGS. 4A-4D are embodiments of a heat source that includes a focused array of a group of light sources accordance with the disclosure.

FIG. 5 is a schematic diagram showing the ability of a focused array to selectively target and exclude different regions of a printable or placed composite tape in accordance with the disclosure.

FIG. 6 is a schematic diagram of an embodiment of a heat source that includes a focused array of a group of light sources accordance with the disclosure.

FIG. 7 is a simplified diagram of an exemplary embodiment of a pressure sensor mounted to an applicator.

FIGS. 8A and 8B are simplified diagrams showing the effects of pressure on a material with composite fibers and a material without composite fibers, in accordance with the disclosure.

FIG. 9A shows an exemplary embodiment of a 3D printing system according to the disclosure.

FIG. 9B is a schematic diagram that shows an exemplary target region for directing thermal energy according to the disclosure.

FIG. 10 shows an alternate exemplary embodiment of a 3D printing system according to the disclosure.

FIG. 11 is a simplified illustration of a system showing potential heat sources and regions of heat management within a 3D printing system according to the disclosure.

FIG. 12 shows an exemplary embodiment of a slip ring used within a 3D printing system according to the disclosure.

FIG. 13 shows an exemplary embodiment of various cooling subsystems and related methods utilized to manage heat within a 3D printing system according to the disclosure.

FIG. 14 shows an exemplary embodiment of a cooling module for an applicator for use in a 3D printing system according to the disclosure.

FIG. 15 shows an exemplary roller embodiment suitable for use in one or more heads, tools or other components of 3D printing systems and related methods of the disclosure.

FIG. 16 shows an exemplary embodiment of various cooling systems applied to a system within a 3D printing system.

FIG. 17 shows an alternate perspective of an exemplary embodiment of a cooling module.

FIG. 18 shows an exemplary embodiment of a cooling module attached to an applicator within a 3D printing system.

FIG. 19 shows a simplified diagram a modular tool head applying prepreg tape.

FIGS. 20A and 20B show an overhead view of view of a motion gantry and tool changing elements, in accordance with an embodiment of the present disclosure.

FIG. 21 is a simplified diagram of an example embodiment of a ball lock application changer.

FIGS. 22A, 22B, and 22C show an example embodiment of a ball lock applicator changer in various positions during the locking process.

FIG. 23 is a simplified diagram of an exemplary embodiment of a subtractive processing device mounted to an applicator head.

FIG. 24 is a simplified diagram of an alternate configuration of a pressure sensor mounted to an applicator.

FIG. 25 is a simplified illustration of a modular multi-tool system fabricating using a rotating mandrel, in accordance with an embodiment of the present disclosure.

FIGS. 26A and 26B show an exemplary flow chart for the operation of a modular multi-tool system for making composite parts.

FIG. 27 is a schematic diagram showing a subsystem that includes an applicator and spool that are rotational synchronized suitable for use with a part fabrication system according to the disclosure.

FIG. 28A is a perspective view of a subsystem that includes a tape applicator and a tape spool that are rotational synchronized suitable for use with a part fabrication system according to the disclosure.

FIG. 28B shows two perspective views of subsystem of FIG. 28A at two different rotational positions according to the disclosure.

FIG. 28C shows a magnified perspective of the exemplary embodiment shown in FIG. 28B according to the disclosure.

FIG. 29A shows an exemplary embodiment of a 3D printing system using a synchronized spool and applicator subsystem according to the disclosure.

FIG. 29B shows an alternate perspective of the exemplary embodiment shown in FIG. 29A according to the disclosure.

FIGS. 30A and 30B show alternative perspectives of exemplary embodiments of a synchronized spool and applicator subsystem.

FIG. 31A shows a schematic diagram of a front of alternative arrangement for spool and applicator that includes a first and a second stanchion according to the disclosure.

FIG. 31B shows a side view of schematic diagram of FIG. 31A according to the disclosure.

FIG. 32A shows an exemplary embodiment of a combination composite or dual material part fabricated in accordance with one or more systems and methods of the disclosure.

FIG. 32B shows a magnified view of unitary core of combined composite part of FIG. 32A in accordance with an embodiment of the disclosure.

FIG. 33A shows a schematic diagram of manufacturing process and system that integrates FFF-based printing and composite material placement in accordance with an illustrative embodiment of the disclosure.

FIG. 33B is a schematic diagram showing a combination composite part and a representation of its components in accordance with the disclosure.

FIG. 34A shows a repeating structural grouping of four filaments fabricated with an FFF-based method.

FIG. 34B shows a repeating structural grouping of several filaments fabricated with an FFF-based method.

FIG. 34C shows a repeating structural grouping of several filaments that have been ironed or flattened during heating as part of an FFF-based method.

FIG. 35 shows a repeating structural grouping of two prepreg tapes stacked relative to each other as repeating element of a unitary core in accordance with an embodiment of the disclosure.

FIG. 36 is a cross sectional view of an exemplary unitary composite part formed from heated, segmented, consolidated prepreg tape in accordance with the disclosure.

FIG. 37A is plot of tensile modulus versus tensile strength for part A fabricated with FFF-based method, part B fabricated with prepreg tape based method, and other comparable parts in accordance with the disclosure.

FIG. 37B is a series of three histograms comparing Part A and Part B referenced with regard to FIG. 37A in accordance with the disclosure.

FIG. 38 is a schematic diagram of part that is fabricated with a first and second infill section using a polymer material to incremental print or form constituent layers thereof in accordance with the disclosure.

FIG. 39A is a schematic diagram that depicts a print or deposition process and related head that receives a carbon fiber and a polymer material, such as FFF-based material, and then coextrudes the received materials from a print, tape or deposition head in accordance with the disclosure.

FIG. 39B is a schematic diagram that receives multiple carbon fibers (CF) and a polymer material, such as FFF-based material, and co-extrudes the polymer material with the carbon fibers from a print, tape or deposition head in accordance with the disclosure in accordance with the disclosure.

FIG. 40 is a schematic diagram that depicts a multi-nozzle print head suitable for printing, depositing, or co-extruding polymer materials, chopped fibers, and continuous fibers in accordance with the disclosure.

### DETAILED DESCRIPTION

In particular, the disclosure is directed to solving various technical problems with nozzle-based filament deposition systems such as FFF-based systems that use polymer filaments, polymer filaments with a carbon fiber core, or simultaneous impregnate polymer filaments with a carbon fiber core as part of an FFF-based printing system. The parts produced by such systems can lack internal structural support and are also prone to unacceptably high levels of porosity. Bubbles, gaps, voids throughout a part or at repeating junctions at which layers or filaments are joined or linked in such a part can result in sheer lines that cause unexpected and undesirable failure modes. Further, in addition to the introduction of unwanted defects based on the nature of the FFF-based products using the filaments referenced above, the lack of a strong internal structure further limits the utility of certain FFF-based designs that incorporate a reinforce core. The disclosure also facilitates fabricating a composite unitary core with enhanced structural qualities on substantially simultaneous basis with core fabrication by forming a polymeric or cover relative thereto using an FFF-based system.

In general, the disclosure relates to systems and methods of fabricating composite parts or workpieces. Various embodiments address or mitigate one or more of the issues identified above. The use of composite materials in parallel or in isolation helps obviate or reduce the problems with certain FFF-based approaches. As disclosed herein, the composite parts can be formed using various systems that transform lengths of tapes or tows that include a matrix or carrier material such as a thermoplastic or thermoset material. The matrix or carrier material includes multiple reinforcing fibers such as carbon fibers, for example.

In some embodiments, the tape is pre-impregnated (prepreg) tape. As used herein, pre-impregnated tape refers to tape that includes reinforcing fibers disposed in a matrix such as a polymer material, wherein the tape includes the fibers and the matrix before the introduction of the tape to the first printer head. Prepreg tape has the benefit of the matrix and the fibers being combined such that the matrix surrounds and impregnates the fibers uniformly while the fiber are disposed in and support the matrix. Additional details relating to exemplary tapes or tows and fibers they contain that can be used with various system embodiments are disclosed in more detail herein. In general, any suitable composite tape or tow can be used with various systems and methods disclosed herein.

In one embodiment, a given part or workpiece is of a singular construction or integral such that its components or subassemblies are all a common material such as a consolidated composite tape or tow segments that contain a reinforcing fiber. These fibers can be present in a high volume fraction ratio such that 100 s to 1000 s to 10,000 s fiber strands are present in a given tape segment and span substantially all of its length.

### Use of Heating During the Printing Process

Systems and methods relating to heating during 3D printing processes are generally described. The system, in certain embodiments, includes a heat source (e.g., an infrared lamp, heater, contactless heater, hot air source, hot air blower, and others as disclosed herein) used to provide heat to contribute at least in part to the thermal consolidation of printed material (e.g., material that includes fiber-reinforced thermoplastic tape) during the fabrication of composite parts. In certain embodiments, the heat source is coupled to a printer head (e.g., a printer head for laying down fiber-reinforced thermoplastic tape to make composite structures). In certain cases, the heat source is selected for low-cost, compact size, and/or safety considerations. For example, the heat source described herein may provide greater safety than that of laser or hot gas torch heat sources. The output of the heat source may be controlled based on readings from one or more temperature sensors, providing, in some cases, feedback-control that may provide uniform, appropriate heating during the 3D printing process.

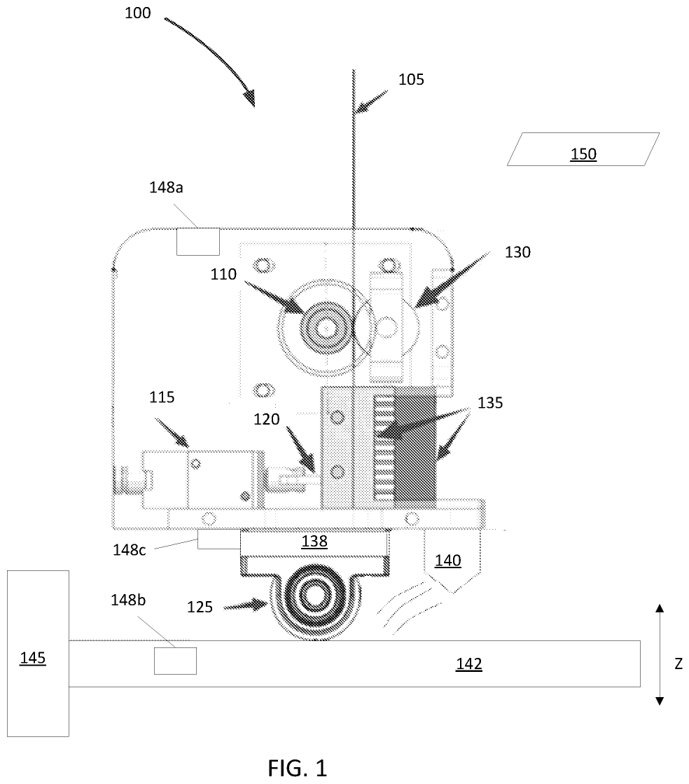

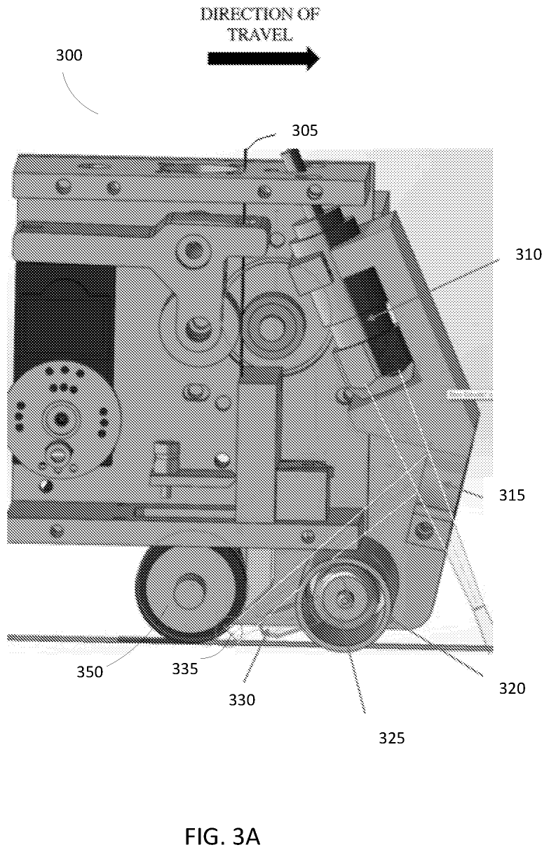

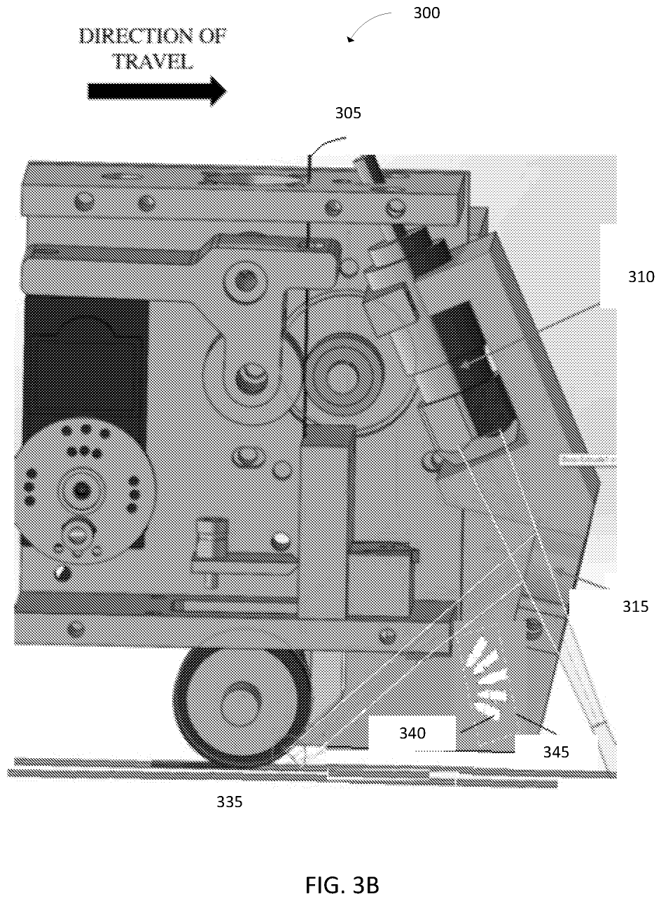

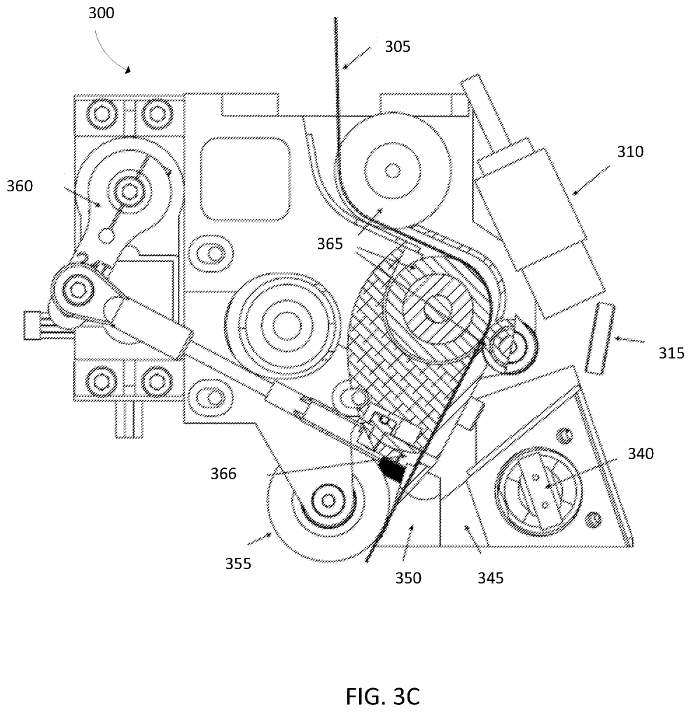

In some embodiments, a printer head is used in the 3D printing process. The printer head, in certain cases, may be the first printer head shown in FIGS. 1 and 3A and described in more detail below. The printer head may fabricate structures (e.g., composite parts) by laying down and consolidating layers of pre-impregnated fiber-reinforced thermoplastic tape. The consolidation process, in certain cases, involves the application of pressure and heat to at least partially melt the thermoplastic polymer of the tape at a nip region where one or more rollers of the printer head contacts the tape that is being laid down. FIG. 3A depicts an exemplary printer head laying down tape (e.g., during the printing process), and a nip region is indicated.

In some embodiments, a heat source/heater is used to provide heat that may be required for consolidation during the 3-D printing process. The heat source, in some embodiments, heats the printing material without necessarily coming into contact with the printing material. Various heat sources that are contactless can be used such as radiant heat, cartridge heaters, electrical heaters, torches, hot air, hot gases, and other heat sources as disclosed herein. In certain cases, a heater/heat source is coupled to the printer head. For example, the heat source may be attached to and/or integrated into the printer head. In some cases, the heat source includes a lamp. For example, FIG. 3A depicts a lamp 325 attached to an exemplary printer head 300. In some cases, the lamp 325 is an infrared lamp. Infrared lamps may, in accordance with certain embodiments, emit electromagnetic energy having wavelengths suitable for heating materials (e.g., thermoplastic polymeric materials). The lamp (e.g., the infrared lamp) may emit electronic radiation having wavelengths in the range of from 700 nm to 2000 nm. In some cases, the lamp emits electromagnetic energy that includes a wavelength of about 1000 nm. The heat source may have a volume that is small enough to allow the heat source to be easily coupled to a printer head (e.g., without providing obstruction to the printing process). In some embodiments, the heat source (e.g., lamp) has a volume suitable for being housed in a printer head.

In some embodiments, the heat source may be a lamp having a volume of less than or equal to 50 cm³, less than or equal to 40 cm³, less than or equal to 30 cm³, less than or equal to 25 cm³, less than equal to 20 cm³, less than or equal to 10 cm³, or less. The volume of the lamp may, for example, refer to the volume determined by the outer dimensions of the bulb of the lamp. In some embodiments, the heat source provides sufficient energy to efficiently heat the printing material (e.g., thermoplastic tape).

For example, in some cases, the heat source may provide enough energy to heat the printing material to a temperature of at least 150° C., at least 200° C., at least to 50° C., at least 300° C., at least 400° C., at least 450° C., and/or up to 500° C. To do so, in accordance with some but not necessarily all embodiments, the heat source may emit electromagnetic energy at a power of at least 75 W, at least 85 W, at least 90 W, at least 100 W, at least 115 W, at least 130 W, at least 150 W, and/or up to 200 W, up to 300 W, up to 400 W, or more. In certain cases, the heat source provides sufficient energy while having a relatively small volume, as described above. In some cases, infrared lamps suitable for use as the heat source can be purchased commercially.

In some embodiments, heat provided by the heat source (e.g., emitted infrared radiation) is focused. For example, electromagnetic radiation emitted by the heat source may be focused such that the intensity of the electromagnetic radiation is greater at the nip region than if the emitted electromagnetic radiation were not focused. Focusing the source of heat from the heat source (e.g., electromagnetic radiation) may, in accordance with certain embodiments, allow regions located in the vicinity of the focal plane and/or focal point of the focused radiation to heat at a faster rate and/or achieve higher temperatures than if the emitted electromagnetic radiation were not focused. In some embodiments, the system includes a focusing lens. For example, a focusing lens may be positioned between the heat source and the region to be heated e.g., the nip region. Referring again to FIG. 3A, an exemplary focusing lens 330 is shown to be attached to the printer head and positioned between the lamp in the nip region. As a result, in certain cases, electromagnetic radiation emitted from the lamp in FIG. 3A is focused by the focusing lens 330 such that the emitted electromagnetic energy is focused at or near the nip region shown.

In one embodiment, the focusing lens may be or include any suitable type of lens capable of focusing electromagnetic radiation, such as infrared radiation. For example, the focusing lens may be a spherical lens (e.g., a plano-convex lens, a biconvex lens), or in, some cases, an aspheric lens (e.g., a cylindrical lens). In some embodiments, additional optical components, such as additional lenses (e.g., focusing or collimating lenses), mirrors, and/or filters may be positioned between the heat source and the nip region (e.g., by being coupled to the printer head as well). The focusing lens may be made of any of a variety of materials suitable for focusing heat. For example, in embodiments in which the heat source is an infrared lamp, the focusing lens may include or be made of quartz (e.g., IR grade HS fused quartz). Other materials that the focusing lens may include or be made out of include, but are not limited to germanium, calcium fluoride, silicon, zinc selenide, or combinations thereof.

In some embodiments, the heat sources is positioned in a housing. The housing, in certain cases, acts as a partial enclosure for the heat source. For example, referring to FIG. 3A, the lamp 325 is shown partially enclosed by a cylindrical housing 320. The housing 320 may be coupled to the printer head 300. The housing 320 may, in accordance with certain embodiments, prevent or limit emitted heat (e.g., electromagnetic radiation emitted from the lamp) from propagating in undesirable directions. In some such cases, the use of the housing may increase the safety and/or effectiveness of the heat source during the 3-D printing process by preventing areas other than the nip region from receiving substantial heat from the heat source. In some cases, an aperture in the housing (e.g., a window in the cylindrical housing shown in FIG. 3A) is positioned such that heat radiated from the heat source in the direction of the nip region can propagate to the nip region, while heat radiated in other directions is substantially prevented from propagating.

In some, but not necessarily all embodiments, an interior surface of the housing may be reflective with respect to the heat (e.g., infrared radiation) such that the initially radiated from the heat source in directions other than that corresponding to the nip region may be reflected by the housing and redirected out of the aperture and toward the nip region, thereby increasing the efficiency of the heating system. In certain cases, a coating that is opaque with respect to the heat /thermal energy/electromagnetic radiation may be applied to the heater itself, leaving only a window located such that radiant heat emitted in the direction of the nip region may propagate. For example, in some embodiments, the heat source is infrared lamp, and a ceramic coating is applied to the infrared lamp, except for at a defined region of the lamp, creating a window in the coating. The window may be located such that infrared radiation emitted from the coated lamp can propagate only in a direction corresponding to the nip region.

In some embodiments, a sensor is included in the system. The sensor, in accordance with some embodiments, is a non-contact temperature sensor. One non-limiting example of a non-contact temperature sensor is a pyrometer. FIG. 3A shows an exemplary printer head 300 that contains a temperature sensor 310, as shown. Another non-limiting example of a non-contact temperature sensor is a thermal camera. The temperature sensor, in certain embodiments, is used to detect the temperature of the nip region during the 3D printing process. In some designs of the system, one or more mirrors, for example mirror 315, are positioned in the printer head such that energy reflected off of and/or radiated from the nip region can be directed to the temperature sensor, such that the temperature sensor need not necessarily be pointed directly at the nip region.

In accordance with certain embodiments, the use of a mirror in such a way may allow the temperature sensor to be oriented in the printer head in such a way as to allow for a compact design. In some cases, the temperature sensor is operationally coupled with the heat source such that readings from the temperature sensor may affect the output of the heat source. For example, in some cases, the temperature sensor and the lamp are both connected to a computer system that receives temperature input from the temperature sensor and, based on the temperature readings of the temperature sensor, modulates the output of the heat source (e.g., modulates the power of the lamp). In some such embodiments, a feedback loop is used such that if the temperature sensor detects a temperature at the nip region that is below a threshold value (e.g., a value suitable for heating and consolidating printing material), a signal is sent to the heat source to increase heat output.

Alternatively, if the temperature sensor detects the temperature at the nip region that is above a threshold value (e.g., a value determined to be unsafe or to cause uneven heating), a signal is sent to the heat source to decrease heat output, according to certain embodiments. Such a feedback loop may allow for more efficient and/or more uniform heating during the printing process, in accordance with certain embodiments. In various embodiments, a closed loop control system is used to regulate and/or control heat source. The control of the heat source can be regulated using sensor data correlated with temperature or temperature range in nip region or other region of interest.

In some embodiments, the system includes a first printer head. The first printer head may be the printer head that includes the heating system (e.g., contactless heating system) described above. FIG. 1 depicts an exemplary cross-sectional schematic representation of the first printer head 100, in accordance with certain embodiments. FIG. 3A depicts another schematic illustration of the first printer head, in accordance with certain embodiments. In some embodiments, the first printer head is configured to lay down tape on to a surface (e.g., a mold structure laid down by the second printer head, as described below). In some embodiments, the first printer head provides a pathway within the housing of the first printer head through which the tape can be driven. FIG. 1 shows, in accordance with certain embodiments, tape 105 (e.g., “prepreg tape”) following a pathway within the housing of the first printer head 100.

In some embodiments, the tape is pre-impregnated tape. As used herein, pre-impregnated tape (“prepreg tape”) refers to tape that includes fibers, wherein the tape includes the fibers before the introduction of the tape to a given print head or applicator. In some embodiments, the tape includes a matrix of thermoplastic material (e.g., a thermoplastic polymer). Examples of suitable thermoplastic polymers include, but are not limited to polyether ether ketone (PEEK), polyaryletherketone (PAEK), polyetherketoneketone (PEKK), polypropylene (PP), PDI, polyphenylene sulfide (PPS), polypropylene polybenzyl isocyante (PPI), and polyethylene (PE). Matrices that includes combinations of thermoplastic polymers are also possible. Any fiber suitable for the desired impregnation into a tape may be used. Examples of suitable fibers impregnated into the tape include, but are not limited to, carbon fibers (e.g., AS4, IM7, IM10), metal fibers, glass fibers (e.g., E-glass, S-glass), and Aramid fibers (e.g., Kevlar). Multiple different types of fibers may be impregnated into the tape, in accordance with certain embodiments. Suitable pre-impregnated tapes can be purchased from a variety of commercial vendors, including Toray/TenCate, Hexcel, Solvay, Barrday, or Suprem.

In some embodiments, the tape has a certain width. In some embodiments, the width is greater than or equal to 1 mm, greater than or equal to 1.5 mm, greater than or equal to 2.0 mm, greater than or equal to 2.5 mm, or greater than or equal to 3.0 mm. In some embodiments, the width of the pre-impregnated tape is less than or equal to 20.0 mm, less than or equal to 15.0 mm, less than or equal to 10.0 mm, less than or equal to 8.0, less than or equal to 6.0 mm, less than or equal to 5.0 mm, or less. Combinations of the above ranges are possible, for example, in some embodiments, the width of the tape is greater than or equal to 1 mm and less than or equal to 20.0 mm. The tape may be wound on to a spool or cassette prior to being introduced to the first roller.

As shown in FIG. 1, the first printer head 100 includes one or more feed rollers 110, 130 attached to the first printer head 100 and configured to drive tape 105 through the first printer head 100. In some embodiments, the gap between the feed rollers 110, 130 is adjustable to accommodate different thicknesses in material systems (e.g., different thicknesses of tapes). In some embodiments, the first printer head 100 includes a heat sink 135 (e.g., a tape feed heat sink), as described above. In some embodiments, the tape 105 passes through and comes into contact with the heat sink 135 as the tape 105 is fed through the first printer head 100. In some embodiments, the first printer head 100 further includes a blade 120 and an article configured to drive the blade. In some embodiments, the blade 120 is an angled blade.

Examples of articles configured to drive the blade include, but are not limited to, solenoids 115 (as pictured in FIG. 1) and servos. The article configured to drive the blade 120 (e.g., the solenoid), upon actuation, may cause the blade 120 to move in such a way that it cuts the tape 105 as the tape 105 is fed through the first head 100. In some embodiments, the blade 120 enters into and out of the heat sink 135 as it cuts the tape 105. In some embodiments, the heat sink 135 is modular (e.g., so as to accommodate different thicknesses of tapes and/or blades. FIG. 1 shows the blade 120 (“tape cutting blade”), solenoid 115 (“tape cutting solenoid”), and heat sink 135, in accordance with certain embodiments.

In some embodiments, the system includes a second printer head. In some embodiments, the second printer head is configured to deposit material (e.g., by extruding plastic filaments). In some embodiments, the material deposited by the second printer head includes polycarbonate, acrylonitrile butadiene styrene (ABS), or any other suitable material. For example, in some embodiments, the second printer head is an FFF head. The second printer head may, in certain embodiments, print out a mold prior to the first printer head laying down the tape (e.g., the second printer head prints a mold designed for form of the desired composite structure, and then the first printer head lays down layers of tape on to the mold, with the mold acting as a support). In some embodiments, the first printer head and/or the second printer head are capable of interfacing with any XYZ gantry motion platform (e.g., any three-dimensional translation stage). The use of such platforms may assist in the automated nature of the system and methods described herein.

In some embodiments, after the tape is fed through the first printer head 100 (e.g., via the feed rollers 110, 130) and cut (e.g., via the blade 120), the tape 105 is heated by the heat source 140 (e.g., infrared lamp) in the manner described above. In some embodiments, the heat source 140 is capable of heating both the tape 105 being fed through the first printer head 100 (e.g., “incoming tape”) and the previously laid down layers of tape on the mold/support. Heating the tape 105 being fed through the head 100 (i.e., the tape being laid down) as well as the previous layers of tape can be beneficial in consolidating the two layers of tape (e.g., via thermal bonding of the two layers).

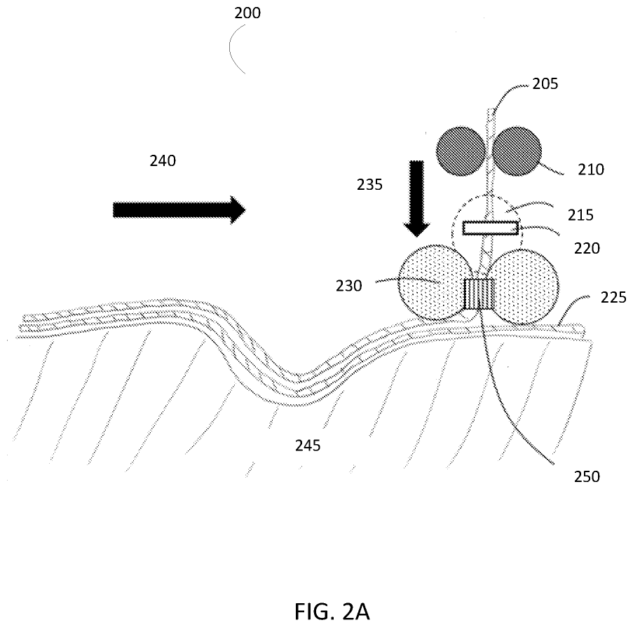

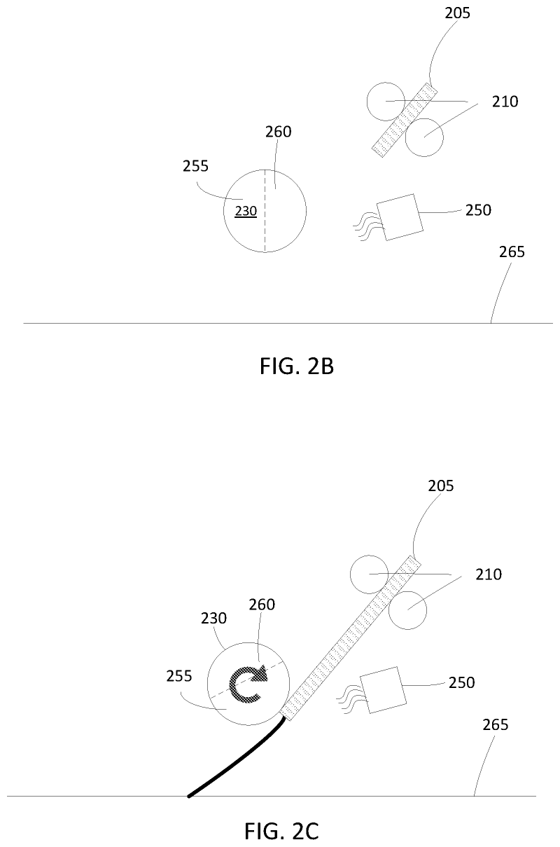

In some embodiments, the first printer head includes a compaction roller. In some embodiments, the first printer head includes at least two compaction rollers (as shown in the non-limiting embodiment illustrated in FIG. 2A). FIG. 1 shows an exemplary compaction roller 125, in accordance with certain embodiments. The compaction roller(s) 125 may be positioned in close proximity to the part of the first printer head 100 that extrudes the tape 105 and lays it down on to the mold/support. The compaction roller 125 may, in some embodiments, provide downward pressure (e.g., in the direction toward the mold) so as to flatten the material and provide necessary compaction pressure for consolidation. In one embodiment, the compaction roller 125 is coupled to a pressure management assembly 138 such as a resilient shock absorber or elastic element. In other embodiments, the pressure management assembly 138 is adjustable and varies force applied by roller to print bed 142. Various sensors 148a, 148b, 148c and a control system 150 can be used to adjust height of print head 100 and/or compaction roller 125 and/or print bed 142. In one embodiment, a print bed adjustment assembly 145 is used to raise and lower print bed to regulate pressure delivered to layers of material deposited on print bed 142. In various embodiments, the print bed 142 moves up and down in z direction in response to measurements from sensors 148a or 148b or 148c or others. The direction of compaction force is illustrated in FIG. 2A, shown by arrow 235. In FIG. 2A, the first printer head 200 is laying down tape 205 on to a support 245 previously printed, in accordance with certain embodiments. The print bed adjustment assembly 145 may include one or more motors/gantries and inputs for control signals from control system 150, which can be in wired or wireless communication with a print bed adjustment assembly 145. The control system 150 can be a PID control system in various embodiments.

A typical FFF-printed thermoplastic filament, which is isotropic, lacks the rigidity to withstand the consolidation pressures required to bond fiber reinforced thermoplastic tapes to it. Instead, printing thermoplastic filaments with chopped fiber additives makes the filament material anisotropic and provides rigidity to withstand consolidation pressures without compromising layer heights. The chopped fiber additives also improve the thermal stability of the material and reduces the likelihood of warping in the printed part due to localized heating and cooling.

In one embodiment, the disclosure relates to 3D printing system that includes a XYZ gantry in which an applicator translates in X and Y and the print bed translates in the Z-direction. Thus, rather than actuating the compaction roller in the applicator itself, pressure can be applied by translating the build platform either closer or further away from the roller to adjust pressure. In other embodiments, the compaction roller include an active or a passive adjustment mechanism such as biased spring, shock, or other element that selectively compresses. In one embodiment, to facilitate uniformity in layer heights and consolidation quality, a closed-loop control system is used. This closed-loop control system utilizes a proportional-integral-derivative (PID) controller or other controller that continuously calculates the error value, or difference between a desired pressure setpoint and the measured pressure (process variable) and applies a correction (in this case, to the print bed Z-height). The process variable, pressure, is measured via various sensors 148a, 148b, and 148c on the applicator or print bed capable of measuring normal force or other parameters. A measured normal force can be used to obtain a pressure reading by using the surface area in contact therewith and the measured compaction force. This can be used to calculate pressure. The sensors or load cell can come in a variety of formats including beam load cells, load pins, annular load cells, strain gauges, and more. This pressure is read by the software, a microprocessor, and/or other system components and the height of the print bed is adjusted to either push against or away from the roller to maintain the required pressure.

FIG. 2A also illustrates a schematic of the various components of the first printer head described herein. As can be seen in FIG. 2A, the first printer head travels in a direction 240 relative to the position of the support 245 as it lays down the tape 205. The relative direction of travel of the first printer head may be due to translation of the first printer head while the support is stationary, or due, at least in part, to motion of the support (e.g., rotation of a mandrel support). The first printer head 200 may be rotatable. Having a rotatable printer head may allow tape to be laid down in multiple directions, resulting in a composite structure with multiple fiber orientations. In some embodiments, the first printer head is rotatable by 180°. In some embodiments, the first printer head can rotate up to 360°.

As shown in FIG. 2A, the first printer head 200 includes incoming tape 205 being fed into tape feed rollers 210 through a guide 215. The guide 215 feeds the tape to through the printer head to the compaction roller 230. The first printer head uses compaction force, shown by arrow 235, to lay down incoming tape 205 into previous layers 225. During the process of laying down the tape 205, the heating element 250 heats the tape to facilitate adherence and compaction of the tape 205 to the previous layer 225.

FIGS. 2B and 2C show an alternative simplified diagram of the first printer head shown in FIG. 2A. In FIG. 2B, during a startup process of the first printer head, incoming tape 205 is fed into tape feed rollers 210 and guided to the compaction roller 230. The heating element 250, which is proximate to the compaction rollers 230, applies heat to the tape 205 and the compaction roller 230 when initiating the process of applying tape 205 to a surface 265 using the first printer head. FIGS. 2B and 2C show compaction roller 230 during startup of the first printer head. The compaction roller 230 includes a first side 255 and a second side 260. During startup of the first printer head, the heating element 250 heats the compaction roller 230 and the tape 205. In the current configuration, the heating element 250 heats the second side 260, causing the temperature of the second side 260 to be greater than the temperature of the first side 255.

In one embodiment, to facilitate application of the tape 205, while minimizing adherence to the compaction roller 230, the first printer head rotates the compaction roller 230 such that the first side 255 (the cooler side) is facing the tape 205 when first applying compaction pressure to the tape 205 to apply the tap 205 to the surface 265. In various embodiments, the cooler temperature of the first side 255, at least initially, causes the compaction roller 230 to be resistant sticking to the heated tape 205. The roller 230 is typically advanced by contacting the print bed surface 265 or other surface 265 to advance the roller. This sequence of advancing the roller can be implemented in software or via the control system. FIG. 2C shows tape 205 initially contacting the cooler side 255 and the trajectory the tape will eventually take (darker line segment) as it contacts the surface 265 and is compacted. This approach can reduce tearing and other undesirable adhesion and failures due to a higher temperature compaction roller.

In some embodiments, the first printer head and/or the second printer head includes a subtractive manufacturing element. The subtractive manufacturing element is used, in some embodiments, to trim edges and cut features (e.g., according to the part design) in the structure formed by the laid-down tape. In some embodiments, the subtractive manufacturing element performs a subtractive manufacturing process between the laying down of each tape layer.

Optionally, the second printer head may, in certain embodiments, print out honeycomb (or other type of lattice) core structures and any other support material for the composite structures. In some embodiments, the honeycomb lattice stays with the part following manufacture. In other embodiments, the honeycomb structure is removed (e.g., via washing or depolymerization).

### Contactless Heating for Composite Fabrication

In part, the disclosure relates to systems and method for heating a polymer material such as a composite tape that includes reinforcing fibers disposed in a matrix or polymer-based materials suitable for FFF-based printing. The disclosure provides various heat delivery subsystems that are contact-based or contactless. In general, contactless heat sources/heaters such as heat sources direct electromagnetic energy or heat, such as hot air or other gases, over a distance without needing to contact the material being heated. In contrast, a contact-based heater, such as an iron is used to contact a surface of a material and heat it directly.

Various heat sources suitable for heating polymer materials such as thermoplastic materials in prepreg composite tapes and polymer based filaments or other FFF-based consumables include without limitation lamps, metal-based contact heaters; thermoelectric heaters, light emitting diodes (LED), multi-element arrays having focusing geometric backplanes, heat sinks or other features, focused arrays, infrared (IR) light sources, and combinations of the foregoing.

Traditionally, thermoplastic materials are used as a base material, i.e., consumable for 3D printing. However, typically, fiber reinforced thermoplastic prepreg tapes are transformed using rapid, high energy density heating using high power lasers or hot gas torches to be useful. This follows because such tapes require a higher energy density for them to be consolidated as part of a manufacturing process. In contrasts, polymer filaments used with FFF-based approaches do not require lasers or hot gas torches to change them to a state suitable for manufacturing. Generally, more efficient ways of using thermoplastic prepreg tapes would be beneficial to the 3D printing industry. For example, when using composite tapes that include reinforcing fibers in a printing or tape placement system alone or in combination with FFF-based printing, having suitable heat delivery systems are important to achieving suitable part outputs.

In part, the disclosure describes methods, systems, and apparatuses for efficiently heating and printing and/or manufacturing using thermoplastic prepreg tapes and other polymer materials disclosed herein. In various embodiments, the current disclosure enables creation of small, high powered groupings of radiant/contactless electromagnetic radiation sources. In one embodiment, an Infrared Light Emitting Diode (LED)-based apparatus is used provide a low cost and safe method of heating polymer materials. In other embodiments, lamp with IR-based bulbs can be used.

In some embodiments, the use of an array of LEDS is advantageous relative to other heating technologies, such as using an Infrared (IR) Bulb. The EMR source array/IR LED apparatus provides focused energy at least equivalent to an IR bulb while having the rapid response time of a laser. Furthermore, in some embodiments, EMR source array/IR LED exhibit many other benefits, such as a longer lifespan than the aforementioned IR bulbs. In addition, the use of a focused array of EMR sources can obviate the need for focusing optics, lenses and additional optical paths which add cost, device complexity and additional modes of failure to a multicomponent printing/automated fiber (tape) placement system.

In some embodiments, the LEDs are positioned in an array such as a row by column configuration and are enabled to be individually programmed to activate and deactivate as needed. In various embodiments, the apparatus is enabled to activate specific LED's within the matrix of LEDs based on the geometry of the material being laid down. In some embodiments, directed heating using IR LEDs minimizes the need to cool ancillary components that become unnecessarily hot due to the unfocused heating of an IR bulb. In many embodiments, an LED matrix is enabled to direct the IR energy towards a point of interest with a higher level of control than an unfocused IR bulb. In various embodiments, directed IR energy with finer controls is enabled to improve processing conditions without the need for external optical elements for focusing. This can be achieved using various heat sources in various configurations.

In some cases, infrared lamps are selected for use as a heat source. These lamps may be paired with focusing optics, mirror, reflectors, etc. to direct thermal energy in the form of light to one or more target regions. Focused arrays of light sources, such as LEDs, can also be used with a grouping or elements in a row by column configuration to direct light to one or more target regions. Each row and column for a given array can be curved along one or more paths and used to generate a focal point for the array. The heating elements and other heat sources disclosed herein can be used with a various printing and placement processes.

In some embodiments, a printer head is used in the 3D printing process. The printer head, in certain cases, may be the first printer head shown in FIGS. 1 and 3A and described in more detail below. The printer head may fabricate structures (e.g., composite parts) by laying down and consolidating layers of pre-impregnated fiber-reinforced thermoplastic tape. The consolidation process, in certain cases, involves the application of pressure and heat to at least partially melt the thermoplastic polymer of the tape at a nip region where one or more rollers of the printer head contacts the tape that is being laid down. FIG. 3A depicts an exemplary printer head laying down tape (e.g., during the printing process), and a nip region is indicated.

In some embodiments, a heat source is used to provide heat that may be required for consolidation during the 3-D printing process. The heat source, in some embodiments, heats the printing material without necessarily coming into contact with the printing material. In certain cases, the heat source is coupled to the printer head. For example, the heat source may be attached to and/or integrated into the printer head. In some cases, the heat source includes a lamp. For example, FIG. 3A depicts a heat source attached to an exemplary printer head 300. In one embodiment, the heat source is a lamp 325, an array of lamps, an array of LEDs, or other light sources. Each heat/light source can include a housing 320 and control and power delivery electronics.

In some cases, the lamp is an infrared lamp. Infrared lamps may, in accordance with certain embodiments, emit electromagnetic energy having wavelengths suitable for heating materials (e.g., thermoplastic polymeric materials). The lamp 325 (e.g., the infrared lamp) and other heat/light sources disclosed herein may emit electronic radiation having wavelengths in the range of from 400 nm to 2000 nm. In some cases, the lamp 325 emits electromagnetic energy including a wavelength of about 1000 nm. The heat source (e.g., lamp) may have a volume that is small enough to allow the heat source to be easily coupled to a printer head (e.g., without providing obstruction to the printing process). In some embodiments, the heat source/contactless heat source has a volume suitable for being housed in a printer head.

In some embodiments, heat provided by the heat source (e.g., emitted infrared radiation) is focused. For example, electromagnetic radiation emitted by the heat source may be focused such that the intensity of the electromagnetic radiation is greater at the nip region than if the emitted electromagnetic radiation were not focused. Focusing the source of heat from the heat source (e.g., electromagnetic radiation) may, in accordance with certain embodiments, allow regions located in the vicinity of the focal plane and/or focal point F of the focused radiation to heat at a faster rate and/or achieve higher temperatures than if the emitted electromagnetic radiation were not focused. In some embodiments, the system includes a focusing lens. For example, a focusing lens 330 may be positioned between the heat source 325 and the region to be heated e.g., the nip region 335. Referring again to FIG. 3A, an exemplary focusing lens 330 is shown to be attached to the printer head 300 and positioned between the lamp 325 and the nip region 335.

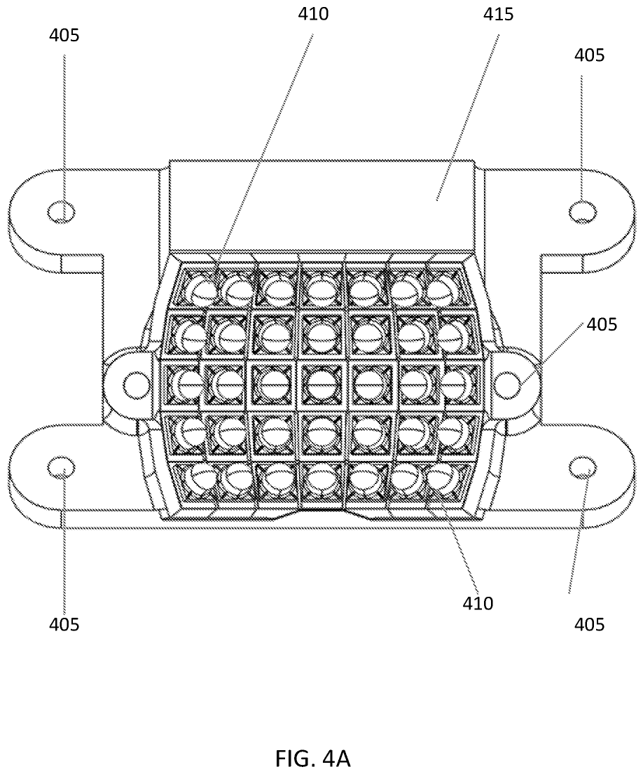

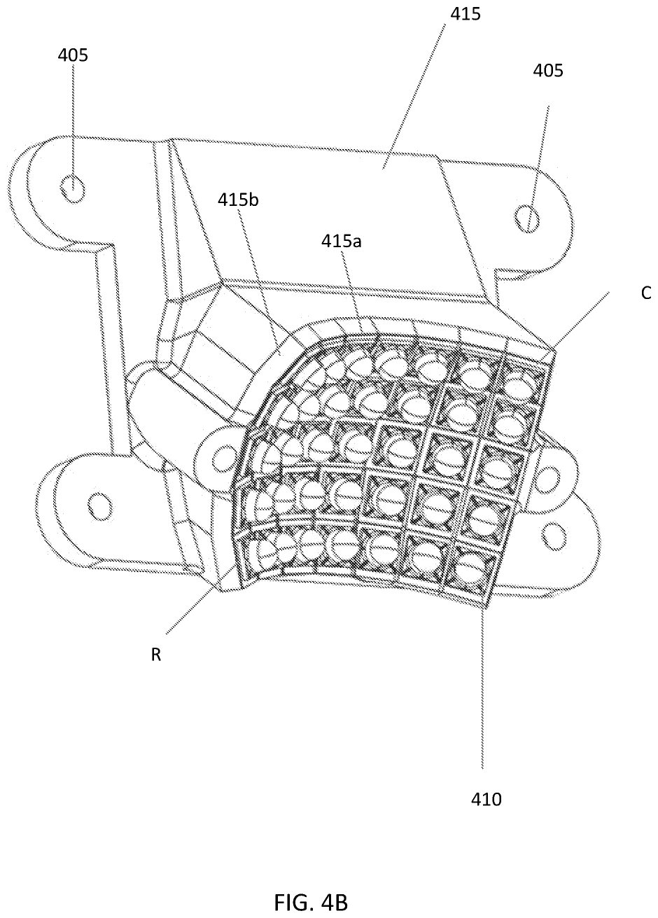

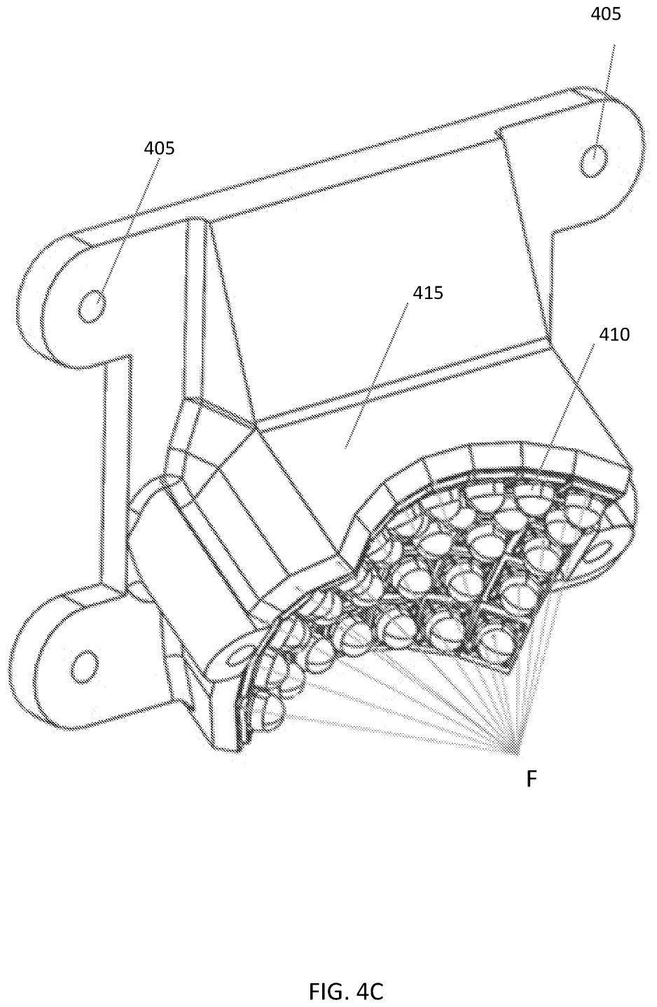

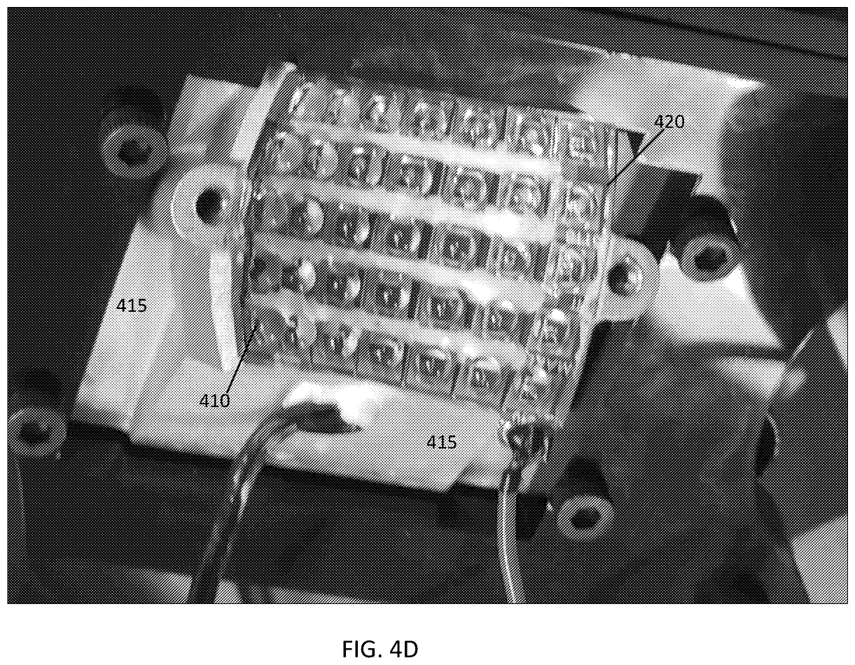

In some embodiments, such as shown in FIG. 3B and FIGS. 4A-4D multiple light sources such as rows and columns of light sources are arranged relative to a curved housing or backplane. In one embodiment, the curvature of the housing or backplane and the ability to multiplex the array allows for improved control and light beam steering and thus heating relative to the target material or region.

In certain cases, electromagnetic radiation emitted from the light/heat source in FIG. 3A is focused by the focusing lens such that the emitted electromagnetic energy is focused at or near the nip region shown. The focusing lens may be or include any suitable type of lens capable of focusing electromagnetic radiation, such as infrared radiation. For example, the focusing lens may be a spherical lens (e.g., a plano-convex lens, a biconvex lens), or in, some cases, an aspheric lens (e.g., a cylindrical lens). In some embodiments, additional optical components, such as additional lenses (e.g., focusing or collimating lenses), mirrors/reflectors, and/or filters may be positioned between the heat source and the nip region (e.g., by being coupled to the printer head as well). In one embodiment, the optical waveguide used to direct electromagnetic radiation from the contactless/heat source includes a lens. In one embodiment, the lens is a fused silica lens. The waveguide also has reflectors disposed around one or more or all of its surfaces to capture stray light rays and focus them. This light scavenging or redirection facilitates increasing or optimizing the number of light rays be directed to the nip region. In one embodiment, these reflectors may include polished aluminum, include a silver plating or coating, or include gold as a coating or other reflective coatings or structures placed relative to the wave guide to redirect light back to the nip region.

The focusing lens may be made of any of a variety of materials suitable for focusing electromagnetic waves/thermal energy. For example, in embodiments in which the heat source is an infrared lamp, the focusing lens may include or be made of quartz (e.g., IR grade HS fused quartz). Other materials that the focusing lens may include or be made out of include, but are not limited to germanium, calcium fluoride, silicon, zinc selenide, or combinations thereof.

In some embodiments, the heat source is positioned in a housing. The housing, in certain cases, acts as a partial enclosure for the heat source. For example, referring to FIG. 3A, the heat source is shown as a lamp 325. In one embodiment, the heat source is partially enclosed by housing 320 such as a cylindrical housing. The housing 320 may be coupled to the printer head. The housing 320 may, in accordance with certain embodiments, prevent or limit emitted heat (e.g., electromagnetic radiation emitted from the lamp) from propagating in undesirable directions. In some such cases, the use of the housing 320 may increase the safety and/or effectiveness of the heat source during the 3-D printing process by preventing areas other than the nip region 335 from receiving substantial heat from the heat source. In some cases, an aperture in the housing 320 (e.g., a window in the cylindrical housing shown in FIG. 3A) is positioned such that heat radiated from the heat source in the direction of the nip region can propagate to the nip region, while heat radiated in other directions is substantially prevented from propagating. In contrast, in FIG. 3B, each EM source 340 is part of an array disposed in a housing 345 and arranged relative to a curvature profile to direct light and thus thermal energy to a focus. The focus is typically on, in or near the nip region 335.

In some embodiments, an interior surface of the housing is reflective with respect to the radiant heat (e.g., infrared radiation) and configured to reflect and/or redirect the radiant heat towards a nip region, thereby increasing the efficiency of the heating system. In certain cases, a coating that is opaque with respect to the radiant heat may be applied to the radiant resource itself, leaving only a window uncoated and oriented in the direction of the nip region such that thermal energy may propagate towards and heat the nip region.

For example, in some embodiments, the radiant heat source is infrared lamp, and a ceramic coating is applied to the infrared lamp, except for at a defined region of the lamp, creating a window in the coating. The window may be located such that infrared radiation emitted from a heat source such as lamp can propagate only in a direction corresponding to the nip region. The foregoing use of a window can also be combined with the light source arrays of FIGS. 3B and 4A-4D in some embodiments. In one embodiment, a lamp is uncoated, while in other embodiments the lamp is coated. For some embodiments, uncoated bulbs in conjunction with optical focusing is preferred to using a coated bulb with this window.

Any element capable of heating the tape to a temperature above the melting temperature of the thermoplastic of the tape may be suitable. For example, in some embodiments, the heating element is a heat block. In some embodiments, the heat block (e.g., a copper heat block) is heated by a thermistor, while a thermocouple monitors and controls the temperature of the heat block via a feedback loop. In some embodiments, the heating element heats the tape by coming into contact with tape as the tape is fed through the first printer head. In some embodiments, however, the heating element heats the tape without contacting the tape. For example, in some embodiments, the heating element is an infrared lamp capable of radiating heat in the form of electromagnetic radiation toward the tape.

In some embodiments, a sensor is included in the system. The sensor, in accordance with some embodiments, is a non-contact temperature sensor. One non-limiting example of a non-contact temperature sensor is a pyrometer. FIG. 3A shows an exemplary printer head that contains a pyrometer, as shown. FIG. 3A also shows an exemplary heat sensor 310. Another non-limiting example of a non-contact temperature sensor is a thermal camera. The temperature sensor 310, in certain embodiments, is used to detect the temperature of the nip region 335 during the 3D printing process. In some designs of the system, one or more mirrors 315 or reflectors or partial reflectors are positioned in the printer head 300 such that energy reflected off of and/or radiated from the nip region 335 can be directed to the temperature sensor 310, such that the temperature sensor 310 need not necessarily be pointed directly at the nip region 335. In accordance with certain embodiments, the use of a mirror 315 or reflector as shown in FIGS. 3A and 3B in such a way may allow the temperature sensor 310 to be oriented in the printer head 300 in such a way as to allow for a compact design.

In some cases, the temperature sensor 310 is operationally coupled with the heat source 340, 325 such that readings from the temperature sensor 310 may affect the output of the heat source 340, 325. For example, in some cases, the temperature sensor 310 and the lamp 325 are both connected to a computer system that receives temperature input from the temperature sensor 310 and, based on the temperature readings of the temperature sensor 310, modulates the output of the heat source (e.g., modulates the power of the lamp).

### Temperature Control

In some such embodiments, a feedback loop is used such that if the temperature sensor detects a temperature at the nip region that is below a threshold value (e.g., a value suitable for heating and consolidating printing material), a signal is sent to the heat source to increase heat output. In various embodiments, the heating elements disclosed herein are suitable for use with a system for producing composite parts using automated fiber placement with continuous fiber reinforced polymer tapes. The system may also be configured to control the temperature by regulating the rate or speed at which a given part is printed or formed with prepreg tape or other materials. For example, if the power to the heat source stays the same, the system may operate to increase temperature near nip region or other target region by moving slower, such as by reducing print head speed, and allowing the material to heat up more. In contrast, the system can decrease temperature at nip region or another target region by moving faster. In one embodiment, the selective control of print rate can increase temperature or limit how hot the material used to make a given part can get. Alternatively, if the temperature sensor detects the temperature at the nip region that is above a threshold value (e.g., a value determined to be unsafe or to cause uneven heating), a signal is sent to the heat source to decrease heat output, according to certain embodiments. Such a feedback loop may allow for more efficient and/or more uniform heating during the printing process, in accordance with certain embodiments. In some cases, the systems and methods relating to heating in 3D printing processes described herein are used in the system for manufacturing composite structures layer-by-layer, described below.

In some embodiments, the system includes a first printer head. The first printer head may be the printer head including the heating system (e.g., radiant heating system) described above. FIG. 1 depicts an exemplary cross-sectional schematic representation of the first printer head, in accordance with certain embodiments. FIG. 3A and 3B depicts another schematic illustration of the first printer head, in accordance with certain embodiments. In some embodiments, the first printer head is configured to lay down tape on to a surface (e.g., a mold structure laid down by the second printer head, as described below). In some embodiments, the first printer head provides a pathway within the housing of the first printer head through which the tape can be driven. FIGS. 1, 3A, and 3B show, in accordance with certain embodiments, tape (e.g., “prepreg tape”) following a pathway within the housing of the first printer head. In some embodiments, the tape includes a matrix of thermoplastic material (e.g., a thermoplastic polymer).

In some embodiments, the first printer head includes one or more feed rollers attached to the head and configured to drive tape through the head. FIG. 1 shows exemplary feed rollers 110, 130. In some embodiments, the gap between the feed rollers is adjustable to accommodate different thicknesses in material systems (e.g., different thicknesses of tapes). In some embodiments, the first printer head 100 includes a heat sink 135 (e.g., a tape feed heat sink), as described above. In some embodiments, the tape 105 passes through and comes into contact with the heat sink 135 as the tape 105 is fed through the first printer head 100. In some embodiments, the first printer head 100 further includes a blade 120 and an article configured to drive the blade. In some embodiments, the blade is an angled blade.

Examples of articles configured to drive the blade include, but are not limited to, solenoids 115 (as pictured in FIG. 1) and servos. The article configured to drive the blade (e.g., the solenoid), upon actuation, may cause the blade to move in such a way that it cuts the tape as the tape is fed through the first head. In some embodiments, the blade 120 enters into and out of the heat sink 135 as it cuts the tape 105. In some embodiments, the heat sink 135 is modular (e.g., so as to accommodate different thicknesses of tapes and/or blades. FIG. 1 shows the blade 120 (“tape cutting blade”), solenoid 115 (“tape cutting solenoid”), and heat sink 135, in accordance with certain embodiments.

Systems and methods relating to heating consumable materials during 3D printing processes are generally described. In particular, various heat sources are described herein suitable for heating polymer-based materials and others. The system, in certain embodiments, includes a contactless heat source used to provide heat to contribute at least in part to the thermal consolidation of printed material (e.g., material including fiber-reinforced thermoplastic tape) during the fabrication of composite parts. In certain embodiments, the radiant heat source is coupled to a printer head (e.g., a printer head for laying down fiber-reinforced thermoplastic tape to make composite structures).

In many embodiments, the apparatus includes multiple IR LEDs disposed within a housing containing a printed circuit board (PCB). In some embodiments, the housing and the PCB are coupled together. In various embodiments, the PCB is bonded to a profiled heatsink. The profile of a given heatsink or housing facilitates focusing light from the array of sources. In some embodiments, a configuration of IR LEDs are enabled to be targeted to focus on a nip region of a tape laying head, which provides heat to the tape when the tape is applied to a surface. The housing may be formed into various shapes to cause the matrix of IR LEDs to provide various forms of directed heating including, but not limited to, a convex shape, a concave shape, and/or other configurations. In some embodiments, the housing is formed into a convex shape directing each IR LED placed in the housing to have a single focal point. In many embodiments, each of the IR LEDs is focused on a single point. In certain embodiments, one or more portions of the IR LEDs may be focused on one or more points.

In some embodiments, the IR LEDs are in a substantially convex configuration focusing on a single point. In some embodiments, the housing, holding the IR LEDs, is enabled to be formed into various shapes which can be, but are not limited to, substantially elliptical in shape, substantially spherical in shape, or be formed from one or more shapes designed to direct the energy created by the IR LEDs. In various embodiments, less than the entire matrix/array, such as a subset of light sources, of IR LEDs can be selectively activated to control the amount of heat directed towards a focal point. In some embodiments, the geometry of the target and/or part dictates how much heat is required. In some embodiments, various portions of a matrix of IR LEDs are configurable (i.e., on or off) depending on what areas of a material require heating. For example, in certain embodiments, fed tape requires heating to tack the fed tape to the layer below. In these embodiments, a strong bond is not desired. Thus, only a portion of the IR LED array targeting the fed tape side of the nip would be activated, while the IR LEDs targeting the substrate would be disabled.

In some embodiments, the housing and/or PCB are constructed and configured to facilitate cooling of the matrix of IR LEDs. In some embodiments, the housing and/or PCB may be constructed to create channels to and from the IR LEDs. In certain embodiments, fans and/or other cooling mechanisms can be used to push colder air into the matrix of IR LEDs. In other embodiments, fans and/or other venting mechanisms can be used to expel heat from the housing and/or PCB. In various embodiments, a cooling system can be mounted on the backside of the LED heatsink for maintaining a cool and/or constant temperature for the LEDs to optimize the performance. In certain embodiments, a cooling system is configured and constructed to quickly dissipate heat away from the matrix of IR LEDs. In some embodiments, the cooling system includes a thermoelectric cooling module or a more conventional chilled heatsink block using liquid cooling. In certain embodiments, a cooling system used in conjunction with the housing and PCB could be a combination of various cooling methods.

In some embodiments, the IR LED apparatus is enabled to provide a controllable directed heat source with the ability to have granular controls on the amount of heat directed to the focal point of the IR LEDs. In certain embodiments, the IR LED apparatus is used to heat various materials used to in three dimensional printing. In various embodiments, for example, heat from the IR LED apparatus may be used to lay prepreg tape may be laid down onto a part with a curved edge. In some embodiments, heating the section of tape that extends beyond the curved part of an edge may not be necessary and is enabled to be controlled when using IR LEDs in a matrix configuration.

FIGS. 4A, 4B, and 4C refer to electromagnetic radiation (EMR) sources 410 arranged in an array, in accordance with an embodiment of the present disclosure relative to a housing 415. The housing 415 includes various attachment points or fastening mechanisms 405 such that the array can be attached to the print head. In one embodiment, the EMR sources 410 are LEDs such as IR LEDS or other light sources. FIG. 4C shows a plurality of EMR sources 410 with a single focal point F mounted to a printed circuit board (PCB). As shown in FIG. 4B, the array of sources 410 can be grouped by rows R and columns C. The PCB may serve as a heat sink and/or include one or more heat sinks or heat absorbing layers. In one embodiment, the PCB 415a is used in conjunction with a heat sink 415b as shown. The PCB, heat absorbing materials, cooling devices and other apparatus and subsystems may provide cooling to the plurality of EMR sources 410. In one embodiment, the PCB is disposed between the housing and sources. The PCB is constructed and configured to arrange the EMR sources 410 into an array configuration. Each of the LEDs are individually wired to be enabled to turn on or off individually. FIG. 4B is a perspective view of the array of infrared LEDs. In this embodiment, the PCB is shown having multiple mounting apertures. FIG. 4C is an alternate perspective view of the array if infrared LEDs.

As shown in FIG. 4C, each of the EMR sources 410 is directed towards a single focal point. Individual elements of the PCB or housing such as elements 415a, 415and others can be curved or offset relative to other elements of housing such as supports and used to change the focus of the array. This can be achieved by changing the separation distance of one or more sources in the array relative to others. Beam profiling and targeting can be achieved without limitation by varying surface profile of housing, array, PCB, and other elements.

FIG. 4D is an image of an exemplary array of a light source array-based apparatus, in accordance with an embodiment of the present disclosure. The apparatus is mounted within a 3D printing device. The apparatus includes a housing, a PCB, and a matrix/array of EMR sources 410. The housing is coupled to the 3D printing device using four bolts. The PCB is coupled to the housing and a plurality of EMR sources 410 are electrically in communication and connected to the PCB. The PCB enables communication with each of the EMR sources 410 individually, however, in some embodiments, multiple EMR sources 410 are activated collectively to provide a heat source or a targeted focus. As shown, the housing is enabled to dissipate heat created by the combination of the PCB and each of the EMR sources 410. In some embodiments, the housing can be used in conjunction with one or more venting apparatus (i.e., a fan) to direct heat away from the IR LED apparatus.

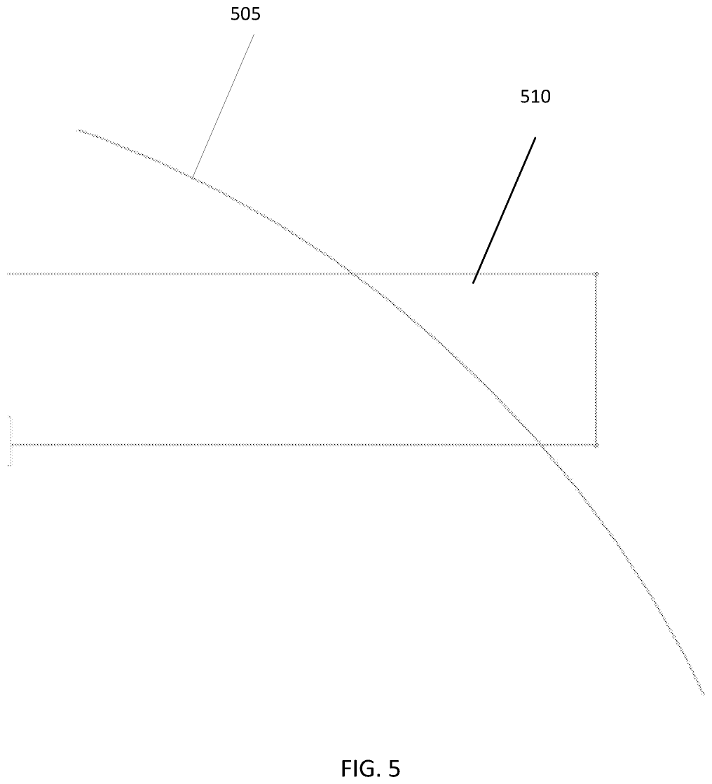

FIG. 5 is a schematic diagram showing the application of a light source-based array heat source in accordance with an embodiment of the present disclosure. As shown, prepreg tape 510 is laid down onto a part 505 with a curved edge. Using an IR LED, IR energy is directed such that the tape 510 that extends beyond the curved part 505 of the edge can be excluded using the energy from the IR LED.

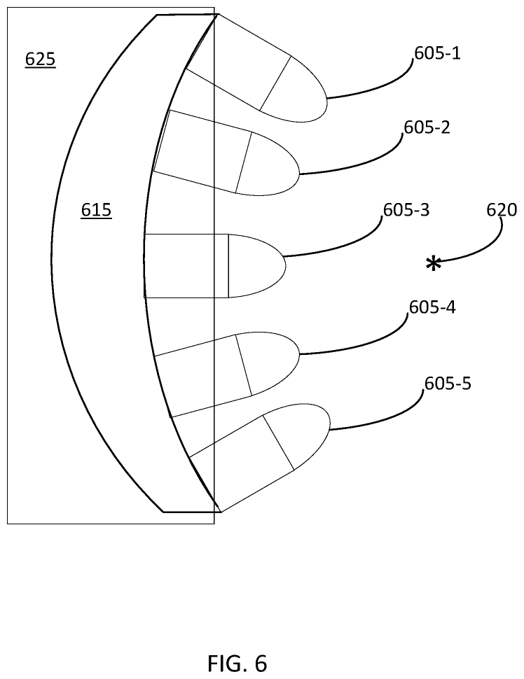

FIG. 6 is a simplified illustration of a cross section of an IR LED apparatus. In this embodiments, EMR sources 410 (605-1 . . . 605-5, 605 generally) are electrically coupled to the printed circuit board (PCB) 615. The PCB 615 and various sources 410 can be disposed with or partially disposed within a housing. Each of the EMR sources 410 are directed towards focal point 620. Each of the EMR sources 410 are electrically coupled such that each of the EMR sources 410 is individually controllable, which provides the capability to selectively target regions of tape and polymer material.

In some embodiments, the heat source may be a light source having a volume of less than or equal to 50 cm³, less than or equal to 40 cm³, less than or equal to 30 cm³, less than or equal to 25 cm³, less than equal to 20 cm³, less than or equal to 10 cm³, or less. The volume of the light source may, for example, refer to the volume determined by the outer dimensions of the bulb of the light source. In some embodiments, the heat source provides sufficient energy to efficiently heat the printing material (e.g., thermoplastic tape).

For example, in some cases, the heat source (e.g., lamp) or array of light source or EMR sources or LEDs may provide enough energy to heat the printing material to a temperature of at least 150° C., at least 200° C., at least to 50° C., at least 300° C., at least 400° C., at least 450° C., and/or up to 500° C. To do so, in accordance with some but not necessarily all embodiments, the heat source may emit electromagnetic energy at a power of at least 75 W, at least 85 W, at least 90 W, at least 100 W, at least 115 W, at least 130 W, at least 150 W, and/or up to 200 W, up to 300 W, up to 400 W, or more. In certain cases, the heat source provides sufficient energy while having a relatively small volume, as described above.

### Use of Pressure During Printing Process

Systems and methods relating to controlling applied pressure during 3D printing processes are generally described. In some cases, the system includes a printer head that is used to lay down and compact composite material in order to fabricate composite parts (e.g., fiber-reinforced aeronautical parts). In certain embodiments, the composite material laid down by the printer head is or includes fiber-reinforced thermoplastic tape. In some cases, the one or more components of the printer head, such as compaction rollers, may be used to apply pressure to the laid down tape in order to contribute to the consolidation of the composite part. In some cases, a pressure sensor is coupled to the system in order to control the pressure applied during compaction of the composite material. For example, in certain cases, a load cell is coupled to the printer head, and the load cell is configured to measure the pressure applied by to the printer head (e.g., the compaction rollers) by the composite part being fabricated. It is challenging to apply pressure to an applicator head such as tape applicator/print head while heating the nip region without deforming or otherwise damaging an initial layer being deposited on the print head or subsequent tape layers being formed on FFF layers or existing tape layers.

In one embodiment, the FFF filaments are doped or fabricated with improved strength properties to have a stiffness that can resist deformation due to pressure from the print head/applicator head. In one embodiment, the FFF-based filament is selected to have a stiffness capable of resisting about 10 lbs. of force from a tape applicator. In one embodiment, the FFF-based materials includes one or more stiffening elements/pressure mitigating elements to help mitigate deformation/surface damage from compaction roller/tape applicator. Stiffening elements/pressure mitigating elements may include dopants, glass balls/chunks, polymer balls/chunks, chopped composite fiber, and other structural materials.

Measuring the pressure can then, in some embodiments, allow for a feedback loop to be used to modulate the applied pressure as needed. Modulation of the applied pressure (e.g., via a vertical adjustment of a print bed on which the composite part is being printed and/or the printer head based on readings from the pressure sensor) may be useful in promoting uniformity and/or reproducibility during the 3D printing process. In various embodiments, a closed loop control system utilizes a proportional-integral-derivative (PID) controller that continuously calculates the error value, or difference between a desired pressure set point and the measured pressure (process variable) and applies a correction with minimal delay and overshoot. Various controllers disclosed herein can be implemented using a closed-loop and a PID controller or other controller. Various feedback loop-based controllers may be used without limitation. Various controllers, such as controller 150, can be in wired or wireless communication with sensors 148a, 148b, 148c and other sensors to facilitate selectively adjusting the print bed through a print bed adjustment assembly 145 as shown in FIG. 1. A pressure management assembly 138 can be active or passive. A passive pressure management assembly would be one that includes shocks, force absorbers, or other components to passively manage the force profile at the compaction roller. An active assembly pressure management would be adjusted in response to sensor feedback and change in height in a manner akin to the print head adjustment described.

In some cases, a process variable, pressure can be measured via a load cell on the print head capable of measuring normal force, that when divided by the surface area in contact, can be used to calculate pressure. In various embodiments, the systems disclosed herein may include one or more pressure sensing/control systems to regulate printing/deposition/tape laydown process. In one embodiment, a given print bed is motorized and/or height adjustable. Pressure readings from one or more sensors are used with a controller modify or adjust height of print bed to maintain a constant pressure or substantially constant pressure. In one embodiment, the pressure is maintained relative to a tape head roller such as a compaction roller. Accordingly, height adjustments are made to maintain a pressure level between the print bed and the compaction roller that is being used to additively manufacture a part on the print bed.

As mentioned above, in some cases, one or more components of the printer head (e.g., the first printer head described in more detail below and depicted in FIG. 1 and FIG. 3A), applies pressure to a composite part during the printing process. For example, FIG. 3A shows a schematic illustration of an exemplary printer head 300 that includes a compaction roller 350 applying pressure to tape 305 being laid down on a print bed. The compaction may, in combination with applied heat, consolidate printed composite material (e.g., fiber-reinforced tape and/or thermoplastic filaments with chopped fiber) during printing. Generally, a certain minimum amount of pressure is required to achieve sufficient consolidation of the composite material during printing. For example, in some cases, a pressure of at least 50 kPa, at least 75 kPa, at least 100 kPa, at least 125 kPa, at least 150 kPa, at least 175 kPa at least 200 kPa, at least 250 kPa, and/or up to 300 kPa or more is applied between one or more components of the printer head and the composite part being printed during the printing process.

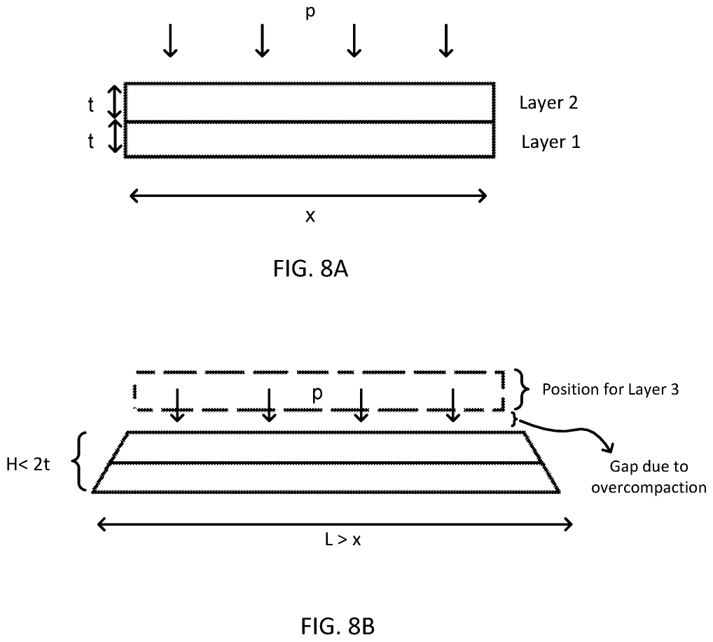

In various cases, when additively building up 2D layers/slices at a time, controlling applied pressure effects consolidation of printing materials, control of layer height, and prevention of deformation of the substrate material beneath each layer. In some cases, if too great a pressure is applied between one or more components of the printer head and the composite part, defects and/or a lack of uniformity in the printed composite part may occur. FIGS. 8A and 8B show two different examples of pressure applied to multiple layers of thermoplastic material being used to fabricate a three dimensional object. As shown in FIG. 8B, when a shell of FFF-printed thermoplastic material is first printed, too much pressure can result in crushing of the shell. FIG. 8B shows the impact of over compaction. The crushed shell compromises the structural integrity of a part and effects tolerances in all directions. Instances where there is over compression, such as crushing one or more layers, creates a larger than expected gap between where a layer is actually laid down versus where a printing head expects the layer to be positioned. In FIG. 8B, the position for Layer 3, which is to be deposited next, is shown with a dotted border. The length x of layers 1 and 2 has spread out from over compaction and is a longer length L, wherein L is greater than X. In turn, the thickness t of each of layers 1 and 2, which is 2t is greater than the thickness H of compacted layers 1 and 2 shown in FIG. 8B. By adjusting the print bed using a control system or having a compensating element integrated or coupled to compaction roller, over compaction can be reduced, mitigated or compacted.

Additionally, when underlying layers are over compressed, the dimensions of each layer is different from expected. Moreover, since a print head is adjusted by an expected height or thickness of the previous layer, over compacting one or more previous layers potentially compromises the object being fabricated due to insufficient pressure being applied to one or more other layers being applied on top of the over compressed layer. In certain cases, when too little pressure is applied, a tape layer cannot properly bond to the substrate, which can lead to delamination causing a compromise in the structural integrity of a printed part. In contrast, as shown in FIG. 8A, when an appropriate amount of pressure is applied, each layer reacts in a predictable manner. In this instance, each layer applied is the same thickness (t) and the same dimension (x). Predictable dimensions enable a print head to accurately lay down future layers of material during fabrication.

In various embodiments, additives, such as chopped fiber, are added to thermoplastic filament to increase the rigidity of the thermoplastic filament to withstand the consolidation pressure required to bond fiber reinforced thermoplastic tapes to the thermoplastic filament. Typically, FFF printed thermoplastic filament is isotropic and lacks the rigidity to withstand the consolidation pressures required to bond with fiber reinforced thermoplastic tapes. However, printing with thermoplastic filaments with chopped fiber additives makes the filament material anisotropic, which provides the thermoplastic filament with rigidity to withstand consolidation pressures without compromising layer heights. In some cases, the chopped fiber additives also improve the thermal stability of the material and reduces the likelihood of a printed part to warp due to localized heating and cooling. In one embodiment, chopped fibers having lengths that range from about 2 mm to about 6 mm are disposed in the FFF-based filament.

In various embodiments, in the context of an object, such as a manufactured part, materials may selected to fabricate the object such that a physical property measured in a first direction relative to the material has a value that differs by an amount greater than S % when compared to the same physical property measured in a second direction relative to the material.

In various embodiments, in the context of an object, such as a manufactured part, materials may selected to fabricate the object such that a physical property measured in a first direction relative to the material has a value that differs by an amount less than S % when compared to the same physical property measured in a second direction relative to the material. In one embodiment, S is 10. In one embodiment, S is 5. In one embodiment, S is about 5 or about 10. In one embodiment, S ranges from about 5 to about 20. In one embodiment, S ranges from about 1 to about 50. In one embodiment, S is greater than 0. In one embodiment, S is less than 100. In one embodiment, S ranges from about 10 to about 30. In one embodiment, S ranges from about 20 to about 40. In one embodiment, S ranges from about 40 to about 50. In one embodiment, S ranges from about 50 to about 60. In one embodiment, S ranges from about 60 to about 70. In one embodiment, S ranges from about 70 to about 80. In one embodiment, S ranges from about 80 to about 90. In one embodiment, S ranges from about 90 to about 100. In one embodiment, S may also refer to either percentages P or Q.

In some embodiments, it is beneficial for the variation in pressure applied between one or more components of the printer head and the composite part to be relatively small. For example, in some embodiments, the variation in applied pressure between one or more components of the printer head (e.g., the compaction rollers) and the composite part being printed is less than or equal to about 20%, less than or equal to about 15%, less than or equal to about 10%, or less than or equal to about 5% of the pressure being applied. Having a relatively low variation in applied pressure may, in accord certain embodiments, allow for greater reproducibility in the manufacturing of the composite parts.

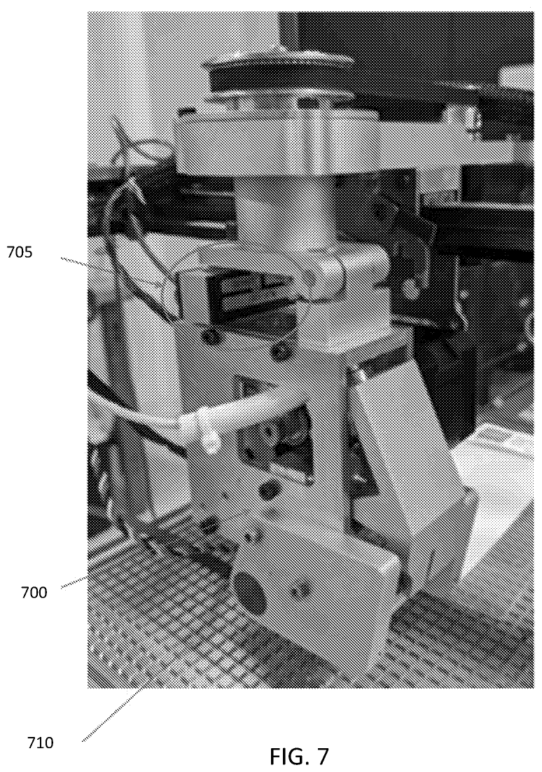

In some embodiments, the system includes a pressure sensor. For example, a pressure sensor may be coupled to the printer head (e.g., be attached to the printer head). FIG. 7 depicts a non-limiting example of a printer head 700 (e.g., a printer head capable of laying down fiber-reinforced thermoplastic tape) coupled to the pressure sensor 705. The pressure sensor 705, in some embodiments, can measure, directly or indirectly, the pressure applied between the printer head 700 and a composite structure or a print bed 710 with which the printer head is in contact during the printing process. The pressure sensor 705 may be any of a variety of suitable devices capable of measuring pressure. For example, in some embodiments, the pressure sensor is a load cell. The load cell may be in contact with the printer head and be configured to measure a normal force from the printer head that is generated when the printer head comes into contact with either the print bed or the composite part being printed.

In one embodiment, the load cell may then use the measured normal force and a known surface area of contact to calculate the applied pressure. As shown in FIG. 7, when the printer head 700 shown applies pressure to the composite part (e.g., during compaction), a force is exerted on the printer head 700 that in turn results in the force being exerted on the load cell shown. The load cell in FIG. 7 then, in certain embodiments, measures an applied pressure of the compaction process. The load cell can come in a variety of formats, including, but not limited to, being the load cells, load pins, strain gauges, and/or annular load cells.

In some embodiments, the measurements from the pressure sensor can be used to adjust the pressure being applied between the printer head and the composite part being printed during the printing process. For example, in some cases, both the pressure sensor (e.g., load cell) and the print bed or mandrel on which the composite part is being printed is coupled to a computer system.

The computer system may use the pressure measurements from the pressure sensor to cause a change in the vertical (e.g., Z-axis) position of the print bed or mandrel while the vertical position of the printer head remains the substantially the same, in order to adjust the pressure between the printer head and either the print bed, mandrel, and/or composite part being printed.

For example, if, during compaction the pressure sensor detects that the applied pressure between the composite part and the printer head is too great (e.g., exceeds a threshold value), the computer system may then cause the printing system to lower the print bed while keeping the vertical position of the printer head (and its compaction rollers) substantially the same, thereby decreasing the applied pressure. Similarly, if the pressure sensor detects a pressure that is below a certain threshold (e.g., a threshold for achieving sufficient compaction), the computer system may cause the printing system to raise the height of the print bed, thereby increasing the applied pressure.

In such a way, the pressure sensor can, in some embodiments, be used to provide real-time adjustments of the compaction pressure during a tape laying process by the printer head. In some embodiments, the feedback system described herein involving the pressure sensor and/or the print that and/or mandrel allows for adjustments of the applied pressure even during the laying down of a ply of tape (e.g., an adjustment of apply pressure on the order of seconds or less). Such a feedback-based control of applied pressure may, in accordance with some but not necessarily all embodiments, allow for relatively little variation in applied pressure as well as greater reproducibility and/or uniformity of printed composite parts than in systems in which the pressure is not monitored and adjusted during the printing process.

In some cases, the systems and methods relating to controlling pressure in 3D printing processes described herein are used in the system for manufacturing composite structures layer-by-layer, described below.

In some embodiments, the system includes a first printer head. The first printer head may be the printer head coupled to the pressure controlling system (e.g., including a one or more pressure sensing devices such as a load cell) described above. FIG. 1 depicts an exemplary cross-sectional schematic representation of the first printer head 100, in accordance with certain embodiments. FIG. 3A depicts another schematic illustration of the first printer head, in accordance with certain embodiments. In some embodiments, the first printer head is configured to lay down tape on to a surface, support, cover, build plate, or other structure such as a mold structure laid down by a second printer head/applicator, as described herein). In some embodiments, the first printer head provides a pathway within the housing of the first printer head through which the tape can be driven. FIG. 1 shows, in accordance with certain embodiments, tape 105 (e.g., “prepreg tape”) following a pathway within the housing of the first printer head 100.

In some embodiments, the tape has a certain width. In some embodiments, the width is greater than or equal to 1 mm, greater than or equal to 1.5 mm, greater than or equal to 2.0 mm, greater than or equal to 2.5 mm, or greater than or equal to 3.0 mm. In some embodiments, the width of the pre-impregnated tape is less than or equal to 20.0 mm, less than or equal to 15.0 mm, less than or equal to 10.0 mm, less than or equal to 8.0, less than or equal to 6.0 mm, less than or equal to 5.0 mm, or less. Combinations of the above ranges are possible, for example, in some embodiments, the width of the tape is greater than or equal to 1 mm and less than or equal to 20.0 mm. The tape may be wound on to a spool or cassette prior to being introduced to the first roller.

In some embodiments, the first printer head 100 includes one or more feed rollers 110, 130 attached to the head 100 and configured to drive tape 105 through the head 100. FIG. 1 shows exemplary feed rollers 110, 130. In some embodiments, the gap between the feed rollers is adjustable to accommodate different thicknesses in material systems (e.g., different thicknesses of tapes). In some embodiments, the first printer head 100 includes a heat sink 135 (e.g., a tape feed heat sink), as described above. In some embodiments, the tape 105 passes through and comes into contact with the heat sink 135 as the tape is fed through the first printer head. In some embodiments, the first printer head 100 further includes a blade 120 and an article configured to drive the blade. In some embodiments, the blade 120 is an angled blade.

Examples of apparatuses configured to drive the blade include, but are not limited to, solenoids 115 (as pictured in FIG. 1) and servos. The apparatus configured to drive the blade 120 (e.g., the solenoid), upon actuation, may cause the blade 120 to move in such a way that it cuts the tape as the tape is fed through the first head. In some embodiments, the blade 120 enters into and out of the heat sink 135 as it cuts the tape 105. In some embodiments, the heat sink 135 is modular (e.g., so as to accommodate different thicknesses of tapes and/or blades. FIG. 1 shows the blade 120 (“tape cutting blade”), solenoid 115 (“tape cutting solenoid”), and heat sink 135, in accordance with certain embodiments.

In some embodiments, the system includes a second printer head. In some embodiments, the second printer head is configured to deposit material (e.g., by extruding plastic filaments). In some embodiments, the material deposited by the second printer head includes polycarbonate, acrylonitrile butadiene styrene (ABS), or any other suitable material. For example, in some embodiments, the second printer head is a standard fused filament fabrication (FFF) head. The second printer head may, in certain embodiments, print out a mold prior to the first printer head laying down the tape (e.g., the second printer head prints a mold designed for form of the desired composite structure, and then the first printer head lays down layers of tape on to the mold, with the mold acting as a support). In some embodiments, the first printer head and/or the second printer head are capable of interfacing with any XYZ gantry motion platform (e.g., any three-dimensional translation stage). The use of such platforms may assist in the automated nature of the system and methods described herein.

In some embodiments, after the tape is fed through the first printer head (e.g., via the feed rollers) and cut (e.g., via the blade), the tape is heated by a heating element. Any element capable of heating the tape to a temperature above the melting temperature of the thermoplastic of the tape may be suitable. For example, in some embodiments, the heating element is a heat block. In some embodiments, the heat block (e.g., a copper heat block) is heated by a heat source. The heat source can include a hot air source, such as a blower with a fan or other air directing element. In one embodiment, the heat source may include a thermistor, while a temperature sensor such as a thermocouple monitors and controls the temperature of the heat source via a controller such as feedback loop. A PID loop can be used to provide suitable controls responsive to temperature changes in one embodiment. Various hot air-based heating elements can be used. The heat production and/or air speed of a given air-based heating source can be regulated using a feedback loop. In addition, in some embodiments, the temperature of the compaction roller is adjusted by selectively contacting the print bed and rolling the compaction roller forward by a fraction of rotation such as by about 90° or 180° or another angle greater than 5° and less than 360°. In this way, the side of the roller facing the heat source is rotated and a cooler portion of the compaction roller is presented to compact a given tape segment.

In some embodiments, the heating element heats the tape by coming into contact with tape as the tape is fed through the first printer head. In some embodiments, however, the heating element heats the tape without contacting the tape. For example, in some embodiments, the heating element is an infrared lamp capable of radiating heat in the form of electromagnetic radiation toward the tape. In some embodiments, the heating element is capable of heating both the tape being fed through the first printer head (e.g., “incoming tape”) and the previously laid down layer of tape on the mold/support (e.g., a mandrel). Heating the tape being fed through the head (i.e., the tape being laid down) as well as the previous layer of tape can be beneficial in consolidating the two layers of tape (e.g., via thermal bonding of the two layers). FIG. 1 depicts a heating element, in accordance with certain embodiments.

In some embodiments, the first printer head includes a compaction roller, as mentioned above. In some embodiments, the first printer head includes at least two compaction rollers (as shown in the non-limiting embodiment illustrated in FIG. 2). FIG. 1 shows an exemplary compaction roller 125, in accordance with certain embodiments. The compaction roller(s) 125 may be positioned in close proximity to the part of the first printer head 100 that extrudes the tape 105 and lays it down on to the mold/support 245 (FIG. 2A). The compaction roller 125 may, in some embodiments, provide downward pressure (e.g., in the direction toward the mold) so as to flatten the material and provide necessary compaction pressure for consolidation. The direction of compaction force is illustrated in FIG. 2A, which shows the laying down of tape 205 by the first printer head on to a support 245 previously printed by the second printer head, in accordance with certain embodiments.

FIG. 2A also illustrates a schematic of the various components of the first printer head 200 described herein. As can be seen in FIG. 2, the first printer head 200 travels in a direction (shown by arrow 240) relative to the position of the support 245 as it lays down the tape 205. The first printer head 200 may be rotatable, in some embodiments. Having a rotatable printer head may allow tape to be laid down in multiple directions, resulting in a composite structure with multiple fiber orientations. In some embodiments, the first printer head can rotate 180 degrees. In some embodiments, the first printer head can rotate up to 360 degrees.

In some embodiments, the first printer head and/or the second printer head include a subtractive manufacturing element. The subtractive manufacturing element is used, in some embodiments, to trim edges and cut features (e.g., according to the part design) in the structure formed by the laid-down tape. In some embodiments, the subtractive manufacturing element performs a subtractive manufacturing process between the laying down of each tape layer.

Optionally, the second printer head may, in certain embodiments, print out honeycomb (or other type of lattice) core structures and any other support material for the composite structures. In some embodiments, the honeycomb lattice stays with the part following manufacture. In other embodiments, the honeycomb structure is removed (e.g., via washing or depolymerization).

### Exemplary Heating and Cooling Implementations and Related Subsystems

In particular, the disclosure is directed to solving various technical problems relating to waste heat and associated unwanted temperature levels in various regions or zones of a manufacturing system such as a 3D printing system. Specifically, systems and methods to manage heat and control temperature ranges are described with regard to systems that transform lengths of tapes or tows that include a matrix or carrier material such as a thermoplastic or thermoset material as well as FFF-based components that are used in conjunction therewith. In general, each of these types of systems individually and the combination of systems for printing or depositing FFF-based materials and tapes are described herein as 3D printing systems.

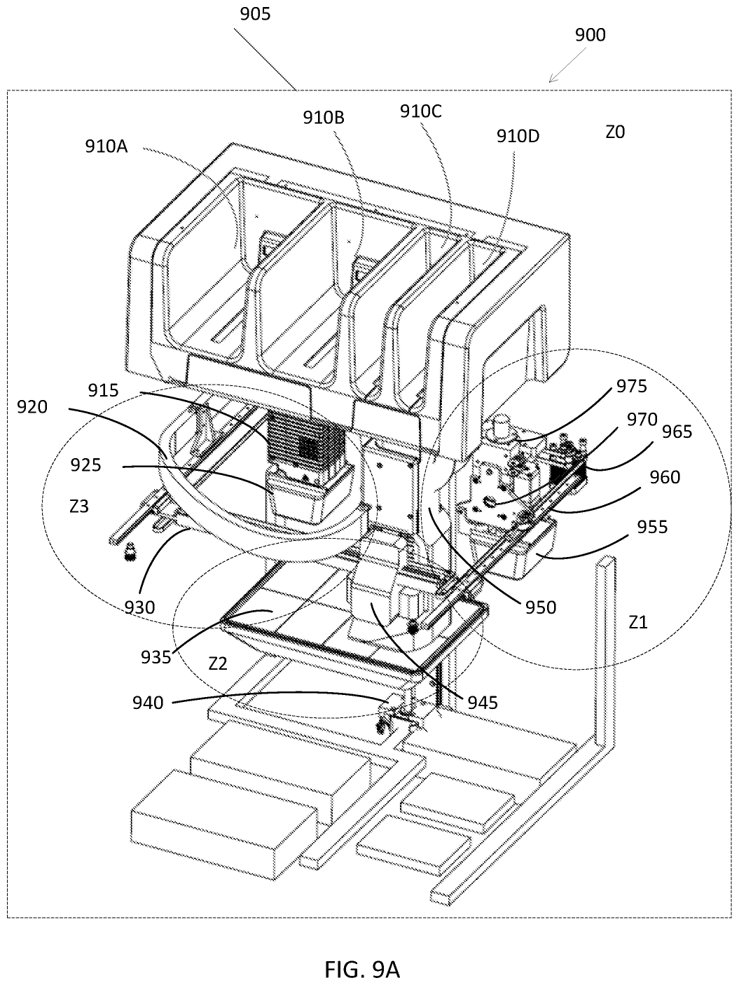

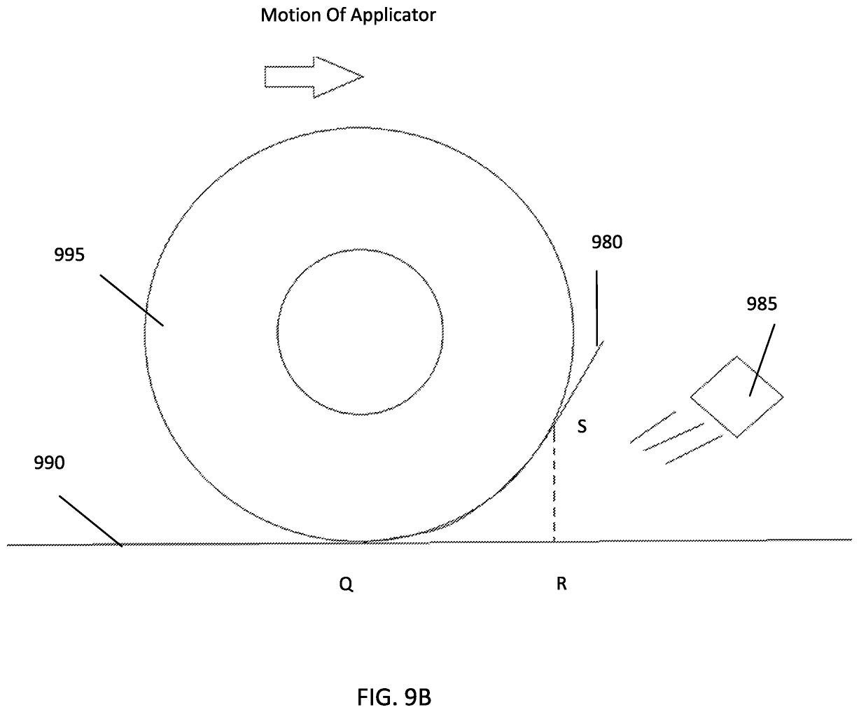

FIG. 9A shows a view of composite part manufacturing system/3D printer 900, in accordance with an embodiment of the present disclosure. The system 900 includes a housing 905 which defines a general internal volume, region, or zone Z0 within which materials are transported and print heads and other tools move and rotate to fabricate a part. Within the housing, various other volumes, regions, or zones such as Z1, Z2, and Z3 are shown. As shown, all of the zones are within zone Z0. In one embodiment, the zones may be located outside the housing or overlap with inside and outside of housing. The 3D printing system may include various movable, rotatable, heat sensitive, heating required, and/or heat generating subsystems, assemblies, consumables, and storage/housing elements for each of the foregoing. Some or all of the foregoing translate or are transported in space, such as within a housing, and work in concert through various zones of heating and cooling to fabricate three dimensional solid objects such as zones Z0, Z1, Z2, and Z3. One or more of the zones may overlap and the temperature, size and shape of the zones may change as various components of the system 900 move and interact during a fabrication session.

Each zone may correspond to temperature gradients relative to the space defined by repeated operation of a given tool or subsystems of the overall system 900. In one embodiment, one or more zones, such as one or more of zones Z0, Z1, Z2, and Z3 are temperature controlled zones. In one embodiment, the temperature in each zone is controlled to remain in temperature range of at or below about 60° C. In one embodiment, the temperature in each zone is controlled to remain in temperature range of at or below about 40° C. In one embodiment, the temperature of one or more zones, including the tape head zone is controlled to remain in a temperature range of between about 200° C. to about 450° C. depending on which materials are being used. The tape head zone includes a nip region. An exemplary nip region is discussed in more detail with regard to FIG. 9B. The system can include one more temperature sensors to monitor a given zone and detect temperature changes relative thereto.

In one embodiment, the system pauses or shuts down one or more or the overall system in the event a temperature threshold for a given zone is met exceeded. Servos and other motors and subsystems can experience various failure modes when subjected to heating, such as heating for extended period of time, when the temperature is at or above 60° C. in some embodiments. In various embodiments, heating at or near nip region is controlled to produce substantially uniform heating/uniform heating to prevent warping and other heat related failure modes. In one embodiment, fans, reflectors, ducts, and other elements are used to maintain target temperature levels in various zones and target regions.

During fabrication, the 3D printing system utilizes various tools, electrical components, and materials which can both be sensitive to temperature and affect the temperature in the various zones Z0, Z1, Z2, and Z3 of a 3D printing system. As a result, improvements to heat management through cooling and other assemblies, subsystems, and components and the interplay and interaction of them together are disclosed herein. The systems, methods and other components offer benefits in terms of final part quality and longevity of the overall system and the individual components.

The methods and systems described herein facilitate the management of redirecting heat or reducing/maintain temperature levels in one or more zones Z0, Z1, Z2, and Z3 or subsystems within a 3D printing system including the housing or other regions thereof. In general, any zone can be defined relative to housing or a given component of the system that experience heating or is otherwise a heat generator or sensitive to heat or that has a target operating temperature range during part manufacture.

Managing heat within a 3D printing system is complicated and requires a balancing of various factors. In general, many of the spaces within a 3D printing system that benefits from heat management are compact and many of those spaces have components, such as tools that move into, out of, or within them frequently. Further, the materials used to fabricate a part and a part in intermediate stages can be affected by any excess heat relative to one or more zones Z0, Z1, Z2, and Z3 (and other zones as occurs for a given heat source or heat recipient in system) in the system. For example, prepreg tape or a polymer filament used to make a part can delaminate or re-melt in regions that cause defects or other unwanted characteristics in a given part. In order to re-direct heat to achieve desirable temperature levels in various zones or relative to various subsystems, each heat management system is sized to fit in compact spaces or zone within the housing. In one embodiment, one or more zones has a zone temperature threshold that can be set to prevent damage to equipment stored in or that traverses a given zone. In one embodiment, the zone temperature threshold is at or about 60° C. One or more cooling systems can be triggered to keep a given zone temperature to about 60° C.

Further, each heat management system associated with other systems that rotate and translate also need to be able to move in concert with the system they are managing a given temperature level. In general, the systems, methods and combinations of components disclosed herein are arranged and designed to isolate and/or manage heat such that the heat does not affect other systems, parts, consumables used to make a given part, and otherwise as disclosed herein. The various cooling and heat management systems disclosed herein can be used or combined with any of the zones or system components disclosed herein.

Referring to FIG. 9A the 3D printer 900 includes a tool grabber actuator assembly 310 enabled to grab and utilize each of the applicators within the 3D printer. As shown, tool grabber actuator assembly 945 is presently located in zone Z2. The tool grabber actuator assembly 945 utilizes the actuated carriage rail 930 and the actuated carriage rail 960 to enable the tool grabber actuator assembly 945 to move within housing/print chamber of system 900. Each of the applicators are connected to a kinematic coupler 970, which enables the tool grabber actuator assembly 945 to pick up and use each of the applicators configured to be used in the 3D printer. For example, the ultrasonic cutting applicator 975 is connected to a kinematic coupler 970, which allows the tool grabber actuator assembly 945 to pick up the ultrasonic cutting applicator 975 and use it to cut various pieces within the 3D printer.

The 3D printer builds parts, through additive processes or other processes, on the build plate using one or more of the applicators. The print bed/build plate is heated or cooled based on the current stage of fabricating a three-dimensional part and/or the material being used for fabrication. In many embodiments, when fabricating using metal, the build plate is heated to about 60° C. to about 65° C. In certain embodiments, when plastics and tapes are used during fabrication, the build plate is heated to about 80° C. to about 120° C. In some embodiments, for fabrication materials such as PEEK, the build plate can be heated up to about 200° C. In some embodiments, the build plate includes heater cartridges on the underside of the build plate for the build plate to obtain a specified heat.

In various embodiments, thermocouples, temperatures sensors are used to monitor the temperature and provide feedback to the controller to adjust the temperature of the build plate. In one embodiment, the sensor is a platinum resistance thermometer. In various embodiments, the temperature of the build plate is adjustable. This can be accomplished by regulating or otherwise controlling the amount of power provided to one or more of the heat sources in thermal communication with heat plate. In one embodiment, the heat source is a plurality of cartridge heaters.

Each of the applicators, when not in use, is placed in a holding bracket mounted on the frame of the 3D printer. While stowed in the holding bracket, each of the applicators is placed above an applicator purge and waste container 925, 955. After a given operation or part fabrication session or cycle, each respective purge and waste container 925, 955 can be used to discard any residual material on each respective applicator. In some embodiments, a purge and waste container are used to purge heat created by an applicator. In this embodiment, the 3D printer is utilizing applicator 915, 950, and 975. In various embodiments, these applicators 915, 950, and 975, are an FFF head, a tape head, and an ultrasonic cutter. These heads are positioned in various zones Z3 and Z1 as shown. However, in other embodiments, different applicators can be utilized. For example, in various embodiments, applicators can be configured for metrology, ultrasonic cutter, adhesive sprayer, over coating, patching, providing directed heat, stepping, flattening, and/or any alternative print head from printing various materials. In various embodiments, an alternative print head can be used such as for FFF-based materials and others.

In various embodiments, the disclosure relates to directing thermal energy from a heat source (or re-directing waste heat from other subsystems) to a target region. Various target regions or zones for directing heat or affirmatively removing heat from a given subsystem, region or zone are described herein. FIG. 9B is a schematic diagram that shows an exemplary target region for directing thermal energy according to the disclosure. A view of the tape lay down process from a tape applicator/tape head is shown relative to the compaction roller moving from left to right. A heat sources 985 is being pointed at the roller 995 and tape 980 as the tape is being applied by the roller 995 onto the substrate 990. The bottom point of tape on roller contacting build plate/prior tape layers Q is shown relative to a point on roller S that is to the right of point Q. A point R on the plate is shown below S. In one embodiment, angle QRS is a right triangle. The triangular region shown can be increased or decreased in size by moving points S and R further out to a tangent of the roller. In general, the triangular region QRS receives thermal energy from heat source shown. This triangular region is an exemplary nip region. In one embodiment, heat is directed towards the nip region. In one embodiment, heat is directed to target region, such as a nip region, in which incoming tape is deposited and/or squeezed and compacted relative to a substrate, which may include previously laid down tape segments.

In many embodiments, each of the applicators efficiently operate at various different temperatures. In some embodiments, applicators, such as the tape head and the FFF head, operate efficiently at or below 60° C. In various embodiments, certain portions of the 3D printer, such as the nip region of the tape head and the nozzle of the FFF head, need to be hot enough to work with the fabrication materials. In some embodiments, certain portions of the 3D printer need to be hot enough to melt fabrication materials, such as a thermoplastic material being processed. Accordingly, in one embodiment, the nip region or tape head working region operates in a working temperature range (WTR) that is at or above 60° C. In one embodiment, WTR is at or above 80° C. In one embodiment, WTR ranges from about 150° C. to about 500° C. In one embodiment, WTR ranges from about 150° C. to about 450° C.

The tool grabber actuator assembly 945 is electrically connected to the power supply and control systems of the 3D printer through cable carrier/chain 920. The tool grabber actuator assembly 945 is enabled to move in two dimensions using actuated carriage rail 930 and actuated carriage rail 960. Near the center of the 3D printer, the build plate resides on an assembly enabled to move in the Z axis using the actuator 940. The build plate moves along the Z axis to facilitate construction of a three dimensional piece part. The part can be formed using alternating cycles of FFF-based materials printing, composite prepreg tape deposition, and combinations thereof such that the part is built upon the build plate in zone Z2.

In one embodiment, the top portion of the build plate is a vacuum or magnetic build chuck 935 with interchangeable build surfaces. The vacuum or magnetic build chuck 935 enables building materials to be placed upon the build plate while reducing the possibility that the constructed three dimensional items will become attached to the build plate during the construction process. Bins (910A, 910B, 910C, 910D, 910 generally) are storage areas for media to be used by one or more applicators currently configured to be used by the 3D printer.

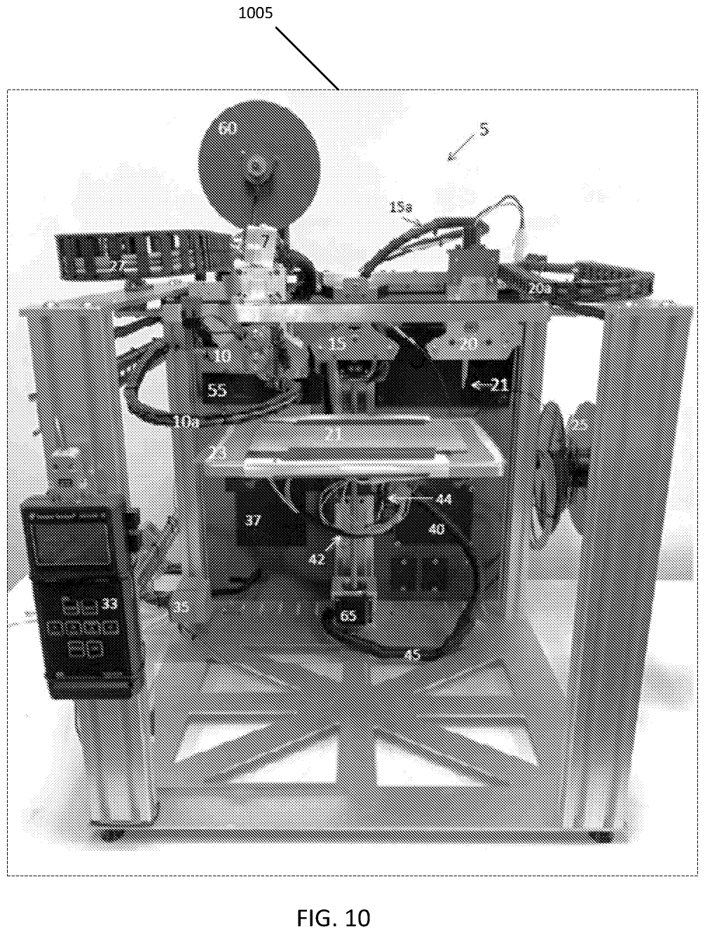

FIG. 10 is an image of an alternate embodiment of a 3D printing system suitable for processing FFF-based materials and prepreg tapes and other polymer-based materials. The 3D printing system 5 includes an outer housing 1005, which supports a plurality of moving parts configured and constructed to facilitate fabricating three dimensional solid objects. At the center of the 3D printing system 5, is a build plate 23 with a removable sheet 23 thereon. The 3D printing system 5 uses a vacuum pump to provide suction through the tubing 45 to vacuum down the build plate 23. The vacuum pump is activated using the switch 35. The build plate 23 is attached to a build plate adjustment mechanism enabled to move the build plate 23 in the z axis. This build plate adjustment mechanism can include various motors, translators, and controls. The build plate adjustment mechanism is in communication with one or more control systems to facilitate adjustment of build plate position based on pressure thresholds as disclosed herein. In one embodiment, the build plate can be heated or cooled with one or more heat management systems described herein. In one embodiment, the motor 65 drives a belt which movies the build plate 23 along the z axis. Other motors, positions, and translators can be used to allow the build plate to move in one, two, or three degrees of freedom in various embodiments. In general, vacuum systems can be used to suction regions of heated air or waste materials and transport them for disposal.

Power supply 37 and power supply 40 power system 5 and its various constituent subsystems and components. In this instance, the power supplies 37 and electronics 40 are enabled to power heating cartridges/modules using cabling 44 and cabling 42. In some embodiments, heating cartridges/modules facilitate construction of one or more three-dimensional items. Specifically, heating the build plate 23 heats the fabricated part which makes it easier for adhesion of fabrication materials to the build plate.

In various embodiments, without build plate heating, the build plate may act as a thermal mass and draw heat from the taper or polymer material used to build the part. Heat losses to the plate during initial tape or filament lay down can make it difficult for each respective material to bond and/or adhere to the print/build plate and to adjacent layers. In some embodiments, increasing the build plate temperature decreases the temperature change between the nozzle/nip region and the substrate, which promotes good bonding and prevents the fabrication materials from delaminating, sliding, or otherwise detaching from the build plate.

These types of unwanted movement of tape, such as prepreg tape, and FFF-based material can ruin part fabrication and otherwise damage the printing system and cause production delays. The application of heat from one or more heat sources relative to the build plate/print bed mitigates this potential failure mode. In some embodiments, the cartridges are disposed proximate to the build plate 23. In some embodiments, the cartridges can be heating elements disposed within the build plate 23. A given heat cartridge/heat module can be any of the various heat sources generally including those disclosed herein.

Above the build plate 23, tool grabber 55 is placed in the middle of the 3D printing system 5 and is enabled to move in three dimensions. The tool grabber 55 is connected to the electronics 40 and the power supply 37 using cabling 27.

In one embodiment, the tool grabber 55 has a motor that rotates a pin or another coupling mechanism or element. After the pin has been aligned and inserted into a socket in the kinematic coupling plate, or the tool and tool grabber are mated or coupled, the tool grabber 55 can operate and otherwise use the tool connected to the kinematic coupling plate. The tool grabber 55 couples or mates with the kinematic coupler and can in turn use a tool coupled to the kinematic coupler.

In this embodiment, kinematic coupler 10 is connected to a tape head, kinematic coupler 15 is connected to an FFF head, and kinematic coupler 20 is connected to the ultrasonic cutter 21. The translation of these heads and other tools can define various working paths and zones in which heat is generated or received during their respective operation. In one embodiment, cable carrier /chain l0a is utilized for the tape head wiring. The wiring in cable carrier/chain l0a controls the head rotation, feed of the tape, servo for cutting, load cell for pressure monitoring, temperature sensor, such as a pyrometer, for temperature measurements, as well as other inputs, outputs, control signals and other data or information exchange.

In one embodiment, cabling 15a connects the FFF head to the electronics 40 and power supply 37. Cable carrier/chain 20a is utilized to hold the wiring for the ultrasonic cutter. In many embodiments, the applicators connected to each of the kinematic couplers can be changed through a mating and docking processes. Both the position and the tool connected to the kinematic coupler may be modified or controlled using instructions provided to a microprocessor or one or more processors or computing devices in wireless or electrical communication with the system 5. In this embodiment, the tape head is supplied with tape from the prepreg tape spool 60. The FFF head is supplied with plastic filament from the spool 25. Force gauge 33 is enabled to monitor compaction force measured by the load cell in the tape head.

In on embodiment, various transducers and sensors to record or measure one or more physical, electrical, or chemical changes within, near, or on the system, tools, heads, and other components thereof can be used to trigger an event such as an alarm or shut down or regulate the operation of a process or component based on a control or feedback loop responsive to measurements from one or more such sensors. In various embodiments, if the temperature of one or more monitored temperature zones of system exceeds, equals, or is below a particular temperature threshold value, a control system in communication with such sensors stops the build of a given part or otherwise increases or decrease temperature in a zone to a preferred level. This can apply to temperature of build plate, which can include one or more sensors, and all of the various zones, devices, and subsystems of the printing system.

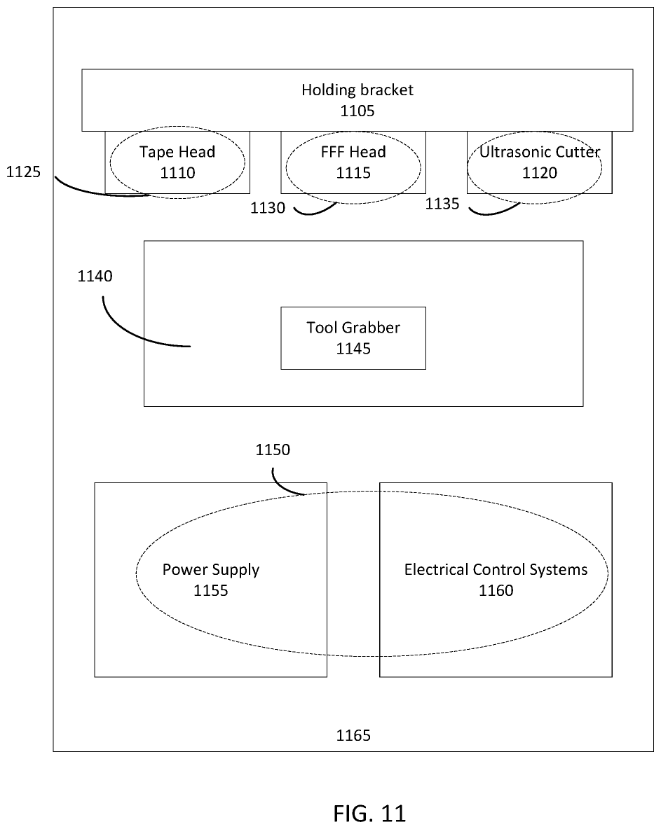

Referring to FIG. 11, which is a simplified illustration of the 3D printing system shown in FIG. 9A. From this perspective, the housing 1165 includes the power supply 1155, electrical control systems 1160, holding bracket 1105, and build plate 1140. The tape head 1110, FFF head 1115, and the ultrasonic cutter 1120 are currently mounted in the holding bracket 1105 and the Tool Grabber 1145 is in the center of the housing 1165. As shown, there are multiple areas (1125, 1130, 1135, 1150) within the housing 1165 that generate heat. Within each of the zones (1125, 1130, 1135, 1150) one or more systems generate heat. Each of the applicators, the power supply, and the electrical control systems generate heat that could potentially affect other systems and/or materials used by the 3D printing system. As such, the 3D printing system uses one or more heat management and/or cooling systems to reduce the effect of heat created by each of the heat sources on other systems or materials in the 3D printing system. Each component shown and other combinations of components can define one or more zones for temperature regulation and control. Heat sources can be used in conjunction with various heads, tools and other components of the system.

Various heat sources suitable for use with components of the system include without limitation lamps, metal-based contact heaters; thermoelectric heaters, electric heaters, thermo electric heaters, lasers, light emitting diodes (LED), cartridge heaters, multi-element arrays having focusing geometric backplanes, heat sinks or other features, focused arrays, infrared (IR) light sources, lamps, bulbs, and combinations of the foregoing. One or more of the foregoing heat sources can also be used to provide heating for polymer materials such as thermoplastic materials in prepreg composite tapes and polymer based filaments or other FFF-based consumables.

In one embodiment, a thermoelectric cooling module is used to dissipate heat quickly. This module and others can be regulating using a control loop and the measurement of temperatures in one or more zones of the system. In this embodiment, a thermoelectric cooler is sandwiched between two heatsinks. The heatsink attached to the cool side of the thermoelectric cooler is placed on or near the leads to the heat source. The thermoelectric cooler, in combination with the heat sink, pulls heat away from one or more heat sources. The ability to draw away excess heat quickly can mitigate damage to one or more system components.

In turn, in one embodiment, the heat sink on the hot side of the thermoelectric cooler is directed away from the applicator to facilitate directing the heat away from one or more heat sources and the applicator. In various embodiments, a secondary cooling system can be used in conjunction with the thermoelectric cooling module to increase the cooling efficiency. For example, in some embodiments, a liquid cooling apparatus is used to cool the heated side of the thermoelectric cooler. In other embodiments, fans and/or other method of air cooling is used to vent the heat from the hot heat sink and away from the applicator. Blades, ducts, conduits, channels, and other structures, subsystems and modules can be used to direct heat and maintain target temperature levels using fluid cooling such as air or water cooling and the various other cooling systems disclosed herein.

In one embodiment, a 3D printer utilizes a combination of liquid cooling and air cooling to vent heat from an applicator. In this embodiment, a liquid cooling loop is created between a heat source and a slip ring. In one embodiment, separately or in addition to the foregoing, an air heat transfer loop is created between the slip ring and the system exhaust. The air is used through the center of the slip ring transfer heat from one process to the other through the slip ring without inhibiting the rotational movement of the head. In some embodiments, the liquid cooling loop can be created between the system exhaust and the slip ring while the air heat transfer loop can be created between the heat source and the slip. In general, when air is used as a coolant other coolants such as water and other liquids can be used when combined with heatsinks, interfaces, pumps, and tubing. In one embodiment, liquid or air based cooling can be routed through suitable conduit, ducts and other pathways through one or more channels or bores of slip ring to delivery cooling or draw waster heat through a vacuum or suction system.

In one embodiment, a 3D printer utilizes compressed air to cool the system. In this embodiment, a conduit or other delivery mechanism for fluids such as compressed air is piped to the top of the tape head and sent down the center of the slip ring. The compressed air is then funneled through the tape head and directly toward the heat source electrical leads or contacts, thereby transferring heat from the heat source to the air and away from the tape head. Piping the compressed air through the slip ring enables full rotation of an applicator without any significant changes to the system. The high speed in which the compressed air moves over the heat source leads is enabled to provide increased cooling. A port for a compressor extends from the housing in one embodiment. This port can be used to pneumatically power heads and to provide a source of pressure or cool air for heat management.

In one embodiment, a 3D printer utilizes an ionic wind generator to vent heat from an applicator. Specifically, in an embodiment, placement of the ionic wind generator near the heat source leads, which will cause airflow to cool down the heat source leads and vent the heat away from the tape head. The ionic wind generator ionizes the air and creates airflow, which can facilitate cooling. In various embodiments, an ionic wind generator is beneficial due reduced noise. An ionic wind system eliminates noisy cooling fans and provides increased airflow at the boundary layer relative to fans.

In one embodiment, a 3D printer utilizes a highly conductive heat pipe to cool sources of heat within each applicator. A heat pipe is constructed from a highly heat conductive material. In this embodiment, one end of the heat pipe is connected to a heat source and a second end is then attached to a cold source. The cold source receives excess heat from the heat source. In many embodiments, a cold source is a heat sink. In other embodiments, a cold source is a chilled heat sink that draws excess heat away from the heat source at a faster rate or removes more heat as a result of the temperature gradient increase from chilling or cooling the heat sink.

In one embodiment, a 3D printer includes a cooled docking system. In this embodiment, each tool dock is enabled to include a cooling system. The tool is enabled to transfer or dump heat built up during use while docked. In many embodiments, the cooling system includes one or more fans to cool the applicator. In other embodiments, the cooling system includes water sprayers to cool the applicator. In some embodiments, the cooling system includes a combination of cooling methods to quickly manage heat created by use of the applicator.

In one embodiment, a 3D printer includes a refrigeration system for providing cooling. In this embodiment, a heatsink with cooling paths is thermally linked to one or more heat sources in the 3D printer. Each of the cooling paths is filled with refrigerant that is pumped through a refrigeration unit. These cooling paths can be directed through one or more zones of the system.

In one embodiment, a 3D printer utilizes a thermal mass to manage heat created within the 3D printer housing or one of its subsystems. In this embodiment, a thermal mass is formed and positioned from one or more materials with high thermal conductivity. The thermal mass is placed such that it surrounds a heat source within the 3D printer. The thermal mass is enabled to absorb energy during use. Once the temperature of the thermal mass has exceeded a specified level, the thermal mass is enabled to be replaced with a new thermal mass, which is at room temperature. The heated thermal mass, while not in use, is cooled and then enabled to be used again by the 3D printer. In one embodiment, the mass is connected to a motor and a positioner to swap it for another thermal mass.

In one embodiment, this can be performed using a motor powered tool changing operation. For example, a tool changer that can engage and move a thermal mass changer head that includes a coupler or grabber to the thermal mass. The thermal mass can be a block of metal, a heat sink, or another workpiece that can absorb waste heat from one of the heat generating process disclosed herein. The thermal mass changer can grab or couple to the thermal mass and then move it away from the system from which it is absorbing heat or otherwise docks it somewhere. If further heating or heat management is required, the thermal mass changer can then install a new thermal mass that is at a lower temperature and thus able to absorb heat until it can subsequently be changed out and replaced.

In one embodiment, a 3D printer uses suction to manage heat created within the 3D printer. In this embodiment, one or more pumps and/or fans are mounted within the 3D printer. The fans and/or pumps are positioned to direct the air through areas that create heat, through the slip ring, then to the pump, which vents the heat to the exterior of the 3D printer.

In various embodiments, heat management and/or cooling methods mentioned above can be used to manage heat for various systems in a 3D printing system. For example, in many embodiments, rollers and/or applicators for prepreg tape or filament have their temperatures regulated for an ideal application of the tape or filament during three dimensional fabrication. In some embodiments, rollers are used in a printing process (e.g., a three-dimensional printing process for laying down fiber-reinforced pre-impregnated tape to manufacture composite structures). In some cases, the rollers are compaction rollers. The compaction rollers may be used to guide and/or apply pressure to the material being printed. For example, in one non-limiting embodiment, the rollers are compaction rollers that apply pressure to consolidate fiber-reinforced pre-impregnated tape as it is being laid down (e.g., by a printer head). In some, but not all, embodiments, the compaction rollers are attached to a printer head that is part of an automated system for layer-by-layer manufacture of composite structures as described herein (i.e., in some embodiments, the roller are the compaction rollers in the first printer head described herein).

In some embodiments, the system described herein includes a device for actively cooling the rollers (e.g., the compaction rollers of a printer head). The device may, in certain embodiments, be capable of directing fluid toward the rollers. In some embodiments, the temperature of the fluid is lower than the temperature of the rollers. Therefore, in some embodiments, heat is transferred from the rollers to the fluid, thereby cooling the rollers.

In some, but not all, embodiments, the fluid directed toward the rollers by a pump, conduit, or fan is a gas (e.g., air). In some embodiments, the fluid directed toward the rollers is a liquid (e.g., a cooled liquid). In some embodiments, the device is a fan. The fan may, in certain embodiments, blow air at the rollers while the rollers are in operation. For example, in some embodiments, the rollers are compaction rollers as part of a printer head and as the compaction rollers apply pressure to heated pre-impregnated tape, the fan flows air towards and/or through the compaction rollers. In some cases, this active airflow contributes to faster cooling of the compaction rollers than passive cooling methods (such as methods in which the compaction rollers are exposed only to non-actively directed, room-temperature air).

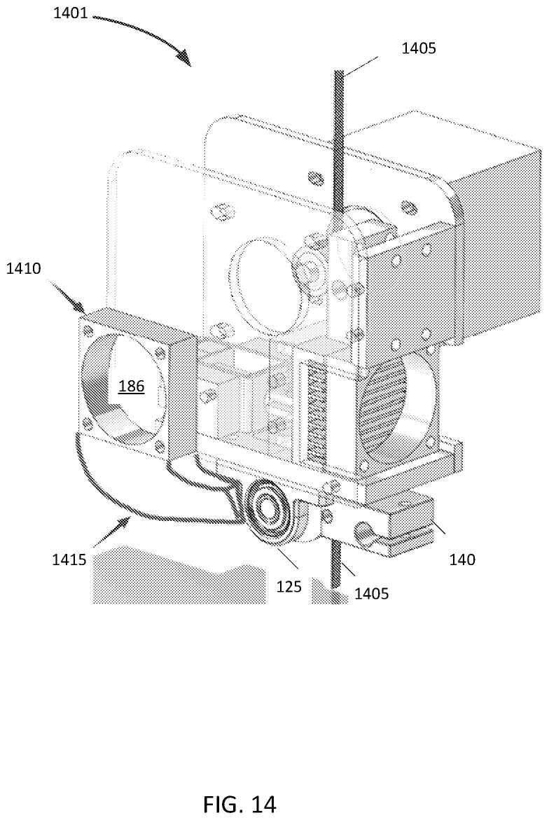

FIG. 14 shows an exemplary embodiment of a cooling module for an applicator for use in a 3D printing system. An applicator 1401 is shown in FIG. 14. In some embodiments, the device for actively cooling the rollers is fluidically connected to the rollers. In some embodiments, the device (e.g., a fan) is fluidically connected to the rollers (e.g., the compaction rollers) via a duct that is attached to a mount to which the device is fixed 1410 (as shown in the schematic illustration in FIG. 14) as well as to the rollers or a mount attached to the rollers. In some embodiments, the fluidic connection is 3D-printed. In some embodiments, the duct 1415 (e.g., the duct in FIG. 14 is 3D-printed. A fluid transferring rotary joint is incorporated in the roller when fluid is used for cooling in one embodiment. A given roller assembly can include an input and an output port for fluid flow.

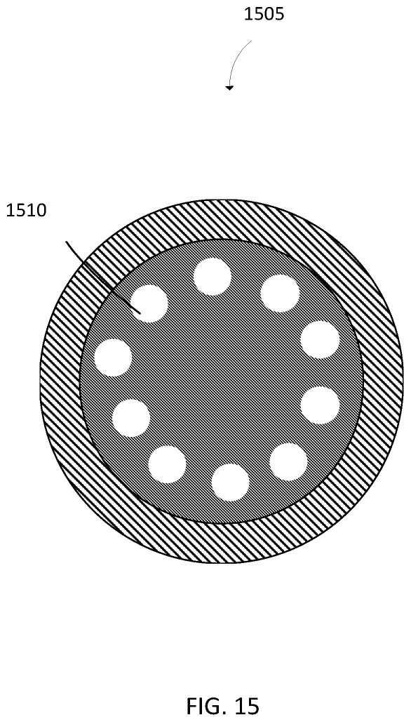

FIG. 15 shows an exemplary roller embodiment suitable for use in one or more heads, tools or other components of 3D printing systems and related methods described herein. In one embodiment, the roller 1505 includes various holes 1510 or channels along the outer perimeter of the roller. These roller holes 1510 or channels may be in fluid communication with various flow paths and used for transport of fluids, coolant, cooled air, and other material though the rollers. The rollers' holes and channels may assist in the active cooling of the rollers. In addition, the presence of holes 1510 or channels defined by material that forms roller can reduce mass of roller 1505 and facilitate its expedited heating and cooling in one embodiment.

In some cases, the systems and methods for actively cooling rollers described herein are used in the system for manufacturing composite structures layer-by-layer using prepreg tape with reinforcing continuous fibers, FFF-based materials, FFF-based materials with chopped fibers, and combinations of the foregoing. In one embodiment, the roller defines one or more holes, channels, trenches, treads, or grooves to reduce thermal mass and allow faster cooling. In one embodiment, the rate of cooling may be increased by incorporating a cooling device. In one embodiment, the printing system includes a port or couple for compressed air. A vortex chiller or other distribution element for cool air can be used to direct air through holes or other features defined by roller as the roller rotates, thereby promoting heat dissipation.

In some embodiments, a 3D printing system uses a recyclable heating and cooling system. In various embodiments, a recyclable heating and cooling system includes a printer head (e.g. a printer head for laying down fiber-reinforced thermoplastic tape to make composite structures) configured to direct relatively cool fluid (e.g., ambient air) toward a component of the printer head (e.g., a roller or heat sink) such that heat is transferred from the component to the fluid, thereby cooling the first component and heating the fluid. The recyclable heating and cooling system also involve, in certain embodiments, the printer head being configured to subsequently direct the heated fluid to a heating element (e.g., a heat block or coil), thereby heating the heating element and/or gas (e.g., air) in close proximity to the heating element.

In one embodiment, the heated gas can be used for heating and/or bonding thermoplastic tape strands during layer-by-layer printing of composite structures. The use of such a recyclable heating and cooling system, which in some embodiments, takes advantage of convective heat flow, may improve the efficiency and safety of printer heads in certain printing 3D printing processes, especially in comparison to other possible non-contact heating methods, such as those that use lasers, torches, or infrared lamp heating elements. In one embodiment, recycle heat is used to selectively or constantly heat the print bed/print plate or one or more zones of the system.

In some embodiments, one or more rollers may be cooled by the recyclable heating and cooling process described herein. In some cases, the rollers are compaction rollers. The compaction rollers may be used to guide and/or apply pressure to the material being printed. For example, in one non-limiting embodiment, the rollers are compaction rollers that apply pressure to consolidate fiber-reinforced pre-impregnated tape as it is being laid down (e.g., by a printer head). In some, but not all, embodiments, the compaction rollers are attached to a printer head that is part of an automated system for layer-by-layer manufacture of composite structures as described below (i.e., in some embodiments, the rollers are the compaction rollers in the first printer head described below).

Tapes that include thermoplastic materials may be heated (e.g., with by a heating element) to a temperature above the melting temperature of the thermoplastic material as the tape is being laid down (e.g., to assist in bonding the tape to a previous layer). In some cases, it is desirable to cool the tape as quickly as possible once it is laid down in order for the structure to consolidate and solidify. Having a rapid change in temperature may, in some embodiments, speed up the consolidation process and therefore speed up the process cycle for manufacturing the composite. The systems and methods described herein describe a low-cost method for the active cooling of the rollers, so that, in some embodiments, the rate at which the tape cools is increased, without significant expenditure of resources. Moreover, the systems and methods herein describe the recycling of the heat removed from the rollers so that the heat may, in some embodiments, be transferred to components that are desired to be heated (e.g., a heating element and/or gas in contact or proximity to the heating element).

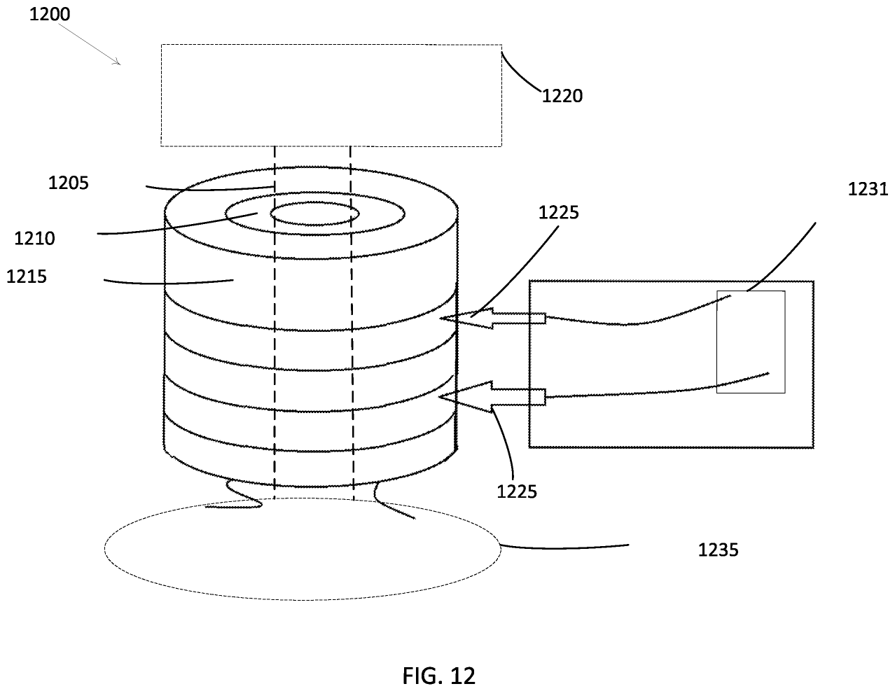

Referring to FIG. 12, a schematic diagram of a slip ring suitable for providing electrical signals such as power signals, control signals and data to a device that is rotatable such as an FFF head or a print head or another applicator or tool. The slip ring 1200 can facilitate transmission of power and electrical signals 1231 from a stationary to a rotating structure. A slip ring 1200 can be used in any electromechanical system that requires rotation while transmitting power or signals. In relation to the 3D printing system shown in FIGS. 9A and 10, the system utilizes slip rings 1200 to electrically connect with various systems within the 3D printing system.

In one embodiment, the slip ring is utilized by the spool assembly to allow the applicator /tool head and spool to rotate independently relative to slip ring and structures attached or supporting the slip ring. The spool assembly includes the spool 1220, elongated member 1205, and the tape applicator 1235. The slip ring includes an inner 1210 and outer 1215 cylinder, wherein the inner cylinder 1210 is electrically connected to one or more portions of the spool assembly. In various embodiments, the inner cylinder 1210 is electrically connected to electrical control and power wires 1225 for the rotating applicator/tool head 1235, where the wires go through a bore or channel defined by the elongated member 1205. In one embodiment, the bore or channel is central disposed in the elongated member.

In one embodiment, the outer cylinder is electrically connected to control and power wires originating from outside the spool assembly. In some embodiments, the electrical control and power systems of a 3D printing systems provide power and direction to the spool assembly using the slip ring. Between the inner and outer cylinders are electrical couplers capable of maintaining an electric connection while the inner cylinder is moving. In some embodiments, the electrical couplers include stationary metal contacts (i.e., brushes) which rub on the outside diameter of a rotating inner cylinder. As the inner cylinder turns, the electric current or signal is conducted through the stationary brush to the outer cylinder to make the connection. In various embodiments, brush assemblies are stacked along the rotating axis to provide for multiple electrical circuits as needed. The slip ring can be used to transmit power, control signals, data, and other information to control the applicator and other components in electrical communication therewith. Various configurations of slip rings can be used to facilitate power/signal deliver to an applicator that rotates in conjunction with a material storage spool.

For example, each of the tool heads moves and rotates within the housing of the 3D printing system and thus each uses a slip ring or other coupler to electrically connect with the power systems and electrical control systems of the 3D printing system. Many of the methods and devices for heat management and/or cooling and implemented in conjunction with a slip ring, to allow each of the tool heads to be cooled while still enabling unfettered movement. In one embodiment, one or more conduits for coolant are passed through a hole or channel defined in whole or part by slip ring or a component thereof.

In various embodiments, heat management and/or cooling systems are incorporated in various modular print heads or tools that are used by the system. In various embodiments, heat management and cooling techniques connect to one or more systems within a 3D printing system through a slip ring. In some embodiments, a slip ring is an electromechanical device that allows the transmission of power and electrical signals from a stationary to a rotating structure. In some embodiments, heat management and cooling techniques are applied directly to external portions of each respective tool head. In some embodiments, a combination of internal and external cooling methods and systems are used to manage the head created by the 3D printing system. For example, in one embodiment, a 3D printing system can apply water and/or other coolants to the external portion of an FFF head while internally periodically cycling refrigerated compressed air throughout the system.

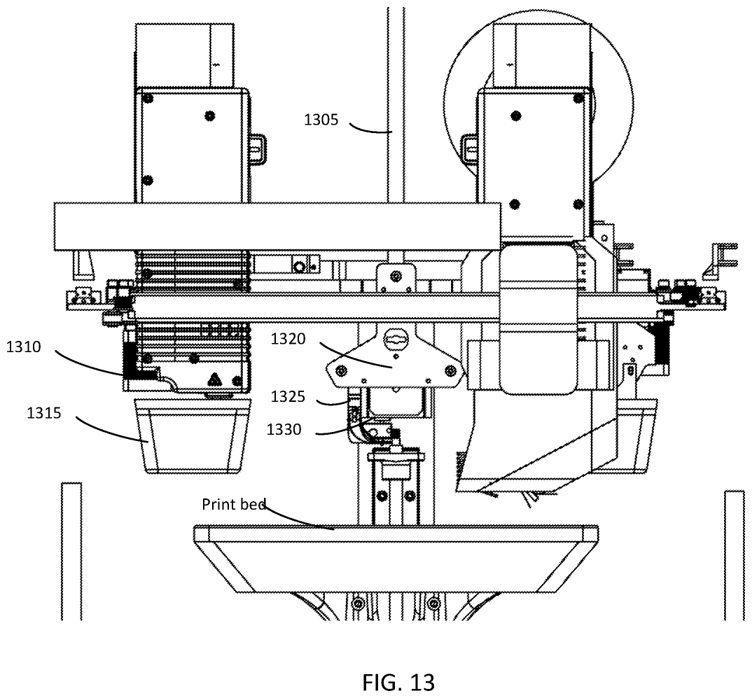

Referring to FIG. 13, which is a simplified illustration of various cooling methods utilized to manage heat within a 3D printing system, in accordance with an embodiment of the present disclosure. As shown, the 3D printing system includes various tool heads. In this instance, the 3D printing system includes a tape head 1310 and an FFF head 1330. The tape head 1310 is configured to utilize cooling when not in use. When not in use, the tape head 1310 is placed in a heat collector or heat dump 1315, which removes heat from the tape head. In this embodiment, the heat collector/dump includes 1315 a thermal material and configured and constructed to contact with the tape head 1310 when placed in the holding bracket. In one embodiment, surface area contact between heat dump/collector 1315 and tape head 1310 is increased and aligned such that regions of heat in tape head 1310 contact the heat collector/dump.

When in the holding bracket, the heat dump 1315 pulls heat away from the tape head thereby reducing the temperature of the tape head in between uses. Also shown is the FFF head 1330, which is electrically connected to the 3D printing system using a slip ring 1325. In this embodiment, piping is plumbed from the FFF head 1330 to the slip ring 1325 and from the slip ring 1325 to an external connector. A pump runs periodically to provide suction to the piping 1305, which pulls heat out of the FFF head 1330 through the piping 1305. As shown, in one embodiment, the piping 1305 is plumbed along with the wiring.

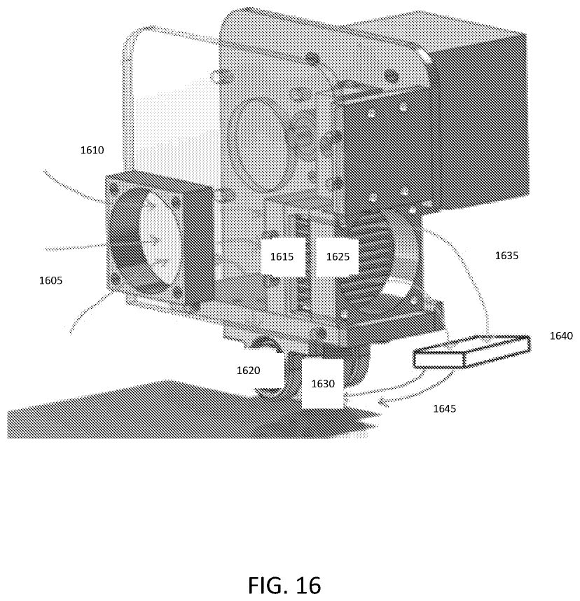

Referring to FIG. 16, which is a simplified diagram of cooling systems and methods applied to a system within a 3D printing system, in accordance with an embodiment of the present disclosure. In some embodiments, the rollers are compaction rollers. The rollers can be made of any suitable material. In some embodiments, the rollers include materials having a high thermal conductivity. By selecting rollers formed from a material having a high thermal conductivity, faster cooling of the rollers may be achieved in some embodiments. In some embodiments, the rollers include a metal. For example, in some embodiments, the rollers (e.g., compaction rollers) include aluminum, steel, copper, titanium, chromium, nickel, zinc, or combinations thereof. In some embodiments, at least 50 vol %, at least 75 vol %, at least 90 vol %, at least 95 vol %, at least 99 vol %, or more of the rollers are made up of metal. In some embodiments, the rollers include holes around the outer perimeter of the rollers.

In some embodiments, the system described herein includes a first device configured to direct fluid. The first device may be used for cooling one or more components of a printer head (e.g., the compaction rollers of a printer head and/or a tape feed heat sink). The device may, in certain embodiments, be capable of directing fluid toward the one or more components. For example, FIG. 8 illustrates an exemplary 3D schematic of a printer head that includes the recyclable heating and cooling system described herein. FIG. 16 depicts a first device 1610, which is configured to direct fluid 1605 (depicted as arrows) toward one or more components of the printer head. In accordance with certain embodiments, first device 1610 is a fan, and fluid is ambient air.

Referring again to FIG. 16, in accordance with certain embodiments, first device 1610 directs fluid toward compaction roller 1620 and/or heat sink 1615. The first device 1610 may direct the fluid toward the one or more components via a duct (not picture in FIG. 16). In some embodiments, the temperature of the fluid is lower than the temperature of the rollers and/or the heat sink. Therefore, in some embodiments, heat is transferred from the one or more components of the printer head (e.g., the rollers and/or heat sink) to the fluid, thereby cooling the one or more components and heating the fluid.

For example, in some embodiments, heat is transferred from compaction roller 1620 and/or heat sink 1615 to fluid 1605 after it is directed by first device 1610, thereby cooling compaction roller 1620 and/or heat sink 1615 and heating fluid 1605, which, when heated, is referred to in FIG. 16 as heated fluid 1635 (depicted as arrows). In some, but not all, embodiments, the fluid directed toward the component(s) by the device is a gas (e.g., air). In some embodiments, the fluid directed toward the component(s) is a liquid (e.g., a cooled liquid). In some embodiments, the first device is a fan. The fan may, in certain embodiments, blow air at the rollers while the rollers are in operation. For example, in some embodiments, the rollers are compaction rollers as part of a printer head (e.g., the first printer head described below), and as the compaction rollers apply pressure to heated pre-impregnated tape, the fan flows air at the compaction rollers. In some cases, this active airflow contributes to faster cooling of the compaction rollers than passive cooling methods (such as methods in which the compaction rollers are exposed only to non-actively directed, room-temperature air).

In some embodiments, the heated fluid (i.e., the fluid heated by the one or more components of printer head, such as the roller) is directed toward a heating element (which may be part of the printer head). For example, referring to FIG. 16, heated fluid 1635 is directed toward heating element 1640. In some embodiments, the heated fluid is directed (at least in part) toward the heating element by the first device configured to direct fluid. In some embodiments, an optional second device configured to direct fluid directs the heated fluid toward the heating element. In some embodiments, the printer head includes the second device (e.g., a fan located in the printer head between the one or more components that are cooled and the heating element). For example, FIG. 16 depicts, in accordance with certain embodiments, optional second device 1625, which directs heated fluid 1635 toward heating element 1640. In some embodiments, the heated fluid is directed from the one or more components to the heating element via a duct (not pictured in FIG. 16).

The flow of the heated fluid past or into contact with the heating element may result in heat being transferred from the heated fluid to the heating element or gas (e.g., air) in close proximity to the heating element. For example, in some embodiments, heated fluid 1635 transfers heat to heating element 1640 and/or gas 1645 (shown as arrows in FIG. 16). In some embodiments, the gas in close proximity to the heating element is heated by a combination of heat from the heated fluid and heat from the heating element.

In some embodiments, the heating element is any suitable element capable of heating a gas (e.g., air) to a temperature above the melting temperature of the thermoplastic of the tape may be suitable. In some such embodiments, the heating element heats the tape without contacting the tape. Rather, the heating element heats the tape by heating gas in close proximity to the heating element, and the gas subsequently heats the tape, in accordance with certain embodiments. Referring to FIG. 16, in accordance with certain embodiments, heating element 1640 heats tape at nip point 1630 by transferring heat to gas 1645 (e.g., a hot air stream), which then heats the tape at nip point 1630 (e.g., by convective heat flow).

The heating of the gas in close proximity to the heating element may be assisted by the transfer of heat from the heated fluid directed toward the heating element by the first device and/or the second device described above (e.g., a first and second fan). Such heating of the tape may cause the tape to partially melt, thereby assisting in the bonding/consolidating of the tape during the 3D printing of a composite structure. In some embodiments, the heating element is a heat block. In some embodiments, the heat block (e.g., a copper heat block) is heated by a thermistor, while a thermocouple monitors and controls the temperature of the heat block via a feedback loop. In some embodiments, the heating element is an electrical resistance coil.

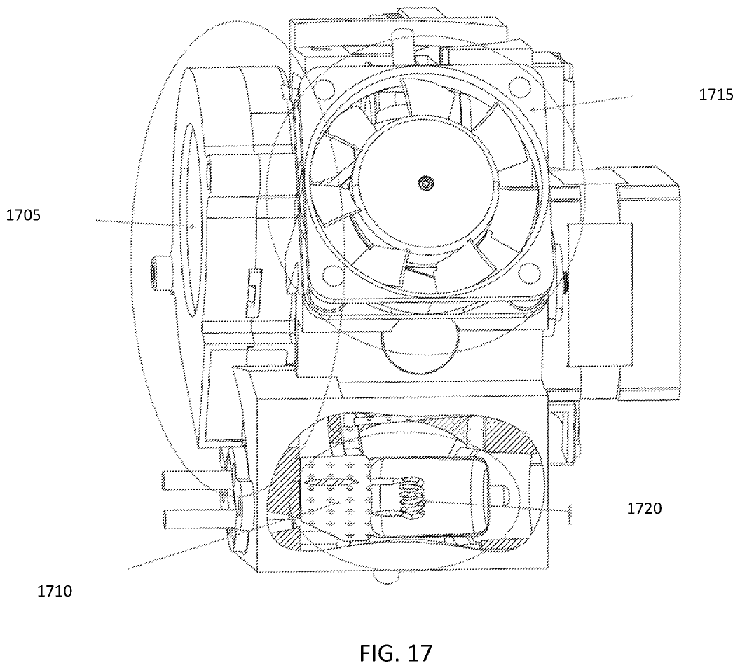

Referring to FIG. 17, which is a simplified diagram of multiple heat management and/or cooling methods utilized to manage heat created by one or more systems disclosed herein. As shown, a heat source, such as an IR bulb 1720, is electrically connected to a tool head, wherein the heat source is enabled to heat prepreg tape. A thermal cooling element (i.e., a heat sink) is placed proximate to the leads of the heat source. In one embodiment, ducting within the head routes cool air (or other coolant/fluid) from a fan 1715 or other source of cooled air (or other coolant/fluid) to a heat sync or other heat absorbing element that is proximate to the leads 1710 of the heat source to maintain a specified temperature. In various embodiments, the temperature of the heat source can be set to a specific temperature and/or a temperature range, such as from about 180° C. to about 450° C. In one embodiment, the tool head includes electronics in communication with and controlling a heat source such as contactless heat source. In one embodiment, a heatsink and/or a heatsink and cooling fan 1705 are used to cool the electronics and limit or prevent spread of residual heat from heat source to any nearby electronics or heat sensitive assemblies.

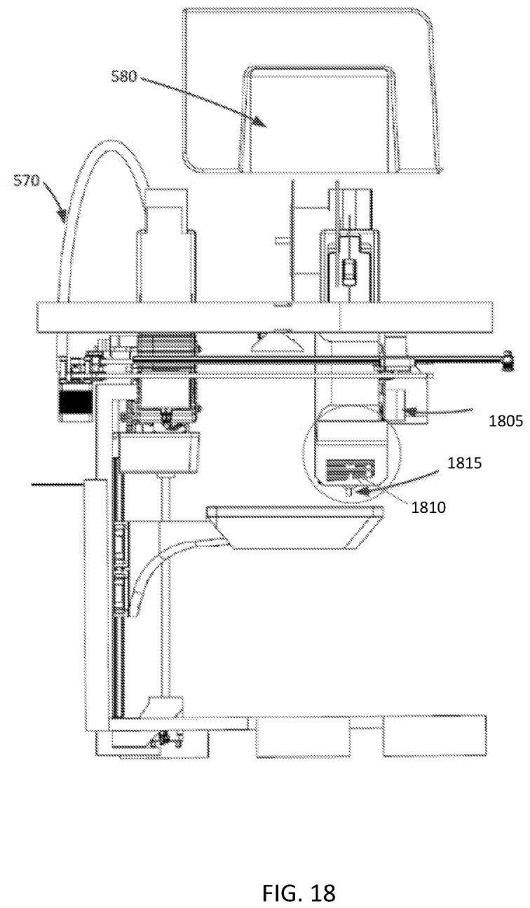

Referring to FIG. 18, which is a simplified diagram of the tool head, shown in FIG. 17, utilized within a 3D printing system. As shown, the heat management subsystems and/or cooling methods are attached to or otherwise used with the heating and cooling module 1810. In one embodiment, this module 1810 is currently engaged by the tool grabber 1805. The heating and cooling module 1810 utilizes forced air in combination with a heat sink to cool the heat source and electronics in close proximity to the heat source, for example tape head 1815.

### Exemplary Multiple Applicator Implementations and Features

In part, the disclosure relates to methods and systems for manufacturing composite parts and other parts using a system that supports a multitude of heads or tools having different functionality and capabilities. The disclosure relates to various print or deposition heads as well as various other heads that can be used in conjunction or interchanged therewith to achieve various objectives related to manufacturing, assessing, testing, and creating a complex part, whether of one material or multiple materials. In addition, applicators can be changed at any stage of the fabrication, inspection, measurement, and testing processes for a given part. The ability to swap applicators supports building a part that include different materials such as composite materials, FFF-based materials, and metal components such as electrical traces, reinforcing structures, or other structures.

In general, the disclosure relates to systems and methods of fabricating composite parts or workpieces. Various embodiments address or mitigate one or more of the issues identified above. The use of composite materials in parallel or in isolation helps obviate or reduce the problems with certain FFF-based approaches. As disclosed herein, the composite parts can be formed using various systems that transform lengths of tapes or tows that include a matrix or carrier material such as a thermoplastic or thermoset material. The matrix or carrier material includes multiple reinforcing fibers such as carbon fibers, for example.

### Exemplary Modular Multi-Head/Multi-Tool System

FIG. 10 shows an exemplary modular multi-head/multi-tool system 5 for fabricating various types of 3D parts. The system 5 includes an outer housing, which supports a plurality of moving parts configured and constructed to fabricate various types of 3D parts. At the center of the system 5, is a build plate 23 with a removable sheet 23 thereon. The system 5 uses a vacuum pump to provide suction through the tubing 45 to vacuum down the removable sheet 23. The vacuum pump is activated using the switch 35. The build plate 23 is attached to a mechanism enabled to move the build plate 23 in the z axis. The motor 65 drives a belt which moves the build plate 23 along the z axis. In one embodiment, the build plate is a flat build plate with silicone heaters that provide the heating. In one embodiment, a fiberglass-epoxy laminate sheet (for example a Garolite sheet) is clamped over or otherwise fastened to the top of the build plate.

The system is powered and controlled by power supply 37 and electrical control systems 40. In this instance, power supply 37 and electrical control systems 40 provide power to heating cartridges using cabling 44 and cabling 42. In most embodiments, heating cartridges are thermally coupled to the build plate 23. The heat cartridges are designed to raise the temperature of the build plate 23 from a first temperature to a second temperature, wherein the second temperature is higher than the first temperature. Operation of the system at a second temperature facilitates adhesion of materials used on the build plate 23. In some embodiments, the cartridges can be heating elements disposed within the build plate 23.

Above the build plate 23, tool/applicator grabber 55 is placed in the middle of the 3D printer 5 and is enabled to move in three dimensions. The applicator grabber 55 is connected to the electrical control systems 40 and the power supply 37 using cabling 27. The tool/applicator grabber 55 has a motor that rotates a pin. After the pin has been aligned and inserted into a socket in the kinematic coupling plate, the tool/applicator grabber 55 is capable of using the tool connected to the kinematic coupling plate. A pin or other structure can be used to engage and release from a subsystem that receives the foregoing as part of the applicator changing process. As shown in FIG. 1, kinematic coupler 10 is connected to a tape head, kinematic coupler 15 is connected to an FFF head, and kinematic coupler 20 is connected to the ultrasonic cutter 21.

The tape head 10 receives control signals from the electrical control systems 40. The cabling from the electrical control systems 40 to the tape head are routed through the cable carrier/chain 10a. The electrical control system 40 can control the head rotation, feed of the tape, servo for cutting, load cell for pressure monitoring, ppyrometer for temperature, as well as other I/O for the tape head. Cabling 15a connects the FFF head to the electrical control systems 40 and power supply 37.

Cable carrier/chain 20a is utilized to hold the wiring for the ultrasonic cutter. In many embodiments, the tool heads connected to each of the kinematic couplers can be changed. Both the position and the tool connected to the kinetic coupler may be modified. In this embodiment, the tape head is supplied with tape from the prepreg tape spool 60. The FFF head is supplied with plastic filament from the spool 25. Force gauge 33 is enabled to monitor compaction force measured by the load cell in the tape head. In various embodiments, the build plate 23 is enabled to move based on the pressure detected by the force gauge.

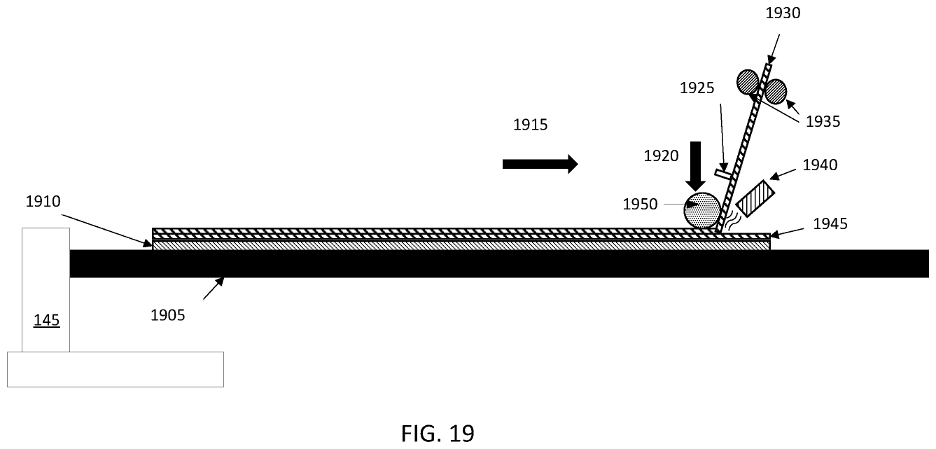

FIG. 19 is a simplified diagram of a prepreg tape applied by a tape head under the direction of a modular multi-head/multi-tool system. As shown, a support base 1910 lays on top of the print bed 1905 and a tape tool head (not shown) lays prepreg tape 1930 on the support base 1910. The tape tool head heats the prepreg tape 1930 coming into the tape tool head using the heating element 1940 and lays the prepreg tape on a previous layer of prepreg tape 1945. In various embodiments, the heating element 1940 heats the compaction roller and/or the prepreg tape 1930. Upon placement of the prepreg tape 1930, the tape tool head applies a compaction force, shown by arrow 1920, on the freshly laid prepreg tape 1945 using a roller 1950. In some embodiments, the roller maintains a set temperature to facilitate compaction of the prepreg tape. Once placement of a layer of prepreg tape is complete, the tape head cuts the prepreg tape using a cutting blade 1925. The prepreg tape is guided into, and through, the tape tool head using a plurality of tape feed rollers 1935 which align incoming tape with the alignment of prepreg tape applicator portion of the tape head tool. In various embodiments, prepreg tape maintains alignment from an input spool to application.

### Exemplary Tool/Applicator Changing

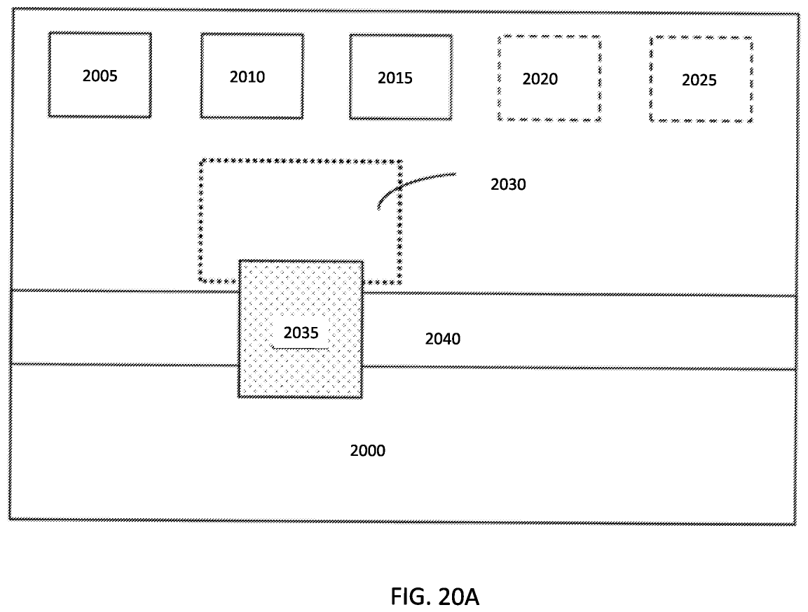

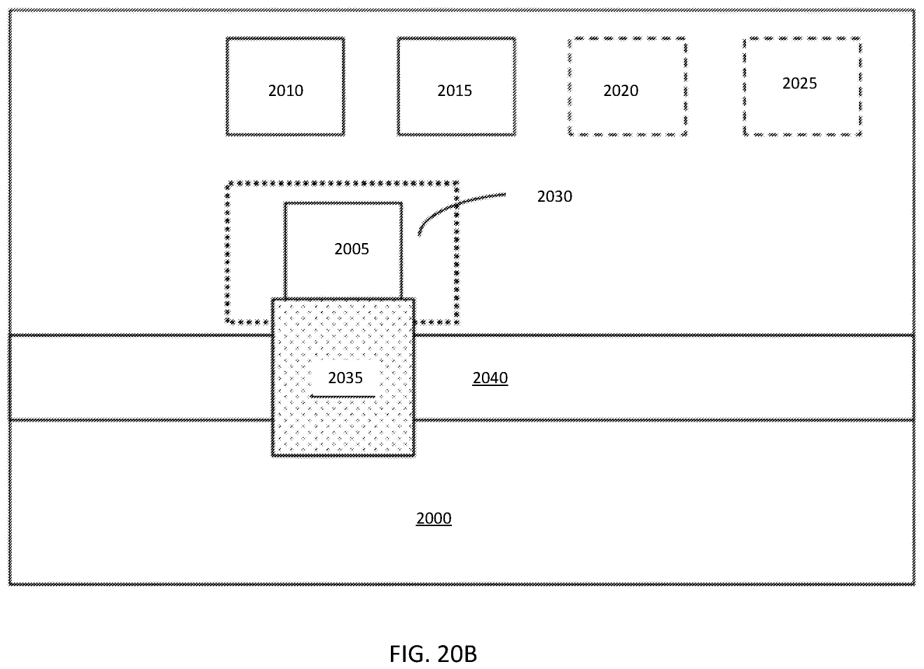

FIGS. 20A and 20B depict an exemplary schematic of a top-down view of system that supports applicator changing, grabbing, or swapping as described herein, in accordance with certain embodiments. The systems and methods disclosed herein are designed to support end-to-end manufacture by supporting multiple applicators that can be used and swapped to fabricate parts and sections of parts with different components. In general, the reference to applicator herein encompasses various heads, tools, devices, and other apparatus that can be coupled and decoupled from a system by which a given applicator translates through space in response to processor control signals to build a part, test a part, finish a part, and perform other tasks and use different consumables as part of the build process.

The applicator changing/swapping systems described herein are suitable to work with various types of applicators. Suitable applicators include, without limitation, print heads, tape heads, pre-preg tape heads, FFF-based heads, nozzle-based heads, metrology/inspection heads, cameras, sprayers, water jet apparatus, metal print heads, sintering heads, cutters, ultrasonic cutters, subtractive devices, drilling devices, stamps, corrective heads to reform defects, filament-based heads, sensors/detectors, temperature sensors, pressure sensors, grabber/positioner devices, engraving heads, electrical conductor printing devices, pick and place heads, torch/heat sources, combinations of one or more of the foregoing, and other heads and devices suitable for processing, testing or building a part/workpiece. One or more of the heads may be combined to form a combination head. For example, a cutting head, such as an ultrasonic cutter can be combined with an inspection head. An inspection head can include a camera,

FIG. 20A shows motion platform 2000 including gantry 2040 and tool changing element 2035 attached to gantry 2040. Tool changing element 2035 is capable of coupling with any one of printer heads 2005, 2010, and 2015 (or optional printer heads 2020 and 2025). In some embodiments, the tool changing element 2035 couples to a printer head (e.g., via translation of the tool changing element via the gantry such that the tool changing element comes into contact and couples with the printer head). Once coupled, the gantry 2040 may translate the tool changing element 2035 and the now-coupled printer head to the portion of the motion platform 2000 where printing (e.g., printing a composite structure or mold for a composite structure) is to take place. For example, referring to FIG. 20B, tool changing element 2035 may be translated by gantry 2040 to come into contact and couple with first printer head 2005, and which, once coupled can be translated to portion 2030 of motion platform 2000 where printing is to take place. In some embodiments, a given applicator/tool head can be a combination system, such as one or more inspection elements combined with another subsystem such as cutting device, such as an ultrasonic cutter.

At a later point in time, the gantry 2040 and tool changing 2035 element may return the printer head 2005 to its original location away from the portion of the motion platform where printing is to take place and decouple the printer head. The tool changing element 2035 can then translate to and couple to a different printer head (e.g., the second printer head, or the third head). For example, in accordance with certain embodiments, after laying down fiber-reinforced tape at portion 2030 of motion platform 2000, first printer head 2005 may be returned to its original location and decoupled from tool changing element 2035, and subsequently, tool changing element 2035 may couple to third head 2015 (i.e., first head 2005 is swapped with third head 2015) including, in accordance with certain embodiments, a subtractive manufacturing element such as an ultrasonic trimmer, which can be translated to over to the laid-down tape at portion 2030 of motion platform 2000 and then trim the laid-down tape structure as desired. Numerous combinations and sequences of swapping and using the modular heads via tool changing are possible, depending on the design and requirements of the structure desired to be manufactured.

In some embodiments, the tool changing of the system described herein allows for efficient swapping between different types tape-laying printer heads (e.g., printer heads that lay down fiber-reinforced thermoplastic tape like the first printer head described herein). For example, in some embodiments, the system includes the first printer head described herein and a fourth printer head. In some embodiments, the fourth printer head is relatively similar to the first printer head, but lays down a tape having a different width than the tape of the first printer head.

For example, referring to FIG. 20A and in accordance with certain embodiments, first printer head 2005 is configured to lay down tape having a first width and fourth printer head 2020 lay down tape having a second width, wherein the first width and second width are different. Having different printer heads that lay down tape with different thicknesses, and being able to easily switch between the different heads via tool changing, may be beneficial. For example, when manufacturing a structure, during flatter parts, it may be advantageous to deposit wider tapes to increase process speeds, while when finer resolution is required; it may be advantageous to use narrower tapes.

Swapping between the two different tape-laying printer heads (e.g., the first printer head and the optional fourth printer head) can therefore lead to more efficient processing. In some embodiments, the fourth printer head is relatively similar to the first printer head, but lays down a tape including a different material altogether than that of tape of the first printer head (e.g., the tape including a different type of fiber or different type of thermoplastic polymer). For example, the first printer head may lay down a tape including one type of fiber (e.g., carbon fiber), while the fourth printer head may lay down a tape including a second, different type of fiber (glass fibers). In some embodiments, this may allow for the efficient manufacturing of composite having a core structure of one material (e.g., carbon-fiber reinforced thermoplastic) and an outer layer of another material (e.g., fiberglass). Other beneficial configurations are also envisioned, including, for example, ones in which metal structures are printed within composite layers (e.g., a copper mesh printed within a layer to create a lightning strike protection material system). The print heads discussed above and swapping relative thereto can be performed with regard to any of the print heads disclosed herein.

In some embodiments, the tool changing of the system described herein allows for efficient swapping between different types of filament-extruding printer heads (e.g., printer heads that extrude polymer filament to create support structures or molds, such as FFF heads). For example, in some embodiments, the system includes the second printer head described herein and a fifth printer head. In some embodiments, the fifth printer head is relatively similar to the second printer head, but extrudes a different polymer than the polymer extruded by the second printer head. For example, referring to FIG. 20A and in accordance with certain embodiments, second printer head 2010 is configured to extrude polymer of a first type and fifth printer head 2025 extrudes polymer of second type, wherein the first type of polymer and second type of polymer are different. Having support (or different parts of the same support) made of different polymers may be beneficial, especially in cases where the supports are used in combination with fiber-reinforced thermoplastic tape for making high quality composites.

For example, in some embodiments at least a portion of a support may be bonded directly to the thermoplastic tape (e.g., laid down by the first printer head). An example of such an embodiment is a sandwich composite where the composite facesheets bond to a plastic internal core. In some embodiments, at least a portion of the support may be desired to separable from the thermoplastic tape (i.e., no bonding between the polymer of the support and the thermoplastic tape). Having two different polymer-extruding heads (e.g., two different FFF heads, one which extrudes polymer that can bond to the tape, the other which extrudes polymer that does not bond to the tape) that can be automatically swapped via tool changing on the motion platform is therefore beneficial.

The different heads may be coupled to (and decoupled from) the tool changing element via a number of suitable known techniques. For example, in some embodiments the heads (e.g., the first printer head, the second printer head, the third printer head including a subtractive manufacturing element) are coupled (and decoupled) to the tool changing element via kinematic couplings. Other coupling techniques include using rigid couplings such as those that feature clevis pin connections and/or threaded studs, other grips, clamps, or fixtures that can mechanically, pneumatically, or magnetically provide attachment points for the various heads.

While embodiments having three, four, or five different heads that can be swapped via tool changing have been described herein, the methods and systems described herein are scalable and can be used for any suitable number of heads (and types of heads), depending on the size of the motion platform, the available space, and the desired applications. In addition, combined heads that include multiple subsystems such as cutting and printing, or metrology and cutting can also be used and swapped for other combination heads.

In some embodiments, mechanical coupling, magnetic coupling, tongue and groove, suction-based, pressure fit, pneumatic, and other systems can be used to engage an applicator, release an applicator, and then switch to another applicator. One or more robotic elements, gantries, frames, and other elements can be used to support applicator swapping, docking, releasing, and storage.

Systems and methods relating to tool changing during the layer-by-layer assembly of composite structures are generally described. The layer-by-layer additive and subtractive process is achieved using two-dimensional routes for a given applicator. In one aspect, a 3D printing system including a motion platform and multiple modular heads is provided. The heads may, in some embodiments, be used for manufacturing high quality continuous fiber reinforced structural parts. In some embodiments, the heads are modular printer heads as well or other types of heads, such as heads including subtractive manufacturing elements. The motion platform of the printing system may include a tool changing element that allows the motion platform to automatically switch or swap between the multiple heads to which the motion platform is coupled (e.g., via an XYZ gantry), This process is referred to herein as applicator tool or head changing.

In some embodiments, the system includes a first applicator configured to lay down tape (e.g., a thermoplastic tape including continuous fibers). In certain embodiments, the system further includes a second applicator configured to deposit material (e.g., by extruding polymeric filaments). In some embodiments, the system includes a third applicator including a subtractive manufacturing element (e.g., an ultrasonic trimmer) configured to trim or mill portions of the composite material laid down. In some embodiments, each of the first printer head, second printer head, and third head are configured to couple with a tool changing element of the motion platform.

Accordingly, the system may then have a capability of swapping between the first applicator, second applicator, or third head as needed during different steps of the printing process. In some cases, the first applicator, second applicator, and third head may be used together to rapidly fabricate high quality structural parts suitable for a variety of applications (e.g., aerospace-grade composite material systems at aerospace quality). In some aspects, the fabrication of the composite structures occurs via additive and/or subtractive processes.

In some embodiments, the second applicator deposits a mold structure, and, subsequently, the second applicator is swapped (e.g., via tool changing) in the motion platform for the first applicator, which lays down a layer of tape onto the mold structure (an additive process), at which point the first applicator is swapped for the third head, which machines the laid-down tape (e.g. via ultrasonic cutting or milling, a subtractive process). In some embodiments, the first applicator is swapped in to the motion platform and then lays down an additional layer of tape and consolidates the additional layer of tape with the laid-down tape (e.g., via a combination of heat and/or compaction force, as described below). In some embodiments, the first applicator, second applicator, and third head, as well as the tool changing of the heads on the motion platform, are robotically controlled. In some embodiments, the system may include an optional fourth head, an optional fifth head, or more, each of which is different from the first applicator, second applicator, and third head, depending on the requirements of the structure being manufactured, as described below.

### Ball Lock

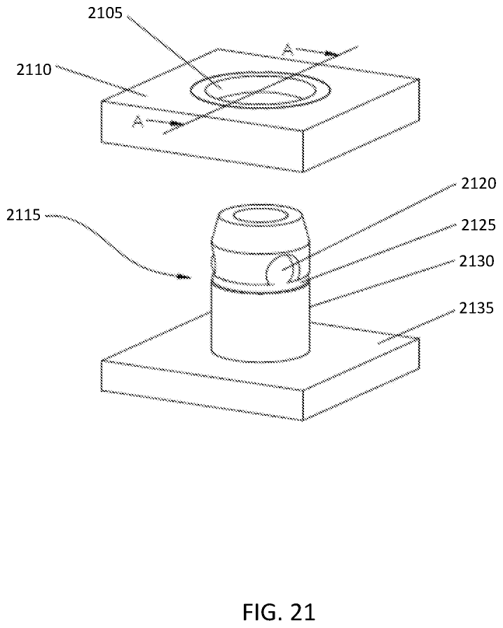

Various subsystems can be used to support changing applicators. FIG. 21 is an embodiment of a ball lock applicator changer for bringing separate plates (in this case, a retainer plate 2110 and shank plate 2135) together. In an embodiment, the shank assembly 2115 is mounted to the shank plate 2135 and contains a shank 2130, ball retaining ring 2125, three locking balls 2120, and one actuating ball 2225. While not mating, the ball retaining ring 2125 ensures the locking balls 2120 do not become dislodged from the shank assembly 2115. Additionally, a retainer 2105 is mounted to the retainer plate 2110. Both components of the ball lock applicator changer, the shank assembly 2115 and the retainer 2105, are mounted using stepped lips, which allow the pulling forces created by locking to pull and lock the retainer plate 2110 and shank plate 2135 together.

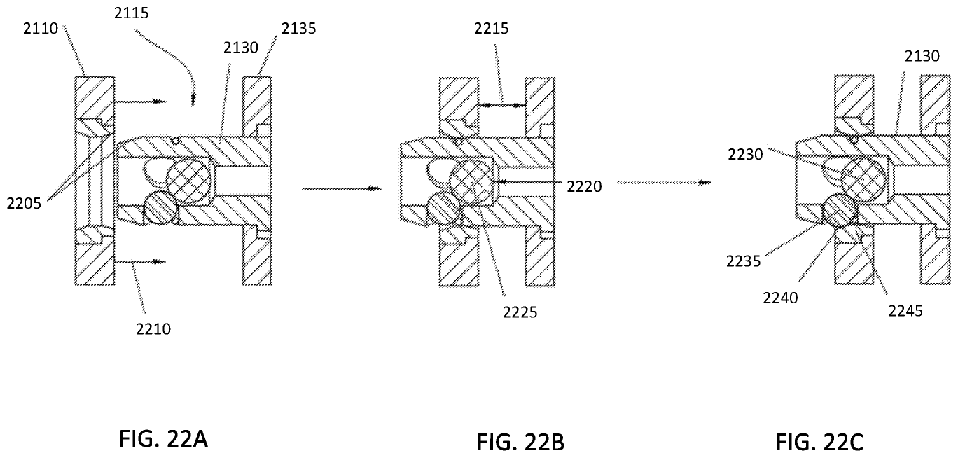

FIGS. 22A-C show the ball lock tool change in various positions during the locking method. In FIG. 22A, the shank assembly 2115 and retainer 2245 are aligned such that the components can mate. In this embodiment, the shank 2130 and retainer 2245 may include features to increase the locational tolerance and allow for easier mating, such as tapered faces 2205. Once aligned within tolerance, a relative displacement 2210 between the retainer plate 2110 and shank plate 2135 is required to bring the plates to within an adequate locking distance. In FIG. 22B, the embodiment is shown at the locking distance 2215. This distance can be set by spacers, stand-offs, or features elsewhere on the plate (not shown in this embodiment). Once the two plates have reached the locking distance 2215, a linear displacement 2220 is applied to the actuating ball. The linear displacement 2220 may be prescribed by a linear actuation (electric, hydraulic, pneumatic, or the like), lead screw, or electromagnet (not shown in this embodiment).

As the actuating ball 2225 is driven by the linear displacement 2220, it comes into contact with the locking balls 2235, and due to being geometrically constrained forces the locking balls 2235 outward radially. As shown in FIG. 22C, once the locking balls 2235 come into contact with the retainer 2245 mating surface 2240, the locking balls 2235 become over-constrained, and begin forcing the retainer 2245 towards the base of the shank 2130, and subsequently the retainer plate 2110 towards the shank plate 2135. The ball retaining ring 2125 is compliant and does not impede the movement of the locking balls 2235. At this point, until the linear displacement of the actuating ball 2225 is reversed, allowing the ball retaining ring 2125 to retract the locking balls 2235, the mated shank assembly 2115 and retainer 2245 will remain locked to considerable forces.

Other embodiments of the ball lock applicator changer may not require a fixed locking distance, but may use features on the retainer mating surface to allow for locking at a fixed location, as opposed to creating a pulling motion, such as a semi-circular swept profile or spherical indentations. Additionally, a ball retaining ring may not be required if other features in the shank are included to prevent the dislocation of the locking balls. Without the means for forced retracting of the locking balls, though, there is a chance they may become lodged in the retainer and prevent un-mating of the assembly.

Each modular print head or tool can include an authenticator suitable for recognition by the system to identify the properties of the print head and the constraints by which it can be used with a program or instructions to print a 3D part. The authenticator can include a bar code or glyph that can be scanned by a camera or other optical element to identify the print head. In another embodiment, the authenticator includes an RFID chip or other source of identification.

### Exemplary Subtractive Elements/Cutting Tools Implementations

In part, one or more of the tools or modular print heads described herein can include a cutting device that is suitable for subtractive processing. Accordingly, in part, the systems and methods of the disclosure relate to subtractive processing during 3D printing processes are generally described. In some embodiments, a device capable of performing a subtractive process on a material (e.g., by cutting, trimming, milling, or otherwise removing the material) is used in conjunction with a 3D printing system that prints structures that includes that material. In some embodiments, the 3D printing system includes multiple print heads that can be docked and interchanged as described herein.

In some cases, the printer head is an extrusion/deposition head for an FFF process. In some cases, the printer head is one configured to lay down continuous-fiber tape (e.g., that includes thermoplastic material). In some embodiments, the device capable of cutting or trimming a material is mounted on to the printer head (e.g., a printer head capable of depositing/extruding the material). In some cases, the 3D printing process is a layer-by-layer process, wherein layers of the material are deposited and in discrete steps. Such processes are additive processes. Generally, with 3D printing processes such as FFF processes, there is a trade-off between the speed of the additive printing process, tolerances, and surface finish. Larger nozzles (e.g., in the printer heads) are used in extrusion-based additive manufacturing methods to achieve faster speeds, but at the expense of tight tolerances.

By employing subtractive processing techniques such as trimming the edges of a print after each layer, tolerances can, in certain embodiments, be improved dramatically while maintaining the desired faster printing speeds. In one embodiment, the cutter is a pneumatic cutter and is powered by air delivered by a compressor. In one embodiment, the cutter includes one or more conduits or flow paths in fluid communication with an input port to the 3D printing system. In one embodiment, a compressor may connect to the input port and supply air for powering the pneumatic cutter.

In some embodiments, the device capable of performing the subtractive process (referred to herein as a subtractive processing device) is a knife. In some embodiments, the subtractive processing device is a cutting device. The device may include an ultrasonic cutter or other mechanical, optical, pneumatic, electronic, and other cutters suitable for removing FFF-based material and/or prepreg composite tapes. Ultrasonic cutters s use ultrasonic sound waves to create microscopic vibrations, which, in some cases, assist in cutting or trimming materials without requiring a significant range of motion. Ultrasonic cutter suitable for the systems and methods described herein are commercially available from the following non-limiting list of vendors: Honda (USW 335 Ti) SharperTek, Dukane, Sonotec, and Cutra (Wondercutter). An ability to cut or trim materials without requiring a significant range of motion may be useful in performing subtractive processes during 3D printing.

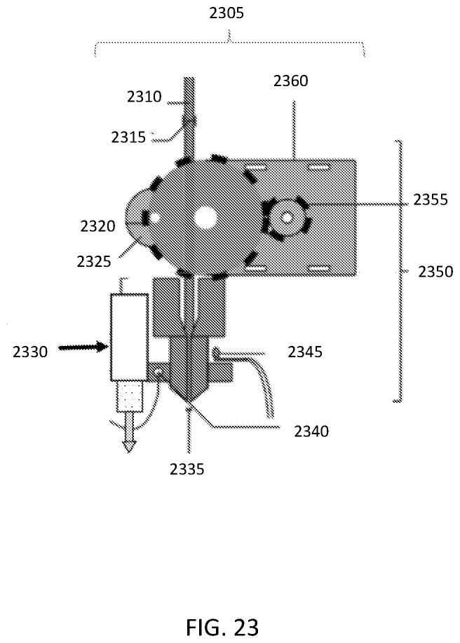

In some embodiments, as mentioned above, the subtractive processing device is mounted on to a printer head. FIG. 23 depicts a subtractive processing device mounted on to a printer head. In some embodiments, the subtractive processing device 2330 mounted on to the printer head is an ultrasonic knife. In some embodiments, the printer head 2305 is part of a system for an FFF process. For example, referring again to FIG. 23, in accordance with certain embodiments, the printer head shown in FIG. 23 is an FFF printer head 2305 (that includes, for example, an extruder 2350, a heater 2340, and a motor 2360), and the subtractive processing device 2330 is an ultrasonic knife mounted on to the printer FFF printer head 2305. The stepper motor 2360 includes a large gear 2320, a small gear 2355, and a bearing 2325 to facilitate moving the filament 2310 of the specified width 2315 through the extruder 2350. The subtractive processing device 2330 is coupled to the FFF printer head 2305 and can be used to trim material. The extrusion width is defined by the nozzle 2335 of the extruder 2350 and the temperature of the extruded filament is managed using a thermistor or thermocouple 2345.

In some embodiments, the device capable of performing a subtractive process (e.g., the ultrasonic knife), is contacted with a printed structure, and controlled movement of the printer head on which it is mounted results in the removal of material from the printed structure. For example, in some embodiments, the ultrasonic trimmer trims the perimeter of the material to create a good finish and ensure tolerances are being met. In some, but not all embodiments, this subtractive process is performed after the deposition of each layer of material (e.g., fused polymeric filament) by the printer head. This can be seen in FIG. 23.

In one embodiment, the use of such a layer-by-layer subtractive method in conjunction with additive printing techniques may, in some cases, allow designers to slightly oversize their part, knowing that they do not need to achieve their target tolerance during the additive laying of the material. Instead, extra material is laid down and subsequently trimmed to achieve the desired tolerances with the added benefit of excellent surface finish (e.g., due to the precision of the ultrasonic cutter, in certain embodiments).

### Exemplary Pressure Sensing and Consolidation/Compaction Features and Implementations

Systems and methods relating to controlling applied pressure during 3D printing processes are generally described. In some cases, the system includes a printer head that is used to lay down and compact composite material in order to fabricate composite parts (e.g., fiber-reinforced aeronautical parts). In certain embodiments, the composite material laid down by the printer head is or includes fiber-reinforced thermoplastic tape.

In some cases, the one or more components of the printer head, such as compaction rollers, may be used to apply pressure to the laid down tape in order to contribute to the consolidation of the composite part. In some cases, a pressure sensor is coupled to the system in order to control the pressure applied during compaction of the composite material. For example, in certain cases, a load cell is coupled to the printer head, and the load cell is configured to measure the pressure applied by to the printer head (e.g., the compaction rollers) by the composite part being fabricated. Measuring the pressure can then, in some embodiments, allow for a feedback loop to be used to modulate the applied pressure as needed. Modulation of the applied pressure (e.g., via a vertical adjustment of a print bed on which the composite part is being printed and/or the printer head based on readings from the pressure sensor) may be useful in promoting uniformity and/or reproducibility during the 3D printing process.

As mentioned above, in some cases, one or more components of the printer head (e.g., the first printer head described in more detail below and depicted in FIGS. 10, 19, and 23), applies pressure to a composite part during the printing process. Continuous fiber-reinforced thermoplastic tapes require both temperature and pressure for consolidation. In a tape-laying 3D printing approach, the material is heated at the nip region and a compaction roller follows the material to apply pressure necessary for in-situ consolidation (For example, FIG. 19 shows a schematic illustration of an exemplary printer head that includes a compaction roller applying pressure to tape being laid down on a print bed. The compaction may, in combination with applied heat, consolidate printed composite material (e.g., fiber-reinforced tape) during printing. Generally, a certain minimum amount of pressure is required to achieve sufficient consolidation of the composite material during printing. For example, in some cases, a pressure of at least 50 kPa, at least 75 kPa, at least 100 kPa, at least 125 kPa, at least 150 kPa, at least 175 kPa at least 200 kPa, at least 250 kPa, and/or up to 300 kPa or more is applied between one or more components of the printer head and the composite part being printed during the printing process.

In some cases, if too great a pressure is applied between one or more components of the printer head and the composite part, defects and/or a lack of uniformity in the printed composite part may occur. In some embodiments, it is beneficial for the variation in pressure applied between one or more components of the printer head and the composite part to be relatively small. For example, in some embodiments, the variation in applied pressure between one or more components of the printer head (e.g., the compaction rollers) and the composite part being printed is less than or equal to 20%, less than or equal to 15%, less than or equal to 10%, or less than or equal to 5% of the pressure being applied. Having a relatively low variation in applied pressure may, in accord certain embodiments, allow for greater reproducibility in the manufacturing of the composite parts.

In some embodiments, the system includes a pressure sensor. For example, a pressure sensor may be coupled to the printer head (e.g., be attached to the printer head). FIG.7 depicts a non-limiting example of a printer head 700 (e.g., a printer head capable of laying down fiber-reinforced thermoplastic tape) coupled to the pressure sensor 705. The pressure sensor 705, in some embodiments, can measure, directly or indirectly, the pressure applied between the printer head 700 and a composite structure or a print bed 710 with which the printer head is in contact during the printing process. The pressure sensor 705 may be any of a variety of suitable devices capable of measuring pressure. For example, in some embodiments, the pressure sensor 705 is a load cell.

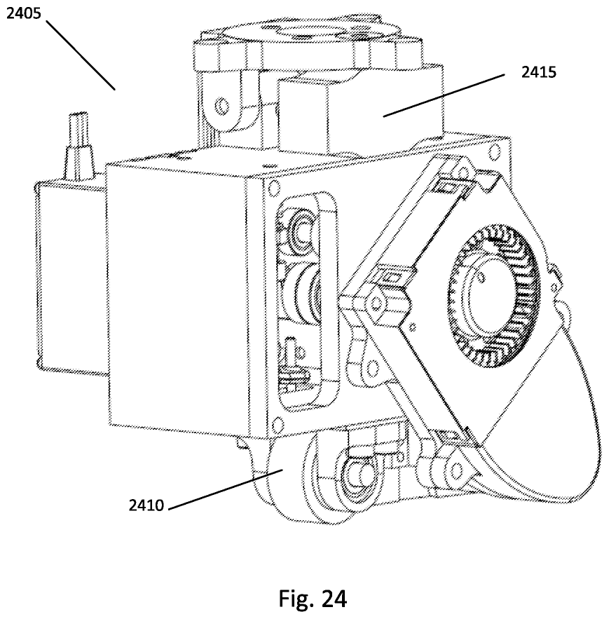

In one embodiment, the load cell may be in contact with the printer head and be configured to measure a normal force from the printer head that is generated when the printer head comes into contact with either the print bed or the composite part being printed. The load cell may then use the measured normal force and a known surface area of contact to calculate the applied pressure. As shown in FIG. 24, when the printer head 2405 shown applies pressure to the composite part (e.g., during compaction), a force is exerted on the printer head 2405 that in turn results in the force being exerted on the load cell 2415 shown. The load cell in FIG. 24 then, in certain embodiments, measures an applied pressure of the compaction process using the compaction roller 2410. The load cell can come in a variety of formats, including, but not limited to, being the load cells, load pins, and/or annular load cells. Load cells suitable for use herein may, in certain cases, be commercially available.

In some embodiments, the measurements from the pressure sensor can be used to adjust the pressure being applied between the printer head and the composite part being printed during the printing process. For example, in some cases, both the pressure sensor (e.g., load cell) and the print bed or mandrel on which the composite part is being printed are coupled to a computer system. The computer system may use the pressure measurements from the pressure sensor to cause a change in the vertical (e.g., Z-axis) position of the print bed or mandrel while the vertical position of the printer head remains the substantially the same, in order to adjust the pressure between the printer head and either the print bed, mandrel, and/or composite part being printed. For example, if, during compaction the pressure sensor detects that the applied pressure between the composite part and the printer head is too great (e.g., exceeds a threshold value), the computer system may then cause the printing system to lower the print bed while keeping the vertical position of the printer head (and its compaction rollers) substantially the same, thereby decreasing the applied pressure. Similarly, if the pressure sensor detects a pressure that is below a certain threshold (e.g., a threshold for achieving sufficient compaction), the computer system may cause the printing system to raise the height of the print bed, thereby increasing the applied pressure.

### Exemplary Rotating Fixtures and Mandrels for 3D Printing and Part Manufacture

Systems and methods relating to the use of rotating fixtures during 3D printing processes are generally described. In one aspect, a 3D printing system is provided. The 3D printing system may include one or more modular heads (e.g., for extruding filament or for laying down fiber-reinforced thermoplastic tape), a motion platform, and/or one or more rotating fixtures. The 3D-printing system may be used in any number of 3D-printing applications, including, but not limited to, Fused Filament Fabrication (FFF) and/or laying pre-impregnated tape that includes continuous fibers and a thermoplastic polymeric matrix to form composites. In some embodiments, a mandrel is coupled to the one or more rotating fixtures such that, when the fixtures rotate, the mandrel also rotates. In some cases, the one or more modular heads are used to print material (e.g., fiber-impregnated tape) on to the mandrel as the mandrel rotates.

Such a process may lead to the 3D printing of closed-section parts (e.g., cylinders, tubes, pressure vessels, etc.). The use of rotating fixtures and/or mandrels may allow for the fabrication of closed-section continuous-fiber-based composite parts that would be otherwise challenging to fabricate using traditional print beds as a base for printing/laying down fiber-impregnated tape. For example, tape that includes continuous fibers may only be able to be laid down by the one or more modular heads in a limited number of orientations, thereby preventing the printing of closed-section parts without the use of such rotating fixtures and/or mandrels.

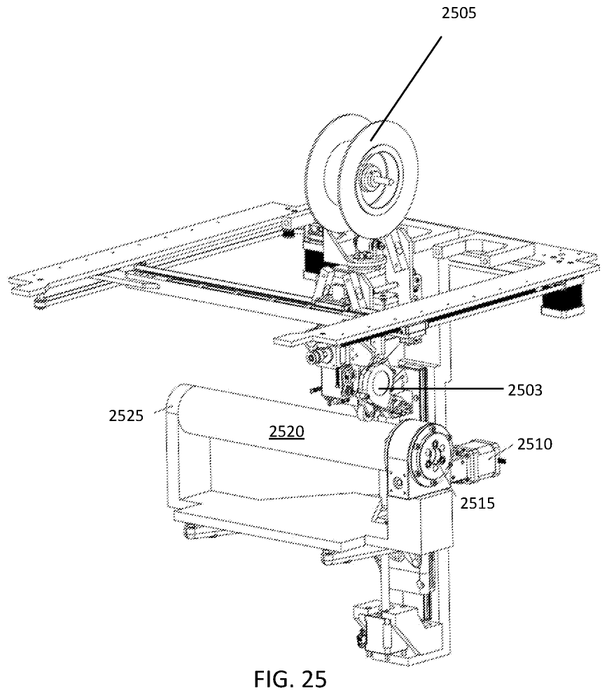

In some embodiments, the 3D printing system includes a 3D printing chamber. For example, FIG. 25 depicts an image and illustration of 3D printing system. The 3D printing system may be of any suitable size, depending on the application and size scale of the desired 3D printed part. In some cases, the 3D printing chamber has a volume of greater than or equal to 1 ft³, greater than or equal to 2 ft³, greater than or equal to 5 ft³, greater than or equal to 10 ft³, greater than or equal to 12 ft³, greater than or equal to 15 ft³, and/or less than or equal to 20 ft³, less than or equal to 30 ft³, or more. In some cases, the 3D printing chamber has a volume suitable for table-top/bench-top applications, which may be beneficial in cases in which relatively small parts (e.g., relatively small continuous-fiber-reinforced composite parts) are desired.

In some embodiments, the 3D printing chamber of the 3D printing system includes a print bed and at least two side walls opposite each other. For example, referring again to FIG. 25, 3D printing system includes print bed as well as two side walls (not pictured), according to certain embodiments. The 3D printing system may also include an XYZ gantry, which can couple to the one or more modular heads (e.g., the first printer head described in more detail below), and, when coupled, translate the one or more modular heads (e.g., in the x, y, or z directions, the x and y directions being parallel to the motion platform). For example, FIG. 25 shows a 3D printing system that includes XYZ gantry coupled to a first printer head. The XYZ gantry being coupled to 3D printing system. The printing of parts (e.g., closed-section composite parts) may occur in inside 3D printing chamber.

In some embodiments, the 3D printing chamber includes two or more rotating fixtures. Rotating fixtures are elements that can be induced to undergo rotational motion about a center axis of the rotating fixtures. The two or more rotating fixtures may be disposed on the at least two side walls opposite each other in the 3D printing system. FIG. 25 shows rotating head stock 2515 and rotating tailstock 2525 located on opposite side walls of 3D printing system, according to certain embodiments. The headstock 2515 and the tail stock 2525 may rotate a clockwise or counter clockwise direction. In various embodiments, any suitable positioners and rotatable elements can be used to move and rotate a given workpiece/part being fabricated. The two or more rotating fixtures may be induced to rotate in a synchronized manner (e.g., rotate with essentially the same angular frequency).

In addition, the 3D printing system may include motors 2510 that induce rotational motion of the two or more rotating fixtures (e.g., the headstock 2515 and tailstock 2525 on the side walls of the 3D printing chamber). The rotation of the fixtures may be controlled, in some cases, by a computer system operationally coupled to the 3D printing system. For example, a computer system can send a signal to the one or more rotating fixtures and/or motors that drive rotation of the fixtures. The signal can, in some cases, initiate and/or stop rotation of the one or more rotating fixtures, or modulate the angular frequency of rotation.

Some embodiments include coupling a mandrel 2520 to the one or more rotating fixtures. For example, in some cases, a mandrel can be coupled to a headstock 2515 and tailstock 2525 disposed on the side walls of the 3D printing chamber. As used herein, a mandrel 2520 is an object upon which and/or around which material is printed by an applicator/tool head 2503 fed by a spool 2505 of material such as tape, FFF, or other consumable for part manufacture disclosed herein. FIG. 25 depicts exemplary mandrel 2525 coupled to rotating fixtures 2525 and 2515. When the one or more rotating fixtures rotate, the mandrel may be rotated about an axis that is collinear with the axis of rotation of the one or more rotating fixtures. The mandrel can have any suitable shape, depending on the desired shape of the part being fabricated. For example, the mandrel can be cylindrical, rectangular prismatic, triangular prismatic, or irregular. In some embodiments, the mandrel is made of a single piece, while in certain cases the mandrel is made of multiple pieces (e.g., multiple pieces attached to each other to form a solid shape). The mandrel can be made of any suitable material.

For example, the mandrel can include a polymeric material (e.g., polycarbonate, acrylonitrile butadiene styrene (ABS)), a metal (e.g., steel, titanium, aluminum, copper), and/or a ceramic. In certain cases, the mandrel is or includes a shape memory polymer. A shape memory polymer is a type of smart material that can be altered from a permanent shape to a temporary shape (e.g., via deformation), and can be induced to return to the permanent shape upon the application of an external stimulus, such as a temperature change (or the use of electricity or light). Examples of suitable polymers for use in shape memory polymer materials include, but are not limited to, block copolymers of polyesters, polyurethanes, polyesters, and/or polyethyleneoxides (and/or combinations thereof).

Mandrels that includes shape memory polymers suitable for certain applications can also be obtained commercially from vendors such as SmartTooling, a division of Spintech LLC. It may be desirable in some cases for the mandrel to be made of a material that can be easily removed/extracted from the printed part following the fabrication of the printed part. For example, in some embodiments, the mandrel includes and/or is made of a water-soluble polymer (e.g., polyvinyl alcohol) that can be removed from a printed closed-section part (e.g., a continuous-fiber-based composite part) by the application of water to the part (e.g., via submersion of the part in water).

In certain cases, the mandrel is fabricated via a 3D printing process. Fabricating the mandrel via a 3D printing process may be desirable in cases in which customized shapes for the part to be printed are desired. The mandrel may be 3D printed using the 3D printing system described herein (e.g., using one of the one or more modular heads, such as an FFF printing head, in the 3D printing chamber). In some embodiments, however, the mandrel can be 3D printed using a different 3D printing system (e.g., in a 3D printing chamber that is different than the 3D printing system described herein). In certain cases, the mandrel is manually coupled to the one or more rotating fixtures in the 3D printing chamber described herein following fabrication and/or acquisition of the mandrel.

As mentioned above, one or more modular printer heads may be used to continuously extrude material on to the mandrel as it rotates in the 3D printing chamber (e.g., via rotation of the one or more rotating fixtures). In some cases, the one or more modular heads (e.g., the first printer head described below) can translate (e.g., in the x and/or y directions) as it lays out material on to the rotating mandrel. In such a way, material (e.g., fiber-reinforced thermoplastic tape) can be applied to the mandrel in a manner akin to filament winding. Such a process can lead to the convenient formation of closed-section 3D-printed parts. Closed-section parts have cross-sections that form a shape having no beginning or end (e.g., pipes), as opposed to parts having open sections or sides, such a “C-shaped” channels, which are not closed-section parts.

In some embodiments, a system for manufacturing composite structures via a layer-by-layer technique, which can be used in conjunction with the 3D printing system that includes rotating fixtures and/or mandrels provided above, is generally described.

In some embodiments, the system includes a first printer head. The first printer head can be used as one of the one or more modular heads of the 3D printing system described above. FIG. 3C depicts an exemplary cross-sectional schematic representation of a printer head, in accordance with certain embodiments. The components of FIG. 3C can be included in a given print head applicator 300 such as the print head shown in FIG. 25. In some embodiments, the printer head is configured to lay down tape on to a surface (e.g., a mold structure such as a mandrel laid down by the second printer head, as described below). In some embodiments, the printer head provides a pathway within the housing of the printer head through which the tape can be driven. FIG. 9 shows, in accordance with certain embodiments, tape (e.g., “pre-preg tape”) following a pathway within the housing of a print head applicator.

In some embodiments, the first printer head includes one or more feed rollers attached to the head and configured to drive tape through the head. FIG. 3C shows exemplary feed rollers 365. In some embodiments, the gap between the feed rollers is adjustable to accommodate different thicknesses in material systems (e.g., different thicknesses of tapes). In some embodiments, the first printer head includes a heat sink. In some embodiments, the tape passes through and comes into contact with the heat sink as the tape is fed through the first printer head. In some embodiments, the first printer head 300 further includes a blade 366 and an article configured to drive the blade, such as a servo 360. In some embodiments, the blade 366 is an angled blade. Examples of articles configured to drive the blade include, but are not limited to, servos (as pictured in FIG. 3C) and solenoids. The article configured to drive the blade 366 (e.g., the servo), upon actuation, may cause the blade 366 to move in such a way that it cuts the tape as the tape is fed through the first printer head 300. In some embodiments, the blade enters into and out of the heat sink as it cuts the tape.

In some embodiments, the heat sink is modular (e.g., so as to accommodate different thicknesses of tapes and/or blades. FIG. 3C shows the blade (“tape cutting blade”), servo (“tape cutting servo”), in accordance with certain embodiments. As shown in FIG. 3C, the first printer head 300 includes a non-contact heating element 340 which uses a focusing lens 345 and/or reflectors 350 to heat up the prepreg tape 305. The first printer head 300 utilizes a compaction roller 355 to apply pressure to the heated prepreg tape 305 to apply it to a surface and/or print bed during fabrication. In this embodiment, the first printer head includes a remote heat/temperature sensor 310 which uses a mirror 315 to determine and manage the temperature applied by the non-contact heating element 340.

In some, but not necessarily all embodiments, the system includes a second printer head. In some embodiments, the second printer head is configured to deposit material (e.g., by extruding plastic filaments). In some embodiments, the material deposited by the second printer head includes polycarbonate, acrylonitrile butadiene styrene (ABS), or any other suitable material. For example, in some embodiments, the second printer head is a Fused Filament Fabrication extrusion head. The second printer head may, in certain embodiments, print out a mold prior to the first printer head laying down the tape (e.g., the second printer head prints a mold designed to have the form of the desired composite structure, and then the first printer head lays down layers of tape on to the mold, with the mold acting as a support). In some cases, the mold is used as the mandrel described above. In some embodiments, the first printer head and/or the second printer head are capable of interfacing with any XYZ gantry motion platform (e.g., any three-dimensional translation stage), such as the gantry of the 3D printing system described above. The use of such platforms may assist in the automated nature of the system and methods described herein.

In some embodiments, after the tape is fed through the first printer head (e.g., via the feed rollers) and cut (e.g., via the blade), the tape is heated by a heating element. Any element capable of heating the tape to a temperature above the melting temperature of the thermoplastic of the tape may be suitable. For example, in some embodiments, the heating element is a heat block. In some embodiments, the heat block (e.g., a copper heat block) is heated by a thermistor, while a thermocouple monitors and controls the temperature of the heat block via a feedback loop.

In some embodiments, the heating element heats the tape by coming into contact with tape as the tape is fed through the first printer head. In some embodiments, however, the heating element heats the tape without contacting the tape. For example, in some embodiments, the heating element is an infrared lamp capable of radiating heat in the form of electromagnetic radiation toward the tape. In some embodiments, the heating element is capable of heating both the tape being fed through the first printer head (e.g., “incoming tape”) and the previously laid down layer of tape on the mold/support (e.g., a mandrel). Heating the tape being fed through the head (i.e., the tape being laid down) as well as the previous layer of tape can be beneficial in consolidating the two layers of tape (e.g., via thermal bonding of the two layers). FIG. 1 depicts a heating element, in accordance with certain embodiments.

In some embodiments, the first printer head 300 includes a compaction roller 355. In some embodiments, the first printer head includes at least two compaction rollers. FIG. 3C shows an exemplary compaction roller, in accordance with certain embodiments. The compaction roller(s) may be positioned in close proximity to the part of the first printer head that extrudes the tape and lays it down on to the mold/support. The compaction roller may, in some embodiments, provide downward pressure (e.g., in the direction toward the mold) so as to flatten the material and provide necessary compaction pressure for consolidation. The direction of compaction force is illustrated in FIG. 2A, which shows the laying down of tape by the first printer head on to a support previously printed by the second printer head, in accordance with certain embodiments. FIG. 2 also illustrates a schematic of the various components of the first printer head described herein.

As can be seen in FIG. 2, the first printer head travels in a direction relative to the position of the support as it lays down the tape. The relative direction of travel of the first printer head may be due to translation of the first printer head while the support is stationary, or due, at least in part, to motion of the support (e.g., rotation of a mandrel support). The first printer head may be rotatable, in some embodiments. Having a rotatable printer head may allow tape to be laid down in multiple directions, resulting in a composite structure with multiple fiber orientations. In some embodiments, the first printer head can rotate 180 degrees. In some embodiments, the first printer head can rotate up to 360 degrees.

### Exemplary Specialized Printing and Fabrication Systems and Combination Systems

In various embodiments, a 3D printing system includes tool heads configured to print, at least partially, parts or sections, regions or components of parts that include metal. In one embodiment, a part or work piece may be fabricated using a metal print head/applicator that integrated as a swappable tool with one or more of the systems disclosed herein. In various embodiments, a 3D printing system includes one or more of the following: a selective laser melting (SLM) head or related subsystem, a direct metal laser sintering (DMLS) head or related subsystem, an electron beam melting (EBM) head or related subsystem, an ultrasonic additive manufacturing (UAM) head or related subsystem, Bound Metal Deposition™ head or related subsystem, Direct Light Processing (DLP) head or related subsystem, stereolithography head or related subsystem, a laser-based metal heating head or subsystem, a furnace subsystem, diffusion-based additive metal manufacture head or related subsystem, a continuous filament fabrication head or subsystem, a sintering-based head or subsystem, a melting-based head or subsystem, a binder jetting head or related subsystem, and a single pass jetting fabrication (SPJF) head or related subsystem. The system can include different stages or housed components such as a furnace or other processing system. In one embodiment, an anisotropic filament such as a chopped fiber-based filament, a doped filament, a glass ball/glass component-based filament, and other anisotropic filaments are used with a FFF-based head. In one embodiment, deformation resistant or hardened unitary layers of FFF-based anisotropic material are fabricated using an applicator such as a nozzle.

In some embodiments, each of the aforementioned heads or subsystems is capable of working with various types of metal. For example, in some embodiments, metal three-dimensional printers use consumables that include, but are not limited to: aluminum alloys, stainless steel, tool steel, titanium alloys, cobalt-chrome super alloys, nickel super alloys, precious metals, and other combination. These and other metals can be in powder, pellet, rod, and other shapes, densities, and configurations for a given metal printing modality. In various embodiments, three-dimensional objects fabricated with metal have higher strength and hardness, and are often more flexible than traditionally manufactured parts. Various ceramic fillers, releasable elements, and other materials suitable for support metal during fabrication can be used.

In various embodiments, a SLM, DMLS, or an EBM printing head is capable of building metal parts and/or metal layers using metal powder. First, in some embodiments, the metal printing head deposits a metal powder over a build area. Second, in various embodiments, the metal powder heated is heated, which fuses a top layer of metal powder to lower layers of metal. When the heat dissipates, the process continues. In some embodiments, each layer is heated using one or more lasers. In other embodiments, each layer is heated using an electron beam. In some embodiments, each layer is heated using a directed energy device.

In some embodiments, a 3D printing system uses a UAM head to build metal parts and/or one or more portions of a metal part using metal strips. In various embodiments, the UAM head places metal strips on the build area. In these embodiments, the UAM head then applies an ultrasonic welder to attach the top layer of metal to previously placed metal strips.

In certain embodiments, a 3D printing system uses a single pass jetting fabrication head for printing metal three-dimensional objects. In some embodiments, the SPJF head uses multiple powder spreaders to deposit a metal powder along a build area followed by a compacting system to create a thin layer of metal powder. In various embodiments, the SPJF head uses one or more jets dispose droplets of a binding agent to bind each layer of the metal three-dimensional objects together. In some embodiments, the SPJF head uses anti-sintering agents to strategically allow certain layers to fall away after fabrication is complete. In these embodiments, the anti-sintering agents allow certain layers to be washed away after fabrication is complete.

In some embodiments, upon drying of each layer, the process repeats until an object or set of objects is fabricated to constitute a finished part or otherwise transferred to another stage or combination system for further processing, such as heating in a furnace or other specialized processes. In various embodiments, when each three-dimensional object is completely formed, the build area is de-powdered and each of the parts is placed into a sintering tray. In some embodiments, the sintering tray is placed into a furnace, where each of the parts is heated to just below the melting point completing the process. In contrast to previous methods where processing each layer of powdered metal requires a cycle of heating and cooling, heat is used to finalize a three-dimensional object. In various embodiments, upon application of heat, each layer is simultaneously fused together while removing the binding agents thereby creating a fully formed three-dimensional metal object.

In some embodiments, a 3D printing system is capable of post processing a fully formed metal product. In various embodiments, a 3D printing system includes one or more tool heads to remove loose metal powder, remove support structures needed during fabrication, provide directed CNC capability, as well as media blasting, polishing, and micro-machining. In some embodiments, one or more tool heads available within a 3D printing system can facilitate metal plating and heat treatment of fabricated metal objects.

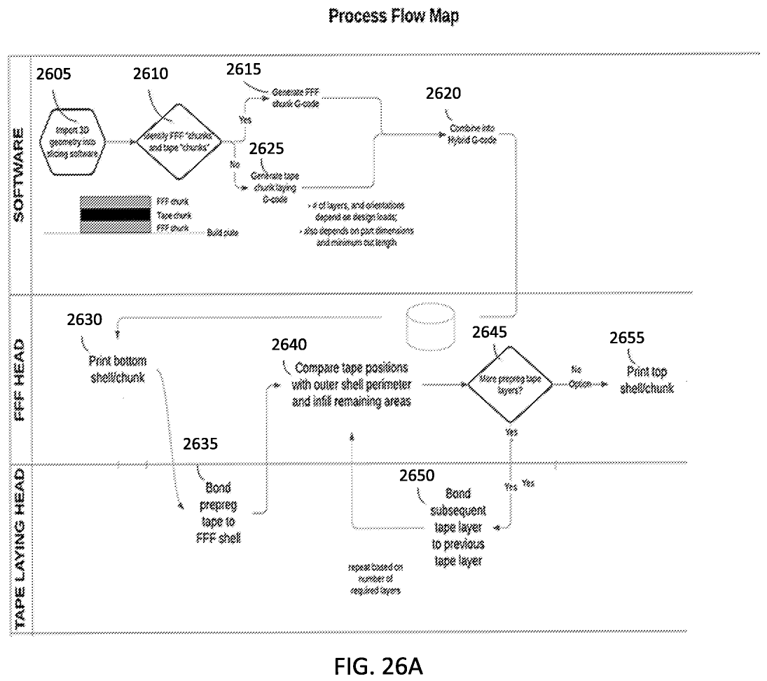

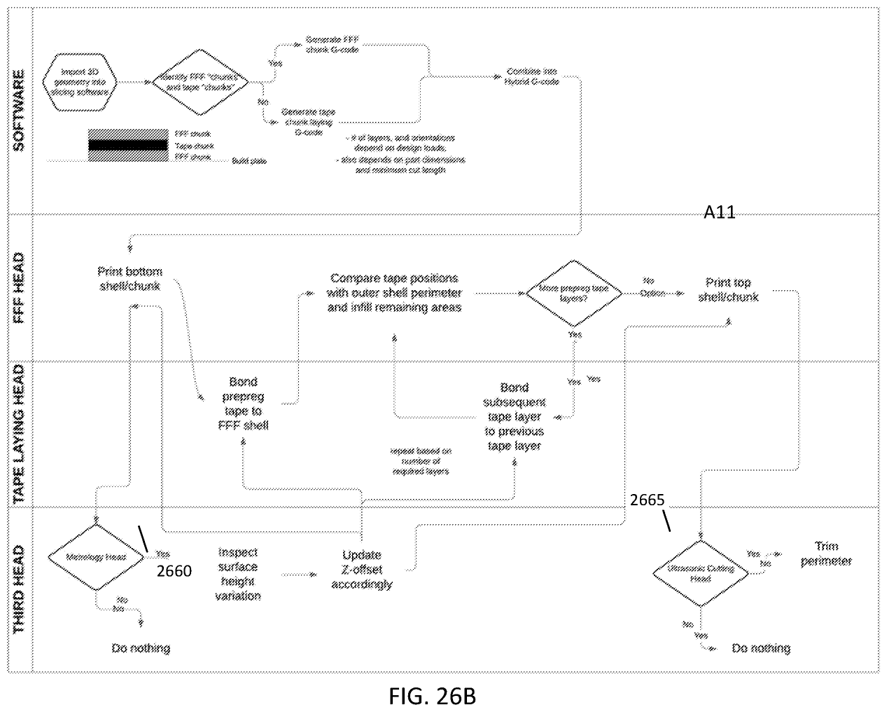

FIG. 26A is an exemplary flow chart for the operation of the system suitable for making composite parts using prepreg tape and/or parts that include a tape-based composite core with a polymer coating in accordance with an embodiment of the present disclosure. Given that FFF-based methods print a part in terms of slices, while a tape-based automated fiber placement system typically does not, additional processing steps are undertaken to operate a system that combines the features of both part generating modalities.

To manufacture an item, the system builds instructions (i.e., G-code) to direct the FFF head and the tape laying head to manufacture the item one layer at a time. Initially, the system imports a three-dimensional drawing of the item showing/describing the geometry of the item (Step 2605). The system utilizes slicing software to determine the structure of the item and divide it into multiple 2D slices that represent each layer the printer needs to build up. The user can define regions, or chunks, of the part corresponding to layers of tape and/or layers of FFF required to construct the item (Step 2610).

Data relating to strength of part of how to reinforce core can be used to design shape of unitary core. If a chunk is an FFF chunk, the system generates an FFF chunk of G-code (Step 2615) and incorporates that G-code into the combined instructions (Step 2620). If a chunk is a tape chunk, the system generates a tape chunk laying G-code (Step 2625) and incorporates the G-code into the combined instructions (Step 2620). Although reference is made to G-code any suitable programming or control language used to process slices or otherwise control a 3D printing device can be used in various embodiments.

Upon completion of the combined instructions, the system starts directing the FFF head and the Tape Laying head to create the item in accordance with the combined instructions. The system directs the FFF head to print a bottom shell/chunk (Step 2630) which is followed by the tape laying head bonding prepreg tape to the FFF shell (Step 2635). The bottom shell is first support layer in one embodiment. Upon completion of each round of tape laying, the system compares the tape positions with the perimeter of the outer shell (Step 2640) to determine whether to use more FFF to infill areas of the partially built item (Step 2645). In part, the disclosure relates to tracking or otherwise evaluating composite tape segments and comparing their positions with the outer part perimeter. By performing this analysis and comparison, the systems and methods disclosed herein can be used to fill-in areas, such as jagged or step regions in layer, not covered by tape segments to create a uniform layer thickness for the part. These stacks of polymer materials that are placed to interface with or link with the cut and consolidated tape segments, such as exemplary layer 1945, allows the part to have uniform layers built up over time of two or more different materials. This approach also reduces or prevents unwanted voids forming at the junctions of dissimilar materials such as an FFF polymer and a prepreg composite tape with reinforcing fibers disposed in a matrix of thermoplastic or thermoset polymer.

Upon determining the appropriate FFF in-fill of regions not covered by tape, the system directs the tape laying head to bond subsequent tape layers to previous tape layers (Step 2650) until the tape deposition process completes the unitary composite-based core of the part. Upon determining that no more tape is needed, the system prints a top shell/chunk (Step 2655) at least partially enclosing the tape layer. In some, embodiments, the system continues repeating steps 2630, 2635, 2640, 2645, 2650, and 2655 until the item is complete. In one embodiment, a second support or top layer is printed using filaments and the various FFF layers are linked at one or more edges or vertex to form an overall or partial shell with the unitary core disposed therein. In one embodiment,

FIG. 26B shows the steps of FIG. 26A with additional steps and operations for additional modular print heads such as a metrology head for inspecting a part as it is fabricated (2660). In addition, the system and software can control a cutting head (e.g. ultrasonic) that is used to trim material if needed (2665) as part of a subtractive process. Various other steps and stages can be used for the various swappable heads disclosed herein.

### Rotatable Print and Material Deposition Heads

Systems and methods relating to the use of rotating fixtures during 3D printing processes are generally described. In one aspect, a 3D printing system is provided. The 3D printing system may include one or more modular heads (e.g., for extruding filament or for laying down fiber-reinforced polymer tape), a motion platform, and/or one or more rotating fixtures. The 3D-printing system may be used in any number of 3D-printing applications, including, but not limited to, fused filament fabrication (FFF) and/or laying pre-impregnated tape including continuous fibers and a thermoplastic polymeric matrix to form composites.

In some embodiments, the system includes a first applicator. The first applicator can be used as one of the one or more modular heads of the 3D printing system described above. The first printer and other applicators may include one or more rotatable elements or axis of rotation.

The relative direction of travel of the first applicator may be due to translation of the first applicator while the support is stationary, or due, at least in part, to motion of the support. The first applicator may be rotatable, in some embodiments. Having a rotatable applicator may allow tape to be laid down in multiple directions, resulting in a composite structure with multiple fiber orientations. In some embodiments, the first applicator can rotate 180 degrees. In some embodiments, the first applicator can rotate up to 360 degrees.

In some embodiments, the first printer head and/or the second printer head include a subtractive manufacturing element. The subtractive manufacturing element is used, in some embodiments, to trim edges and cut features (e.g., according to the part design) in the structure formed by the laid-down tape. In some embodiments, the subtractive manufacturing element performs a subtractive manufacturing process between the laying down of each tape layer. An example of a head including a subtractive manufacturing element is one that includes an ultrasonic trimmer.

In some embodiments, the tape has a certain width. In some embodiments, the width is greater than or equal to 1 mm, greater than or equal to 1.5 mm, greater than or equal to 2.0 mm, greater than or equal to 2.5 mm, or greater than or equal to 3.0 mm. In some embodiments, the width of the pre-impregnated tape is less than or equal to 20.0 mm, less than or equal to 15.0 mm, less than or equal to 10.0 mm, less than or equal to 8.0, less than or equal to 6.0 mm, less than or equal to 5.0 mm, or less. Combinations of the above ranges are possible, for example, in some embodiments, the width of the tape is greater than or equal to 1 mm and less than or equal to 20.0 mm. The tape may be wound on to a spool or cassette prior to being introduced to the first roller.

### Integrated Spool and Tape Head

In particular, the disclosure relates to solutions for various technical problems relating to synchronizing transport of consumables and mitigating twisting of consumables such as prepreg tape and fused filament fabrication (FFF) based materials when used in a composite part manufacturing system. Specifically, systems and methods of co-locating, aligning, co-rotating, synchronizing that transport or receive material such as lengths of tapes or tows stored on a spool or similar apparatus are disclosed herein. In various embodiments, the tapes or tows include a matrix or carrier material such as a thermoplastic or thermoset material.

In addition, FFF-based components that are stored on a spool or similar apparatus can also be used with the systems and methods describes herein. In general, systems described herein that use polymer based materials such as FFF-based materials and prepreg tape, either with continuous or chopped reinforcing fibers, are described herein as systems or 3D printing systems. In various embodiments, a spool is referenced. A spool can include or otherwise be used with a bobbin, reel, roll, or other apparatus for storing a flexible material suitable for fabricating a 3D part/workpiece. In one embodiment, the flexible material coils or wraps around an elongate member, shaft, post or other element to facilitate winding and unwinding the material

The ability to use FFF-based materials and prepreg tape with continuous fibers in a 3D printing embodiment allows such devices to execute complex operations. In addition, for a given system embodiment one or more applicators or print heads may trace various paths through space to additively build a part with the same or different materials being transported to different applications. Further, such applicators and the paths they trace can be constrained by a housing that results in a reduction of their overall size and requires applicators to be able to rotate and turn within a small volume and to do so repeatedly. In various embodiments, the applicator is an applicator/tool head such as a tape applicator/print head, an FFF-based applicator, or other applicators or applicators/tool heads.

Managing the transport of tape and filament in a housing with the one or more heads used to place such materials results in numerous design challenges. As a further challenge to design composite tape-based desktop systems, given that applicators rotate during some additive fabrication processes, this may cause tape-based materials to twist and deform and for filaments to undergo undesirable strain and fatigue states.

In one embodiment, the system includes one or more rotating filament-based heads such as an FFF-based head. This is contrary to a typical common FFF print head that translates in the X, Y, or Z direction to print an object. As a result, the disclosure addresses a technical problem of filament being twisted as a result of using it with a rotating head. Given the use of a rotating head, keeping the spool and head in sync during the fabrication process mitigates twisting and other kinking or bending of tape, filament, and other flexible printable/depositable materials

In addition, placing a polymer-based FFF filament segment or a tape segment with a twist or that has been strained can result in defects being formed in the part as it is being created through an additive process. In turn, these defects, caused by twists and jams, can result in delays during fabrication, creation of unusable parts, lost time used for manual intervention to fix the systems, and other related problems.

In general, various implementations, systems and methods are disclosed herein to solve these problems and others challenges associated herein. Various systems and methods disclosed herein can be implemented to solve the foregoing problems and otherwise provide various advantages when fabricating parts. In part, synchronizing the rotation of an applicator and the spool or other device used to supply prepreg tape, filament, or other materials used during the manufacture of the part helps mitigate such problems. Any suitable tape can be used such as non-continuous fiber reinforced tape, polymer-based tape, tape with chopped fiber, tape with other additives, and metal containing tape. In one embodiment, the filament is anisotropic and the thermoplastic tape or other tape disclosed herein is anisotropic. In one embodiment, the filament is used to form one or more supports, substrates, or covers that resist deformation as a result of the hardness and/or other material properties of one or more regions, structures, or unitary structures formed by a filament-based applicator, such as a nozzle-based or other filament-based deposition, heating, or solidifying device.

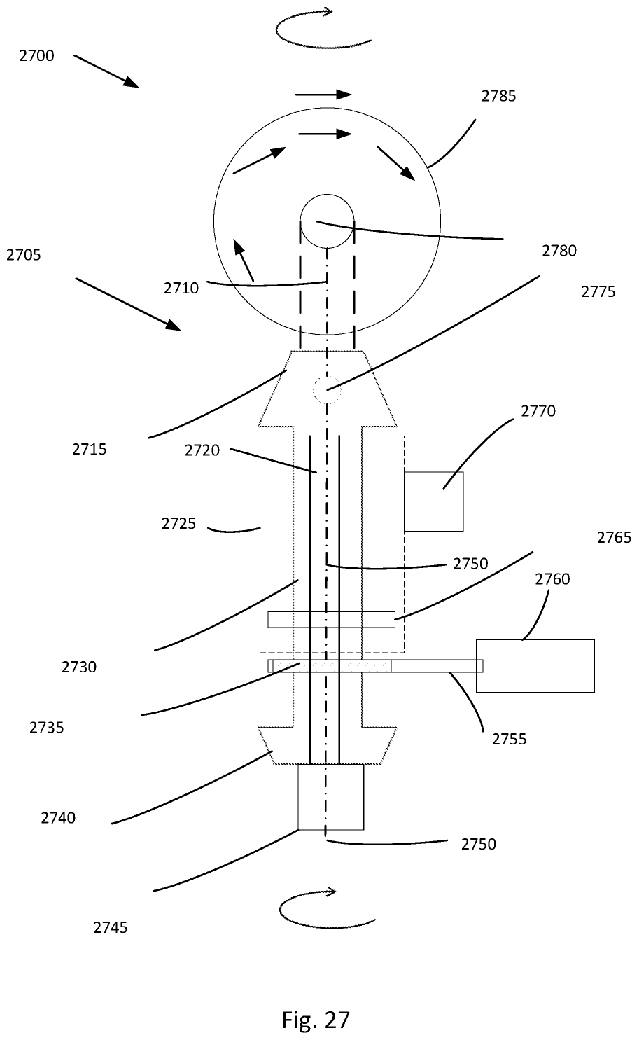

An example of subsystem that addresses aspects of the problems recited herein is shown in the schematic diagram of FIG. 27. FIG. 27 shows a partial cross-sectional view of a subsystem 2700 that includes applicator 2745 and a spool 2785 that are arranged and linked to rotate together while also defining a consumable material transport path that reduces or prevents twisting. A given applicator can include an applicator/tool head, print head, 2745 or other apparatus used to additively form, correct, or assess a part undergoing an additive manufacture. The spool 2785 can store and rotate to allow the transport of prepreg tape, other tapes, FFF-based materials, and materials suitable for impregnation with chopped fiber or other materials. The system can include various guides, channels, bores, rollers and other elements to guide and direct material such as tape or filament relative to a spool and applicator combination systems that rotates relative to a longitudinal axis.

FIG. 27 shows a spool assembly, which is a subsystem of a system for additive manufacture of parts. The spool assembly 2705 includes an applicator 2745 such as a tape head and a spool 2785 to distribute tape 2710, 2750 to the applicator 2745. The applicator 2745 can print or otherwise deposit a material and typically include a heat source and other elements to transform a tape or filament. In various embodiments, the spool 2785 and the applicator/tool head 2745 are attached to an elongated member 2730. The elongated member 2730 includes a mount on each end 2715, 2740 for the spool 2785 and the applicator/tool head 2745, respectively. The elongated member 2730 is rotatable when moveably coupled to a slip ring 2725. The slip ring 2725 can be a tube or a cylindrical bearing that has one or more inner bores or channels. In one embodiment, a clock spring or other apparatus that supports rotation of spool, applicator, and an elongate member that attaches to each of foregoing can be used in lieu of a slip ring.

Using the slip ring 2725, the tape head tool 2745, the spool 2785, and the elongated member 2730 rotate together, relative to a first rotational axis. A slip ring \ electric coupler 2725 is used within the elongated member 2730 to electrically connect the system with the rotatable portions of the spool assembly 2705. In various embodiments, an electrical subsystem that connects applicator 2745 to a power source and/or a control system 2765 (and other signal sources and signal receivers) is a part of the slip ring 2725. In some embodiments, the slip ring/electric coupler 2725 can be placed along the elongated member 2730. The slip ring 2725 can be oriented at different positions along the length of the member that connects the spool 2785 and the applicator 2745.

The mount for the spool 2715 includes a shaft/spindle 2780 for receiving the spool 2785. When dispensing tape to the tape applicator/tool head 2745, the spool 2785 rotates around the shaft/spindle 2780 relative to a second rotational axis that is disposed at an angle relative to the first rotational axis. In one embodiment, the first rotational axis and the second rotational axis are substantially perpendicular.

As shown in FIG. 27, in one embodiment, the spool 2785 and applicator/head/tool 2745 are mounted to different ends of an elongate member 2730. The elongate member 2730 can be a tube or other structure that defines a bore through which polymer-based tape can travel from the spool to the applicator. A cylindrical or other elongate bearing 2725 can be disposed around the elongate member 2730 such that the elongate member 2730 and the applicator 2745 and spool 2785 can rotate relative to the bearing 2725. An electrical subsystem and one or more electrical connections 2765 can be disposed in the bore 2720 of the elongate member and connect to a clock spring, slip ring 2725, or other subsystem to provide electrical connections through brushes, coils, induction or other mechanisms as the applicator and spool rotates. Further, as shown in FIG. 27, spool 2785 connects or is coupled to a mount 2715. The mount 2715 connects or is coupled to elongate member 2730 that defines an inner bore 2720. Elongate member 2730 is coupled or connected to a mount 2740. In turn, mount 2740 couples to or is connected to applicator/head/ tool 2745. With respect to the foregoing, elements 2785, 2715, 2730, 2740, and 2745 rotate together relative to the slip ring/cylindrical bearing 2725 and the electrical subsystem 2765 that transmits power, control and other signals to and from the applicator and other components in various embodiments.

In this embodiment, a motor 2760 and belt/drive linkage 2755 is mechanically connected to the elongated member 2730 of the spool assembly 2705. The elongated member 2730 of the spool assembly 2705 includes a portion having teeth/drive 2735 elements configured to receive the belt/drive linkage 2755. In some embodiments, when active, the motor 2760 drives the belt/drive linkage 2755 in a clockwise or counter clockwise direction to direct the elongated member 2730 to rotate, which in turn causes the spool 2785 and applicator/tool head 2745 to rotate. In some embodiments, the slip ring 2725 is attached to a mounting bracket 2770 that provides a mechanical and electrical connection to the spool assembly. In various embodiments, the mounting bracket 2770 is a kinematic coupler configured and constructed to connect with a tool grabbing actuator.

In one embodiment, the spool 2785 of prepreg tape 2710, 2750 dispenses the prepreg tape 2710, 2750 through the center of the elongated member 2730 guided by a plurality of tape transport rollers 2775. Upon reaching the opposite end of the elongated member, an applicator/ head/applicator/tool head 2745 is configured to receive and utilize the aligned prepreg tape 2710, 2750. In various embodiments, rollers can be positioned to route the tape into guides. In turn, the guides prevent the tape from “swimming” side to side or buckling in an out of plane, off the rollers, or otherwise translating or shifting in an unwanted direction. In one embodiment, the guides are plates that include one or more grooved channels to hold the tape flat and in its proper orientation as it is transported through the applicator or through other parts of the system.

In many embodiments, spooled material that does not twist on its way to disposition on a print bed and has a shorter distance from spool to disposition that provides benefits such as reduced twisting and unwanted slack. Reducing tape twisting during disposition and a shorter distance over which to travel mitigates unwanted effects relating to material elasticity such as stretching during extrusions. Non-twisting disposition causes less stress on the spooled material enabling easier tension control with fewer tension components necessary, such as pulleys or tensioning devices seen in larger automatic fiber placement (AFP) systems. A shorter distance to disposition reduces the need for a complex web guidance and reduces the amount of contact area that the prepreg tape will abrade. A shorter distance to disposition will also reduce difficulties in feeding new tape into the system and minimizing intermediate tape between disposition and the spool. Also, a longer distance from the spool to disposition would require a more substantial extrusion motor thus increasing the mass and/or size of the tape head.

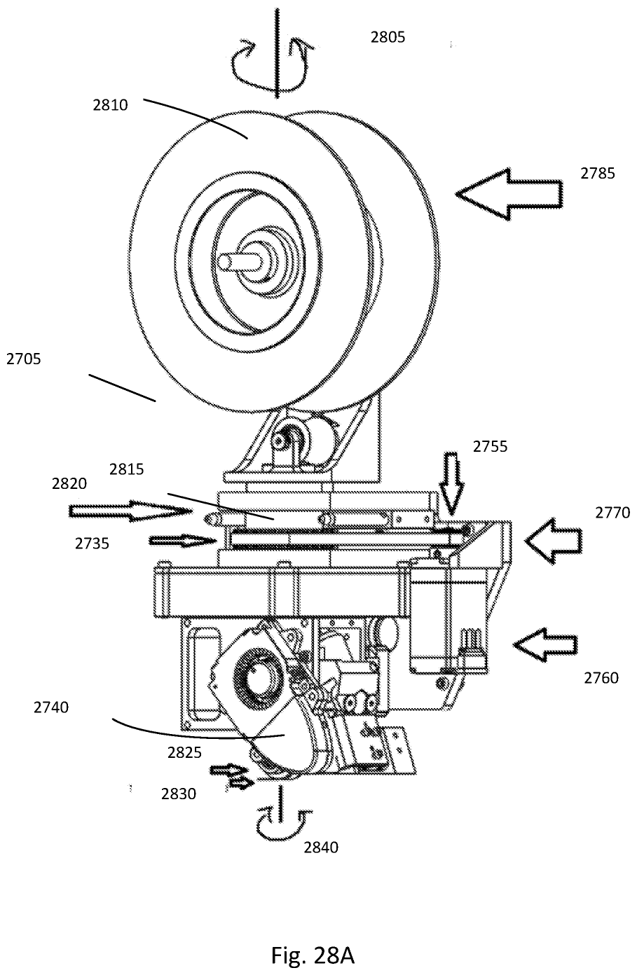

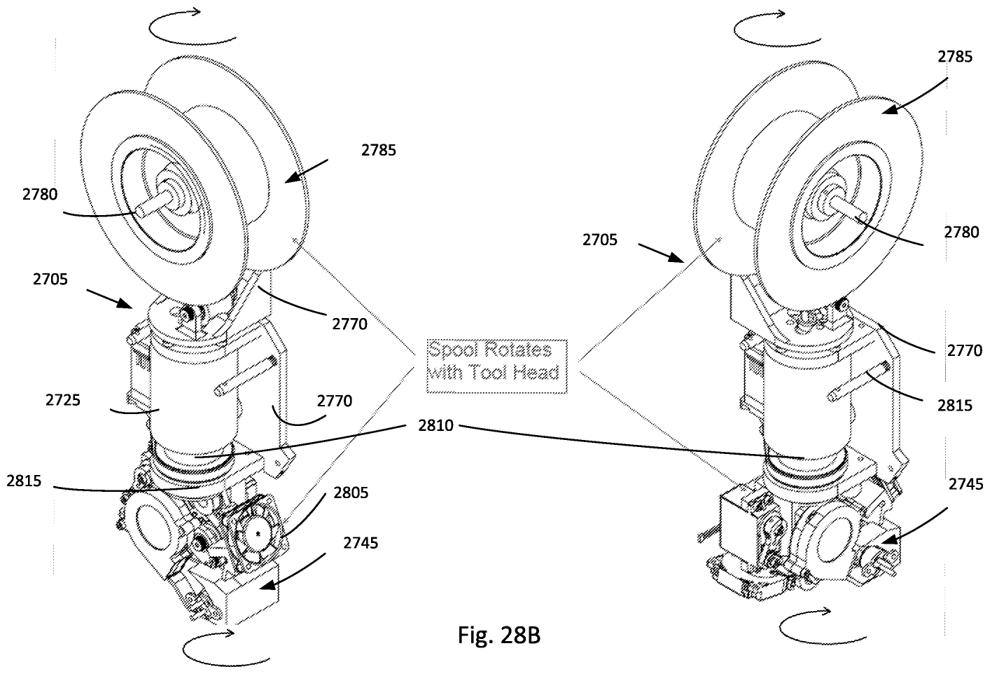

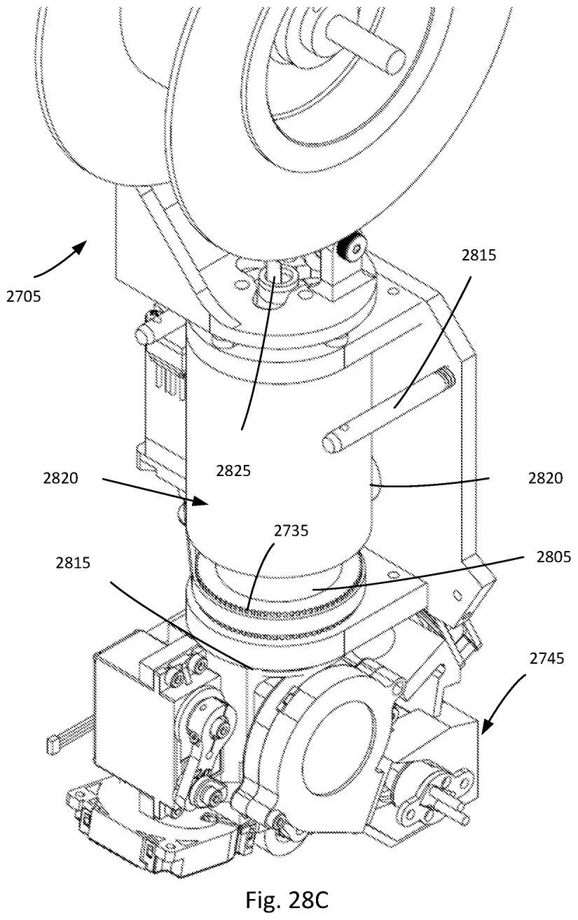

FIG. 28A shows an exemplary embodiment of a spool assembly in an alternate configuration from FIG. 27. In this embodiment, the spool assembly 2705 includes the spool 2810 and applicator/tool head 2745 mounted to an elongated member (not shown). The elongated member is disposed within a slip ring 2815. In one embodiment, the slip ring 2815 is mounted to a kinematic coupler/bracket 2770 and includes docking pins 2820. The docking pins 2820 are configured to be received by a docking bracket for placement of the spool assembly while the tape applicator/tool head 2745 is not in use and to move the applicator with a positioner when in use. A portion of the slip ring 2815 includes gear teeth 2735 configured to receive another gear or a drive belt with teeth mated to the gear teeth on the slip ring 2815. The applicator 2745 and spool assembly 2705 are releasably connectable to a positioner such as gantry system to move the assembly through different positions in the X, Y, and Z direction as part of an additive printing process.

In one embodiment, proximate to the slip ring is a motor 2760 mounted to the slip ring 2815. In this embodiment, the motor includes a gear that can rotate in a clock wise and counter clock wise direction. A drive belt 2755 wraps around or otherwise engages the gear teeth 2735 of the elongate member and the gear of the motor to link the elongate member to the motor and allow the motor to rotate the belt and thereby rotate the elongate member and thereby rotate the spool and applicator assembly around a shared axis of rotation. By activating the motor 2760, the elongate element can be directed to turn in a clockwise or counter clockwise motion, which also rotates the spool 2810 and the applicator 2745. The applicator/tool head includes a nip roller 2825 to apply tape 2830 being processed. During rotation of the spool assembly 2705, the spool assembly 2705 rotates around the axis indicated by arrows 2805 and 2840.

FIG. 28B shows two perspectives of an exemplary embodiment of a spool assembly. Similar to FIG. 28A, the spool assembly 2705 includes a spool 2780 and a applicator/tool head 2745 mounted to an elongated member (not shown) mounted within or relative to an slip ring 2815, clock spring, or other assembly that supports rotation of spool and applicator in synchronized manner while facilitating electrical connections and signal transmission to and from the applicator during rotation of the applicator and spool.

In this embodiment, the applicator/tool head 2745 on the left has been rotated 90 degrees from the position shown on the right. In various embodiments, the slip ring 2815 or clock spring can include one or more bearings and electrical subsystems to maintain power and signal transmission to the applicator. As shown, the spool 2785 and applicator/tool head 2745 stay aligned, whereas the motor, bracket 2770, and slip ring 2815 do not move. The slip ring 2815 can include a cylindrical bearing. The use of a bearing supports and maintains alignment of spool assembly 2705 and applicator 2745 on either end of the slip ring 2815. The slip ring 2815 can include brushes, coils, inductors, and other elements to provide electrical coupling during spool 2785 and applicator 2745 rotation.

FIG. 28C shows a magnified perspective of an exemplary embodiment of a spool assembly. In this embodiment, the prepreg tape is shown being routed down towards the applicator /tool head 2745 using a tape guide 2825. The prepreg tape is distributed through the center of the elongated member 2805 and the slip ring 2815 and received by the applicator/tool head 2745 to be applied to create a three-dimensional object.

FIG. 12 is a schematic diagram of a slip ring, utilized by the spool assembly to allow the applicator/tool head and spool to rotate independently relative to slip ring and structures attached or supporting the slip ring. The spool assembly includes the spool 1220, elongated member 1205, and the tape applicator 1235. The slip ring 1200 includes an inner 1210 and outer 1215 cylinder, wherein the inner cylinder 1210 is electrically connected to one or more portions of the spool assembly. In various embodiments, the inner cylinder 1210 is electrically connected to electrical control and power wires for the rotating applicator/tool head 1235, where the wires go through a bore or channel defined by the elongated member 1205. In one embodiment, the bore or channel is central disposed in the elongated member.

In one embodiment, the outer cylinder 1215 is electrically connected to control and power wires 1225 originating from outside the spool assembly. In some embodiments, the electrical control and power systems of a 3D printing systems 1231 provide power and direction to the spool assembly using the slip ring. Between the inner and outer cylinders are electrical couplers capable of maintaining an electric connection while the inner cylinder is moving. In some embodiments, the electrical couplers include stationary metal contacts (i.e., brushes) which rub on the outside diameter of a rotating inner cylinder. As the inner cylinder turns, the electric current or signal is conducted through the stationary brush to the outer cylinder to make the connection. In various embodiments, brush assemblies are stacked along the rotating axis to provide for multiple electrical circuits as needed. The slip ring 1200 can be used to transmit power, control signals, data, and other information to control the applicator and other components in electrical communication therewith. Various configurations of slip rings can be used to facilitate power/ signal deliver to an applicator that rotates in conjunction with a material storage spool.

### 3D Printing System

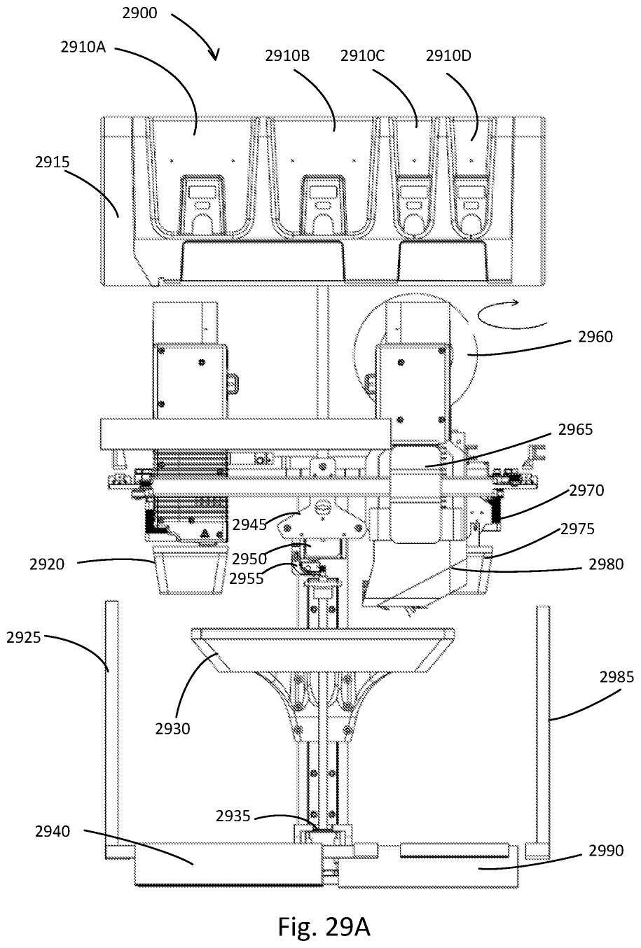

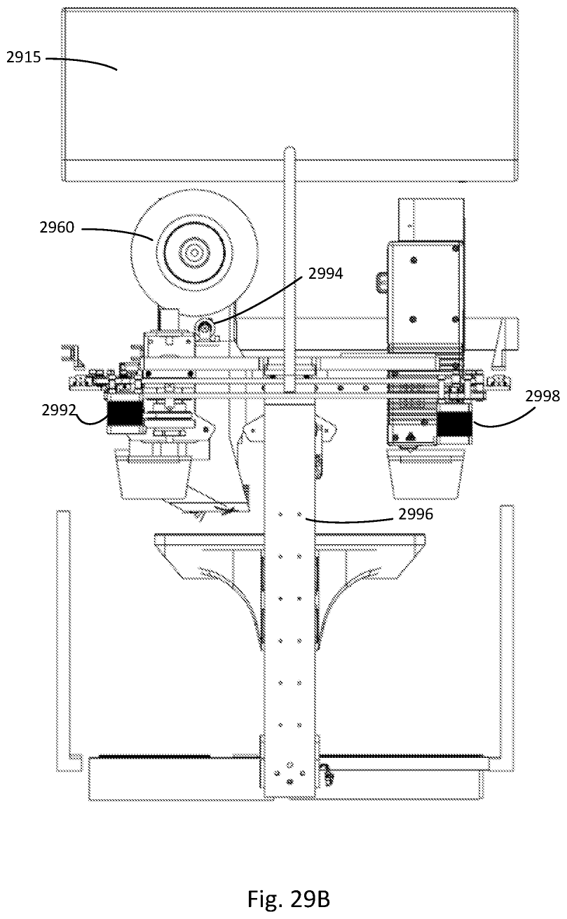

Refer to FIG. 29A, which is a simplified illustration of a 3D printing system, in accordance with an embodiment of the current disclosure. The 3D printing system 2900 fabricates three-dimensional objects on a build plate 2930 using one or more applicators/tool heads. The 3D printing system 2900 includes a tool grabber actuator assembly (Tool Grabber) 2965 for manipulating multiple applicators/tool heads available within the 3D printing system 2900. In this embodiment, applicators/tool heads available within the 3D printing system 2900 include an applicator such as a prepreg tape head 2980, a Fused filament fabrication (FFF) head 2950, and cutter head 2970. The applicator/spool assembly can dock with the tool grabber via the bracket attached to the slip ring shown in FIG. 28C.

As shown, the FFF head 2950 and the ultrasonic cutter head 2970 are both held in a holding bracket, while the tool grabber 2965 is utilizing the prepreg tape head 2980 to place prepreg tape on the build plate 2930. When each applicator/tool head is not in use, each applicator /tool head is placed in its respective holding bracket, which is mounted to the frame of the 3D printing system 2900. While stowed in a holding bracket, each of the applicators/tool heads is placed proximate to a purge and waste container 2920, 2980. After a given operation or part fabrication session or cycle, each respective purge and waste container 2920, 2980 can be used to discard any residual material remaining on each respective applicator/tool head.

The tool grabber 2965 interacts with each of the applicators/tool heads using a kinematic coupler; for example, kinetic coupler 2945 is shown attached to the FFF head 2950. In some embodiments, a kinetic coupler provides a physical and/or an electrical interface to an associated applicator/tool head. In various embodiments, a kinematic coupler enables a tool grabber to actuate, rotate, and/or direct usage of an applicator/tool head connected to the kinematic coupler. The tool grabber 2965 picks up and utilize as applicator as needed to construct a three-dimensional object.

Each system within the 3D printing system is electrically in communication with the power supply 2940 and the electrical control systems 2990 of the 3D printing system 2900. For example, the tool grabber 2965 is electrically connected to the power supply 2940 and electrical control systems 2990 of the 3D printer system 2900 using wires carried through the wire conduit 2925 and wire conduit 2985.

When operational, the tool grabber 2965 moves along a two-dimensional plane defined by the actuated carriage rails. Near the center of the 3D printing system 2900, the build plate 2930 resides on an assembly enabled to move the build plate 2930 along the Z-axis using the actuator 2935. The build plate 2930 moves in the Z-axis to facilitate construction of a three-dimensional object that is built upon the build plate 2930. The top portion of the build plate 2930 includes a vacuum or a magnetic build chuck with interchangeable build surfaces. In some embodiments, the vacuum function of the top portion is constructed and configured to hold a plastic sheet onto the build plate 2930.

The ability to place a barrier material between the build plate 2930 and a three-dimensional object being constructed on the build plate 2930 reduces the possibility that the constructed three-dimensional object will become attached to the build plate 2930 during the construction process. Above the 3D printing system 2900 is a storage shelf 2915 which includes storage bins (2910A-2910D, 2910 generally) for holding extra media for applicators being utilized within the 3D printing system. Each of the bins 2910 are constructed and configured to hold various types of media. For example, bin 2910A is constructed and configured to hold prepreg tape. Bin 2910C, which is smaller than bin 2910A, is constructed and configured to hold Filament.

As shown, the prepreg tape applicator 2980 is being fed prepreg tape from spool 2960.

In this embodiment, the spool 2960 is attached and aligned with the prepreg tape applicator 2980 (described above).

Referring also to FIG. 29B that shows another perspective of FIG. 29A. In this embodiment, the tool grabber 2965 is currently using the prepreg tape applicator 2980. The spool 2960 is shown attached and aligned with the prepreg tape applicator 2980. The prepreg tape applicator 2980 uses idler 2994 to guide the prepreg tape to the prepreg tape applicator 2980. In this current configuration, the 3D printing system 2900 provides the prepreg tape from the spool through to the applicator of the prepreg tape applicator 2980 without significantly adjusting the alignment of the input prepreg tape.

In some embodiments, the spool and tape head are aligned such that the prepreg tape dispensed from the spool is aligned to the disposition tool. Specifically, during dispensing of the prepreg tape to the disposition tool, the prepreg tape's orientation matches the orientation required by the applicator. Further, the prepreg tape does not bend, torque, or modify the orientation of the prepreg tape during the dispensing process.

In various embodiments, a spool assembly dispenses prepreg tape from the spool and guided along the path to the applicator using one or more idlers. The prepreg tape travels downwards to the applicator to the nip roller to be processed by the applicator. If at any point the 3D printing system directs the applicator to rotate, the spool and prepreg tape rotates along with the applicator.

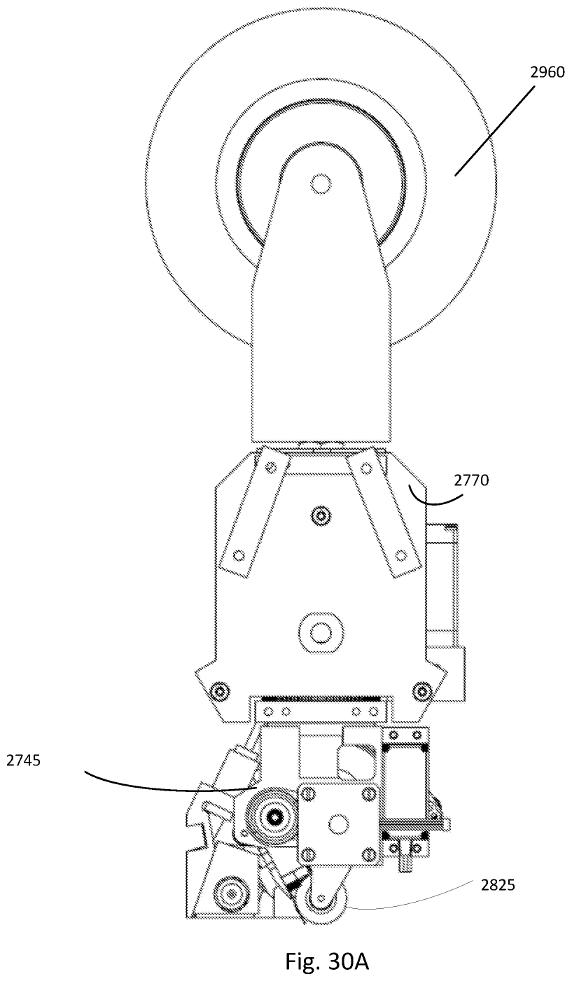

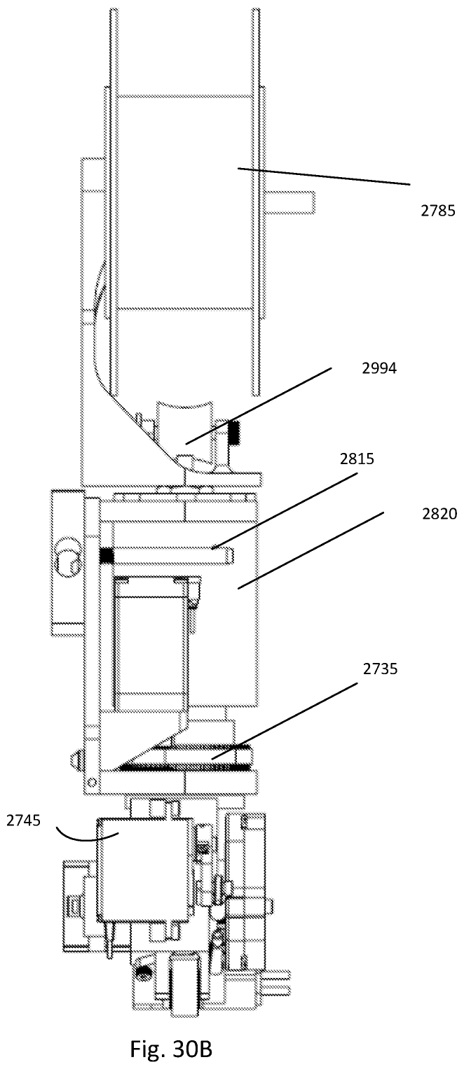

Referring to FIG. 30A which shows a simplified diagram of an exemplary embodiment of a synchronized spool and applicator subsystem. As shown, at one end, a storage spool 2960 is mounted to the synchronized spool and applicator subsystem. At a second end is an applicator /tool head 2745 is mounted to the synchronized spool and applicator subsystem. The prepreg tape stored on the spool/storage 2960 is fed through the center of the synchronized spool and applicator subsystem and directed towards the applicator/tool head using the roller 2825, which places the prepreg tape as needed. A center portion of the spool assembly is coupled to a bracket 2770, which provides mechanical and/or electrical access to the applicator/tool head.

Referring to FIG. 30B which shows a simplified diagram of an alternate perspective of the synchronized spool and applicator subsystem shown in FIG. 30A. As shown, the synchronized spool and applicator subsystem distributes prepreg tape from the spool/storage 2785 using the roller 2994 to guide the prepreg tape through the slip ring/rotational coupler 2820 to the applicator/tool head 2745. The bracket is shown having pin/couplers for mounting the synchronized spool and applicator subsystem onto the fabrication system, when not in use. Also shown, are the teeth/linkage 2735, which provides external access to control over the rotational position of the synchronized spool and applicator subsystem.

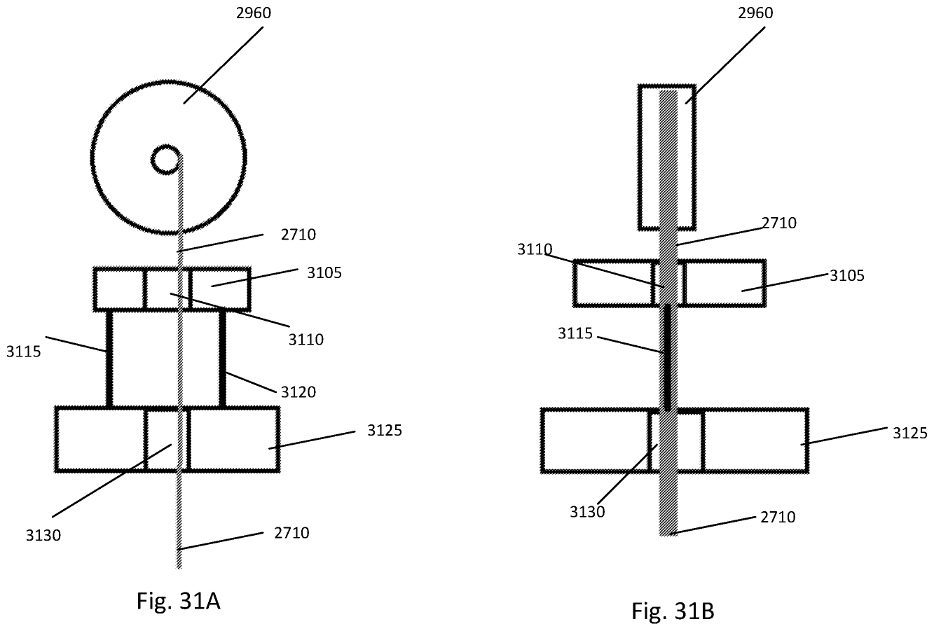

FIG. 31A shows a schematic diagram of a front of alternative arrangement for spool and applicator that includes a first stanchion 3115 and a second stanchion 3120. A first mount 3105 and a second mount 3125 are shown with the stanchions sandwiched or otherwise disposed therebetween. A first bore 3110 is defined by the first mount 3105. A second bore 3130 is defined by the second mount 3125. In one embodiment, the first bore 3110 and second bore 3130 are offset relative to each other or have differing diameters. In one embodiment, tape spans the first bore 3110 and the second bore 3130 and extend to reach an applicator. In one embodiment, a linkage or elongate member spans the first bore and second bore and rotatably couples the spool and applicator. In one embodiment, the stanchions, or other supports hold the first bore and the second bore apart such that a discontinuous shaft results.

In one embodiment, rather than a continuous shaft or bore that allows an elongate member to rotatably couple the applicator and the spool, two bores 3110, 3130 are held apart by some mechanism such as first stanchion and second stanchion shown. FIG. 31B shows a side view of schematic diagram of FIG. 31A according to the disclosure. In FIG. 31B, the side view shows the first stanchion 3115 with the tape 2710 passing behind it, the second stanchion 3120 is not visible. Accordingly, in one embodiment, the slip ring and other rotational elements disclosed herein can be implemented with discontinuous bores/shafts using one or more mounts and supports such as stanchions. In one embodiment, the stanchions are bolts or other attachment mechanisms or fasteners.

### Printing With Fiber-Reinforced Materials

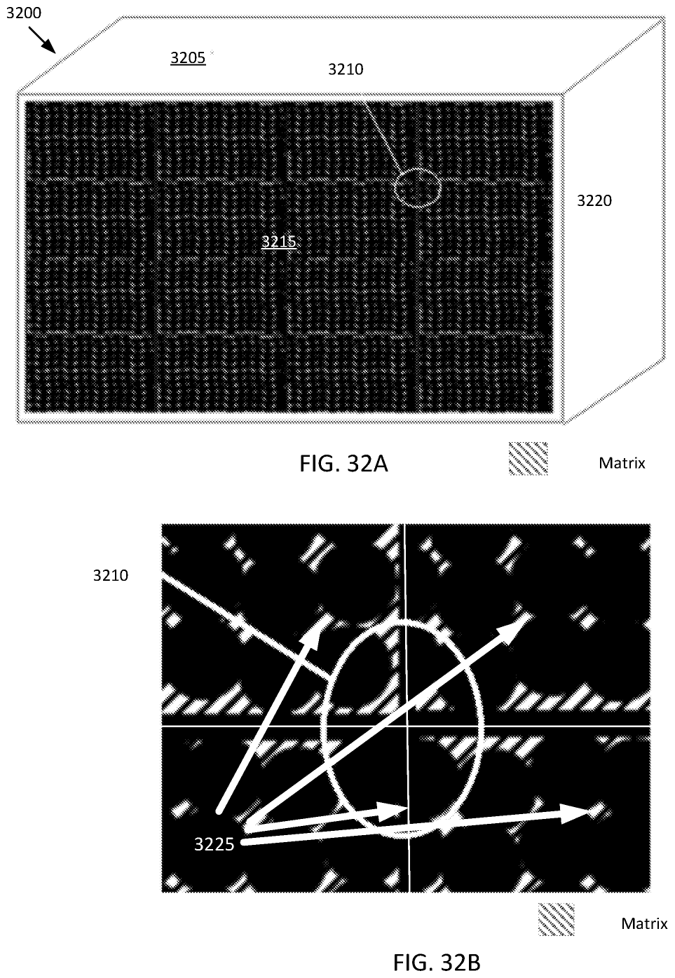

More generally, as used herein, the term unitary construction or unitary encompasses embodiments that are of a singular construction as well as embodiments that include two or more materials that are printed, dispensed, heated, consolidated or otherwise transformed from their unprocessed state by one or more systems and methods disclosed herein and combined to form an assembly or combination. Thus, if a workpiece or part such as a shaft for a hockey stick is formed by heating, depositing, and consolidating tape segments, such as prepreg tape segments, those segments form a unitary part or core. If that unitary part or core is also covered with one or more polymer layers that combination of two materials can also be considered a unitary part. FIG. 32A is a schematic diagram shows such an exemplary part or workpiece 3200.

The part 3200 can be a laminated composite part with multiple layers. In one embodiment, the part is a combination composite part or a dual material part. A combination composite part or dual material part includes a portion thereof formed from a composite material and another material. The non-composite material can be a polymer coating or sections of the part such as stacks of polymer material of 3D volumes thereof. In various embodiments, the polymer material is adjacent to and connected, abutting, interfacing with, or otherwise attached, bonded or linked to regions of composite material such as the matrix thereof. Pre-preg composite tape having reinforcing fibers disposed in a matrix having a polymer coating such as from an FFF-based process is an example of a combined or dual material part. Other multi-material parts as N material parts, wherein N is the number of different materials can be made using the methods and systems disclosed herein.

In particular, FIG. 32A is a cross-sectional view of a part 3200 that includes an inner unitary core 3215 that is formed from various composite tapes that includes a matrix and reinforcing fibers. The tape is prepreg tape in various embodiments. In one embodiment, the tape segments are positioned using an automated dispenser, heated, consolidated and cut to additively build up the inner core 3215 of part 3200. Contactless heating is used in various embodiments. In parallel with the formation of the inner core, a filament based print head such as an FFF-based print head forms various layers or covers 3205. A magnified region 3210 of the inner core 3215 of FIG. 32A is shown in FIG. 32B. The layers and covers 3205 are optional in some embodiments.

In some embodiments, the system includes a second printer head. In some embodiments, the second printer head is configured to deposit material (e.g., by extruding plastic filaments). In some embodiments, the material deposited by the second printer head includes a polymer material such as an FFF-based polymer filament, a polycarbonate, acrylonitrile butadiene styrene (ABS), or any other suitable material. In some embodiments, a given FFF-based material can include chopped or fragments of fibers or reinforcing tubes or other structures.

The magnified region 3210 in FIG. 32B shows the matrix, such as a thermoplastic material or region, with hatching as shown by the legend. In addition, various fibers 3225, such as carbon fibers, glass fibers, aramid fibers, etc., are shown in the magnified cross-sectional view. The inner junction emphasized by the intersecting dotted lines shows the coming together of a corner of four respective tape segments. The four tape segments are joined together at the horizontal and dotted vertical lines to form a unitary part that is reinforced with fibers 3225 dispersed in the matrix in a repeating pattern along the length of each segment.

FIG. 32B is a cross-sectional view that includes circles 3225 that represent the fiber diameters all going in the same direction in one embodiment. In various embodiments, tape layers that include fibers 3225 can extend in other directions without limitation (e.g. perpendicular). For a given part, tape layers can be staggered, overlap, partially overlap, and extend in various directions to provide improved structural support.

Chopped or fragmented fibers can be used as part of the polymer materials printed or deposited using an FFF-based process. In general, replacing a unitary composite core formed from fiber reinforced tape with a polymer material containing chopped fibers is only suitable in certain applications, given the greater strength of composite materials. That said, in some embodiments a combination of prepreg composite tape and FFF-based materials that include chopped fibers can be beneficial. Bearing in mind, it is generally the case that chopped fiber materials lack the additional stiffness and other structural benefits of prepreg tapes. Accordingly, for a given part design, an inner composite core formed using prepreg composite tape may be preferable for various embodiments.

Further, in various embodiments, the polymer materials suitable for use with a given part, such as a polymer suitable for FFF-based printing, may be filled with chopped fibers in order to maximize mechanical properties and also to help mitigate other processing issues such as warping. For example, if a nylon-based polymer is used without any additional reinforcing material, it tends to warp over several layers of printing or placing the material. In contrast, if a chopped carbon fiber filled with nylon is used as a polymer material, warping is reduced or removed and the stiffness and strength of chopped fiber filled nylon is better than nylon that is not combined with such chopped fiber or other additives. Accordingly, for various applications, particularly small aspect ratio structures (i.e., the length in one direction is similar to the length in the perpendicular dimension, and those dimensions are less than about 6 to about 7 inches) chopped fibers may be used instead of continuous fibers. Thus, in one embodiment, the tape used to form the tape segments used to fabricate a composite structure may include one or more chopped reinforcing fibers such as any of the various fibers disclosed herein.

Chopped fibers provide isotropic behavior and thus can provide better stiffness and strength than an additive-free polymer in one, several or all directions. Continuous fiber is suitable to achieve anisotropy. For example, continuous fiber facilitates loading paths and creating greater stiffness in one direction vs. another. This is desirable when making a composite hockey stick. The continuous fiber facilitates greater stiffness along the direction of the shaft, a first direction. In turn, that same level of stiffness across the width of the shaft, in a second direction, is not needed. In part, the disclosure relates to tailoring anisotropic and isotropic behavior of composite parts that include tape segments and one or more polymer materials by selecting the use of continuous fiber versus chopped fiber for inclusion in or use with one or both of the foregoing materials used to fabricate a given part.

Further, simply using one or a few fibers, such as for example as can be centered in an FFF filament is also avoided for the unitary composite core. Example of a single or few fibers per an FFF-based approach are seen in FIGS. 3A-3C and also discussed with regard to Part A herein. Avoiding these approaches helps to increase part strength by improving bonding junctions as shown in dotted lines of FIG. 1B and to avoid unwanted levels of voids, gaps, bubbles, repeating patterns of structural weakness and other unwanted effects.

In various embodiments, as part of designing a given workpiece an analytical approach such as finite element analysis or other analytical platforms can be used to design the dimensions of given composite core for a final part. The part can optionally be covered using polymer materials such as by printing layers or supports in conjunction with depositing, heating and consolidating the tape segments.

As shown in FIG. 32A, the inner core 3215 has a low porosity and a high level of surface contact and interfacing between the matrices of each tape segment and interface zones in which the polymer coating or cover 18 is bonded, linked, cross-linked, adhered, attached or otherwise bound to one or more regions of the matrices of multiple tape segments.

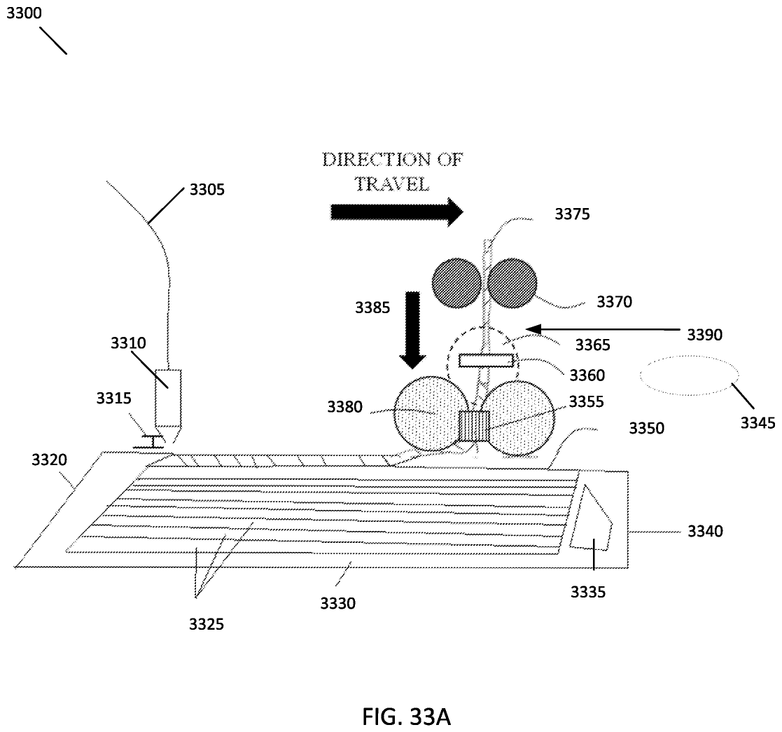

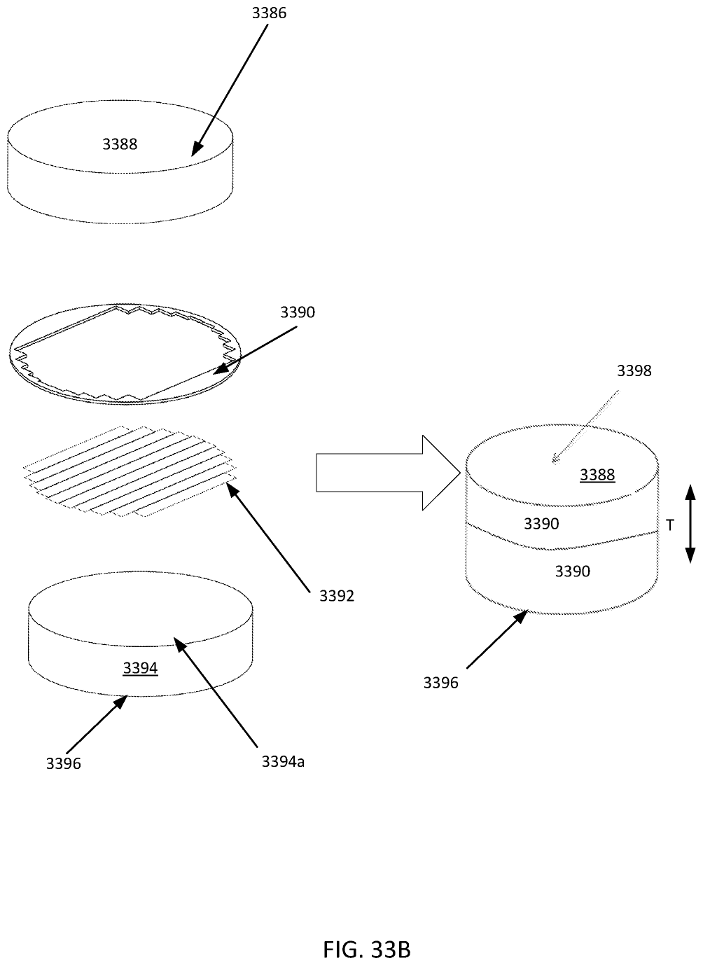

FIG. 33A shows a schematic diagram of manufacturing process implemented by system 3300 that integrates FFF-based printing and composite material placement. As shown, a tape dispensing element or printer head 3390 includes one or more feed rollers attached to the head and configured to drive tape through the head. FIG. 33A shows exemplary feed rollers. In some embodiments, the gap between the feed rollers is adjustable to accommodate different thicknesses in material systems (e.g., different thicknesses of tapes).

In some embodiments, the first printer head includes a heat sink. In some embodiments, the tape passes through and comes into contact with the heat sink as the tape is fed through the first printer head. In some embodiments, the first printer head further includes a blade and an article configured to drive the blade. In some embodiments, the blade is an angled blade. Examples of articles configured to drive the blade include, but are not limited to, solenoids (as pictured in FIG. 33A) and servos. The article configured to drive the blade (e.g., the solenoid), upon actuation, may cause the blade to move in such a way that it cuts the tape as the tape is fed through the first head. In some embodiments, the blade enters into and out of the heat sink as it cuts the tape. In some embodiments, the heat sink is modular (e.g., so as to accommodate different thicknesses of tapes and/or blades. FIG. 33A shows the blade (“tape cutting blade”), solenoid (“tape cutting solenoid”), and heat sink, in accordance with certain embodiments.

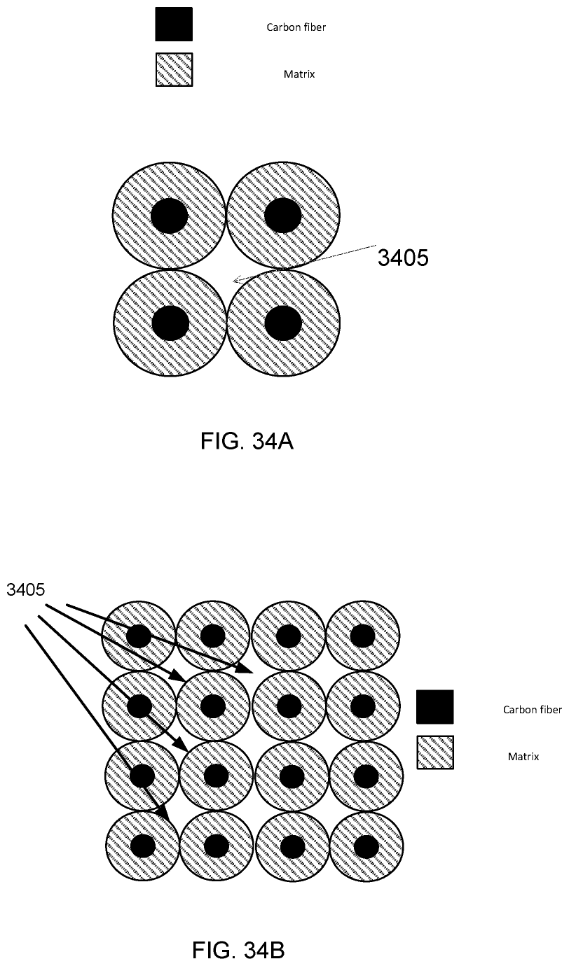

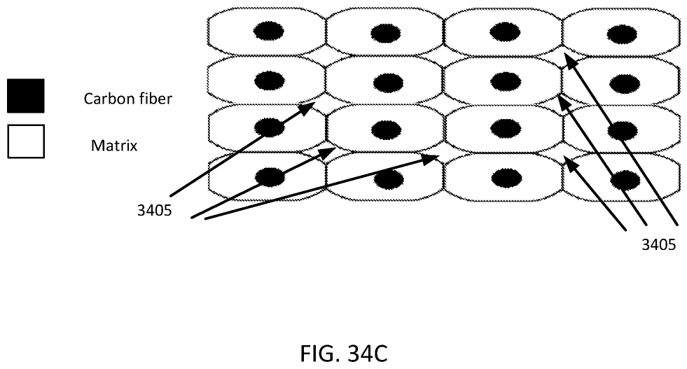

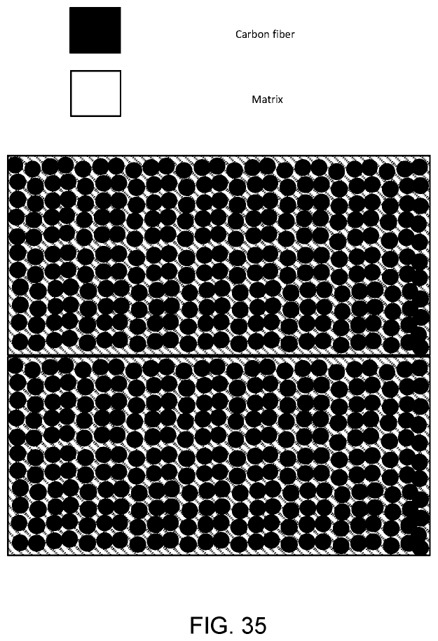

In some embodiments, the system includes a second printer head 3310. In some embodiments, the second printer head 3310 is configured to deposit material 3305 (e.g., by extruding plastic filaments). In some embodiments, the material 3305 deposited by the second printer head 3310 includes polycarbonate, acrylonitrile butadiene styrene (ABS), or any other suitable material. For example, in some embodiments, the second printer 3310 head is a fused filament fabrication (FFF) extrusion head. The second print head 3310 may include a metal heater or flattening edge or bar 3315. This bar can be used to flatten or change cross-sectional profile of FFF filaments such as those shown in FIGS. 34A-34C.

In some embodiments, after the tape is fed through the first printer head 3390 (e.g., via the feed rollers) and cut (e.g., via the blade), the tape 3375 is heated by a heating element 3355, 3345. Element 3355 is a contact-based heat element and heating element 3345 is contacted less in one embodiment. Any element capable of heating the tape to a temperature above the melting temperature of the thermoplastic of the tape may be suitable. For example, in some embodiments, the heating element is a heat block. In some embodiments, the heat block (e.g., a copper heat block) is heated by a thermistor, while a thermocouple monitors and controls the temperature of the heat block via a feedback loop. In some embodiments, the heating element heats the tape by coming into contact with tape as the tape is fed through the first printer head 3310.

In some embodiments, however, the heating element heats the tape without contacting the tape. For example, in some embodiments, the heating element is an infrared lamp or other heat source 3345 capable of radiating heat in the form of electromagnetic radiation toward the tape. In some embodiments, the heating element is capable of heating both the tape being fed through the first printer head 3310 (e.g., “incoming tape”) and the previously laid down layer of tape on the support. Heating the tape being fed through the head (i.e., the tape being laid down) as well as the previous layer of tape can be beneficial in consolidating the two layers of tape (e.g., via thermal bonding of the two layers). In one embodiment, heat source 3345 is contactless and is positioned relative to the tape such that it can radiate heat toward the bottom surface of the incoming tape and the top surface of the previous layer.

In various embodiments, the profile of the tape is in a first state when it is being transported and has not been modified by the system has a first cross-sectional profile. This profile can be substantially identical to the profile of the tape when in a second state after it has been segmented, heated, positioned and compacted. In general, when one or more tape segments are processed using steps disclosed herein the tape will not compact and the thickness of the tape segment will remain the same. In some embodiments, the flow of the polymer matrix to fill in gaps between layers/tows of tape may change, but the cross-sectional profile of the tape remains rectangular or deviates from its unprocessed shape. In one embodiment, the deviation from unprocessed tape to tape disposed in the part after building the part ranges from less than or equal to about 5% along either its length, width, both, or a combination there of.

For an exemplary non-limiting example, if tape has 5 mm by 1 mm rectangular profile. The tapes profile can vary in either plus or minus amount for each of the following: by about 0.25 mm in along the 5 mm dimension, by about 0.05 mm along the 1 mm dimension, about 0.25 mm in along the 5 mm dimension and by about 0.05 mm along the 1 mm dimension, or a variation of plus or minus 0.30 mm (0.25+0.05 (0.30)) with regard to either 1 mm or 5 mm directions.

FIG. 33A shows an exemplary compaction roller 3380, in accordance with certain embodiments. The compaction roller(s) 3380 may be positioned in close proximity to the part of the first printer head 3390 that extrudes the tape and lays it down on to the support. The compaction roller 3380 may, in some embodiments, provide constant or variable pressure (e.g., in the direction toward the support) so as to flatten the material and provide necessary compaction pressure for consolidation. In some embodiments, the first printer head and/or the second printer head are capable of interfacing with any XYZ gantry motion platform (e.g., any three-dimensional translation stage).

As shown in FIG. 33A, a combined part 3340 is shown. This part has a first support 3330 that has been used to position tape segments 3325 using the print head 3390. The first support 3330 has been formed using polymer filament via an FFF process. Surface cover 3320 has been printed using the second print head 3310 as the tape segments have been laid down. Three-dimensional volume 3335 has also been printed in regions in which tape segments have not been placed. This volume 3335, and surface cover 3320 will be sandwiched between first support 3330 and the top layer (not shown) that is printed when all of the segments have been placed. In this way, the inner unitary core that includes tape segments 3325 will be fully or partially covered with a polymer material. In general, references to a print head, printer head, etc., as recited herein also encompass one or combinations of the various heads and applicators disclosed herein.

In one embodiment, additional material, such as FFF-based material, is additively deposited relative to one or more three-dimensional structures formed from prepreg tape. An example of this is shown in FIG. 33B. In particular, FIG. 33B, shows a finished combination composite or dual material part 3398 on the right that has been formed by a combination of FFF-based printing of various supports layers, stacks and regions. Initially, a polymer-based material, such as for example an FFF-based material layer, can be used to print a first support 3394 which includes as a first surface 3394a for a composite part having a composite core. The first surface also has an outer surface 3396. This outer surface 3396 is one outer surface of part 3398. The first surface 3394a of support 3394 receives a first group of tape segments 3392. These are built up through the laying down, cutting, heating and consolidation of fiber segments.

Multiple sets of fiber segment-based layers 3392 are built up and have a thickness T that forms a unitary core of the part 3398. Each layer 3392 rests within a layer 3390 in some embodiments. The content, orientation, and arrangement of the tape segments, stepped/jagged profile, and other features can vary for each respective layer 3392, 3390. Each tape segments for a given layer 3392 is placed on a per segment basis to form a layer. All of the FFF-based materials can include polymer materials such as plastic. In turn, all of the polymer materials that are printed can include chopped fibers or other materials in various embodiments. Further, the tapes disclosed herein can include chopped fibers, continuous fibers or combinations thereof. The subsequent tape runs are placed on the first material, here an FFF-based support 105. The outer surface 3396 of the first support will ultimately serve as one of the surface of the finished part.

As the tape segments are deposited and combined to form a unitary structural core, sections or boundaries of material, such as FFF-based material, are additively placed relative thereto to form another surface of the final part. In the illustrated case a substantially cylindrical solid part 3398 having a first circular support 3394 formed from FFF-based material and a second circular support 3386 formed from FFF-based materials the composite part would be a smaller cylinder sandwiched between the two polymeric parts 3394, 3386 in the case of using polymer based filaments for FFF printing. The inner unitary support region is formed by tape segments layers 3392. The layers 3392 have a characteristic jagged or stepped boundary in various embodiments. This is achieved by sizing the tape segment such that it terminates before reaching the outer edge of a given support or first, second or third surface. In one embodiment, a given FFF-based material that is printed to form a support 3394, 3390, 3386 can be rolled or otherwise compacted prior to receiving composite tape segments or after the placement of each tape segment or a specified number of tape segments. As each layer of tape segments is formed, the regions that lack tape are filled in by FFF material or other polymer material as shown by polymer layer 3390 that would be co-planar with layer 3392 in part 3398. The tape segment layers 3392 and the polymer layers 3390 can be formed simultaneously or on an alternating basis in various embodiments. In one embodiment, rolling or compacting tape segments that have been heated facilitates bonding, linking, adhesion, interfacing, etc. between printed polymer material, such as first, second, third, Nth surface or stack, and tape segments.

A circular ribbon is formed by outer edge of layer 3390 as each layer stacks up along thickness T. between the two circles and in contact with the inner core is formed as the tape runs are created. Thus, this ribbon or third surface 3390 is built up incrementally as the thickness of the inner core reaches a final thickness T. In finished part 3398, T shows the thickness of the tape segment layers 3392 and polymer layers 3392 that span the inner region of the part 3398. A final support 3386 is printed or placed on top of last layers 3392, 3390 to provide an outer cover for the part. The outer surface 3388 of support 3386 is shown as the top surface of the part 3398. Surface 3396 is the bottom surface (not fully shown). The incremental polymer edges of the various layers 3390 form the middle surface or ribbon that spans the two outer surfaces supports 3394, 3386. Each of the layers, regions, and domains of a first material are connected, linked, bonded, cross-linked, interfaced, attached, adhered or otherwise in communication with the first material or a second material. This can be achieved as a result of heating and/or compaction steps during processing. In various embodiments, voids are mitigated at various junctures and regions of dissimilar materials being positioned to increase structural integrity of part and to reduce failure modes.

FIG. 34A shows a repeating structural grouping of four filaments fabricated with an FFF-based method. FIG. 34B shows a repeating structural grouping of several filaments fabricated with an FFF-based method. FIG. 34C shows a repeating structural grouping of several filaments that have been ironed or flatten during heating as part of an FFF-based method. As shown in all of these figures, unwanted voids or gaps 3405 form when the filaments are stacked and placed relative to each other. For a part made from these repeating units with gaps present throughout the part, the structural integrity of the part is greatly reduced compared to the composite based approaches using tape segments disclosed herein.

In one implementation, as shown in FIG. 34C, the filament is squeezed out to form “beads” that can be flattened with a tool or surface as part of the FFF process. With some pressure, the filaments compact to something more rectangular vs. circular as shown in FIG. 34C. As is the case with FIGS. 34A and 34B unwanted voids are present at the intersections 3405. The black dot in the center of each of the filaments represents a small carbon fiber (−1 mm wide) that is surrounded by a nylon (or theoretically, another thermoplastic) matrix. The matrix is what enables bonding to previous layers, the same way normal plastic FFF printers work. Using an embedded carbon fiber inside such a matrix is typically not desirable. A given part may have, at about a 25% fiber volume fraction, in additional to the 10+% porosity due to the voids at intersection. As a result, the presence of more matrix material relative to fiber (75/25) and the presence of voids 3405 at all of the intersections, limits the use cases for such an FFF process to make a quasi-composite part. Any such part is likely to have structural and performance issues.

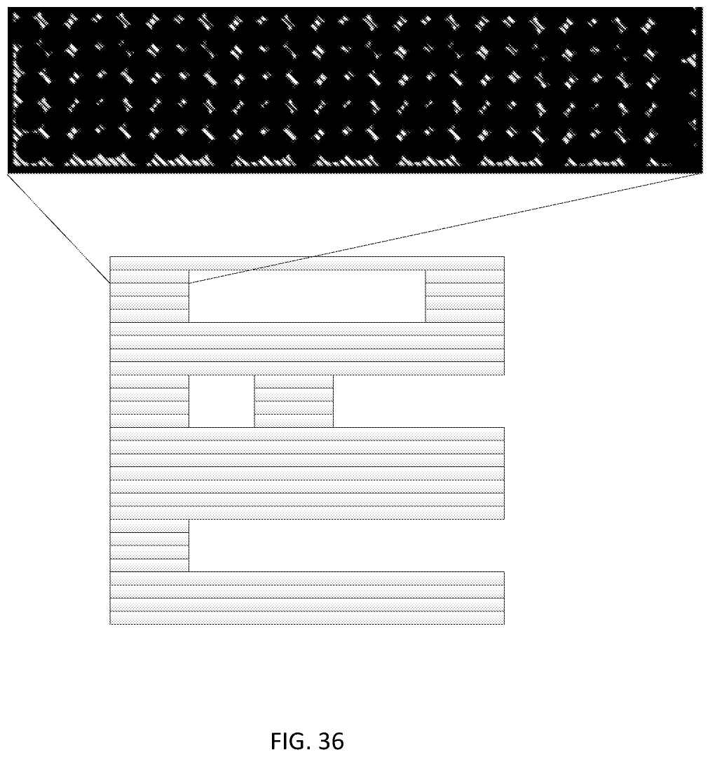

In one embodiment, prior to heating, depositing the tape and consolidating the tape with a roller, the tape being transported to the tape dispensing head has a porosity that is typically less than about 2%. The magnified tape segment shown in the cross-section of the part of FIG. 36 can be formed to comply with this porosity on a per tape segment basis. This porosity corresponds to trapped air bubbles in the matrix material which is impregnated into fibers of the tape. Most of those air bubbles are squeezed out when the compaction roller applies pressure which results in an even lower porosity.

In general, the tape-based approaches disclosed herein reduce porosity levels which are correlated with air or other gasses in a given part or part component. Air creates discontinuities which can cause cracks to form. An increase in part or part component discontinuities is desirable. Discontinuities result in a reduction in mechanical properties, including a reduction in strength. This follows because a given part/part component/structure will start to crack earlier than expected. A lower porosity or void or gap count would counteract this negative effect. Furthermore, when ready for use, in a first state, the tapes have a 50-65% fiber volume fraction. The fibers maximize stiffness. More fibers correspond to higher stiffness. 3× the stiffness results, roughly from about 3× the amount of fibers in the material used in some embodiments.

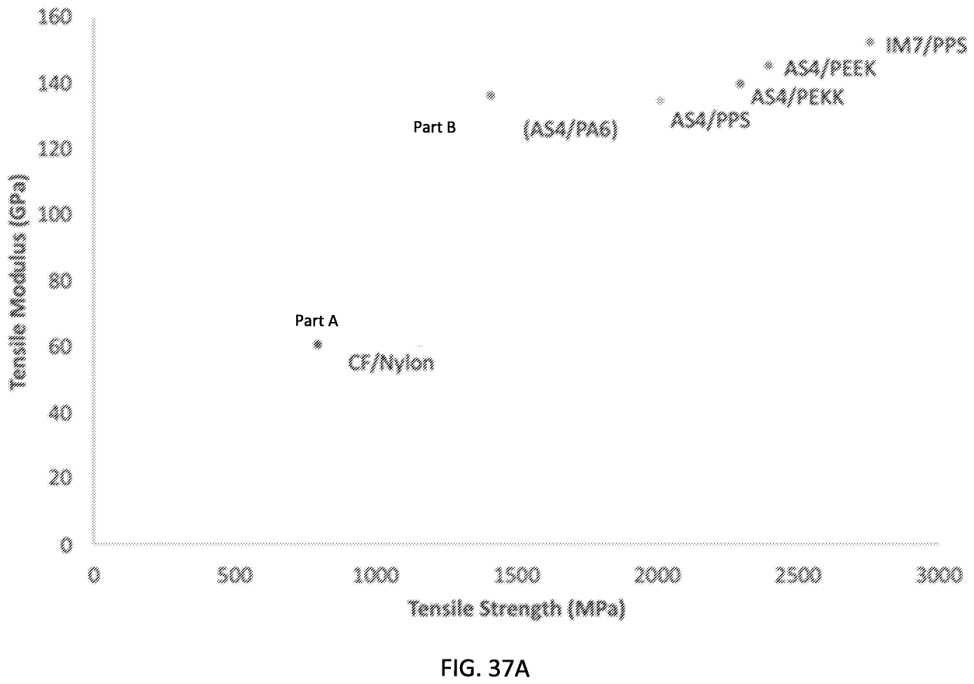

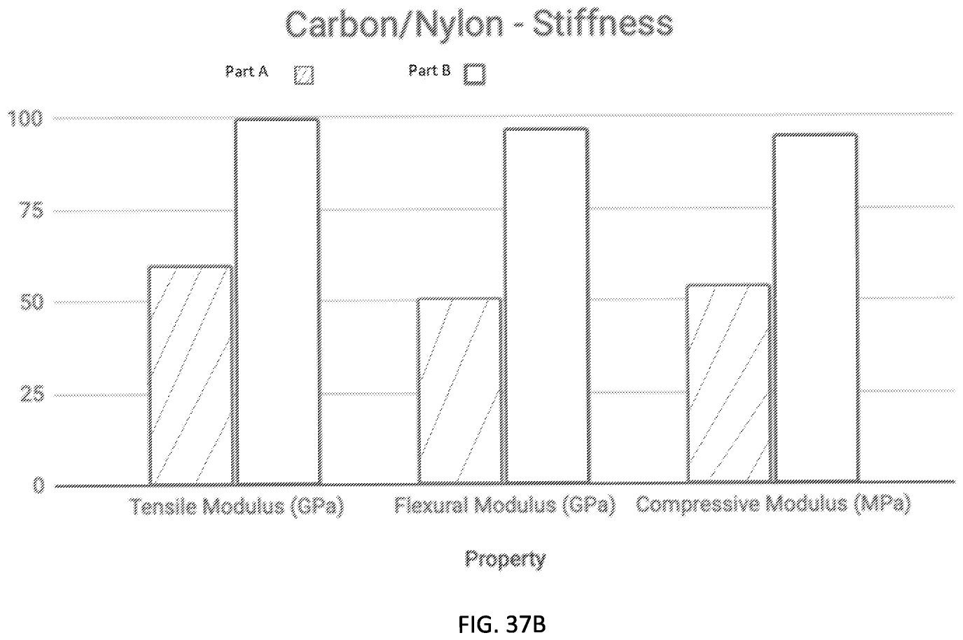

FIG. 37A is plot of tensile modulus versus tensile strength for part A fabricated with FFF-based method, part B fabricated with prepreg tape based method, and other comparable parts in accordance with the disclosure. Part A corresponds to an FFF-based approach using structural units with a high matrix content and low fiber content and voids 3405 as shown in FIGS. 34A-34C. As shown, Part A has the lowest tensile strength and lowest tensile modulus relative to Part B which is fabricated using one of the tape-based methods disclosed herein and AS4 carbon fiber and PA6 for the matrix. Other part values for different matrix materials and fibers have even high strengths and moduli as shown.

FIG. 37B is a series of three histograms comparing Part A and Part B referenced with regard to FIG. 37A in accordance with the disclosure. The units are shown in parenthesis in the X-axis—GPa or MPa, [Load/square area]. 1 Pa=1 N/m², so 1 GPa is about 1×10⁹ Pa. As is clear from the data, Part B (tape-based unitary core part) is stronger/dominant in all categories compares to Part A (FFF-based, low fiber/high resin ratio. The chart shows tensile stiffness and strength for carbon/nylon. The porosity for Part B is less than about 2% while for Part A it is greater than about 10%. In other embodiments, the elongation percentage to break (%) of unitary composite core or overall part can be used as a parameter to target or assess for a given composite or combination composite part. Further, the ratio of stiffness of part or inner core of part to elongation percentage of part of inner core of part can be determined. In one embodiment, the elongation percentage to break ranges from about 0.2% to about 1.5%. Stiffness of a given part can be about 2 times to 12 times stiffer than a part that lacks reinforcing fibers in tape segments.

FIG. 26A is an exemplary flow chart for the operation of the system suitable for making composite parts using prepreg tape and/or parts that include a tape-based composite core with a polymer coating in accordance with an embodiment of the present disclosure. Given that FFF-based methods print a part in terms of slices, while a tape-based automated fiber placement system typically does not, additional processing steps are undertaken to operate a system that combines the features of both part generating modalities.

To manufacture an item, the system builds instructions (i.e., G-code) to direct the FFF head and the tape laying head to manufacture the item one layer at a time. Initially, the system imports a three dimensional drawing of the item showing/describing the geometry of the item (Step 2605). The system utilizes slicing software to determine the structure of the item and divide it into multiple 2D slices that represent each layer the printer needs to build up. The user can define regions, or chunks, of the part corresponding to layers of tape and/or layers of FFF required to construct the item (Step 2610). Data relating to strength of part of how to reinforce core can be used to design shape of unitary core. If a chunk is an FFF chunk, the system generates an FFF chunk of G-code (Step 2615) and incorporates that G-code into the combined instructions (Step 2620). If a chunk is a tape chunk, the system generates a tape chunk laying G-code (Step 2625) and incorporates the G-code into the combined instructions (Step 2620). Although reference is made to G-code any suitable programming or control language used to process slices or otherwise control a 3D printing device can be used in various embodiments.

Upon completion of the combined instructions, the system starts directing the FFF head and the Tape Laying head to create the item in accordance with the combined instructions. The system directs the FFF head to print a bottom shell/chunk (Step 2630) which is followed by the tape laying head bonding prepreg tape to the FFF shell (Step 2635). The bottom shell is first support layer in one embodiment. Upon completion of each round of tape laying, the system compares the tape positions with the perimeter of the outer shell (Step 2640) to determine whether to use more FFF to infill areas of the partially built item (Step 2645). In part, the disclosure relates to tracking or otherwise evaluating composite tape segments and comparing their positions with the outer part perimeter.

By performing this analysis and comparison, the systems and methods disclosed herein can be used to fill-in areas, such as jagged or step regions in layer 3390, not covered by tape segments to create a uniform layer thickness for the part. These stacks of polymer materials that are placed to interface with or link with the cut and consolidated tape segments, such as exemplary layer 3392, allows the part to have uniform layers built up over time of two or more different materials. This approach also reduces or prevents unwanted voids forming at the junctions of dissimilar materials such as an FFF polymer and a prepreg composite tape with reinforcing fibers disposed in a matrix of thermoplastic or thermoset polymer.

Upon determining the appropriate FFF in-fill of regions not covered by tape, the system directs the tape laying head to bond subsequent tape layers to previous tape layers (Step 2650) until the tape deposition process completes the unitary composite-based core of the part. Upon determining that no more tape is needed, the system prints a top shell/chunk (Step 2655) at least partially enclosing the tape layer. In some, embodiments, the system continues repeating steps A6-A11 until the item is complete. In one embodiment, a second support or top layer is printed using filaments and the various FFF layers are linked at one or more edges or vertex to form an overall or partial shell with the unitary core disposed therein. The overall porosity of the finished part is less than about 5% in one embodiment. The overall porosity of the finished part is less than about 4% in one embodiment. The overall porosity of the finished part is less than about 3% in one embodiment. The overall porosity of the finished part is less than about 2% in one embodiment.

### Modified Polymer Filament Systems, Materials and Methods of Part Manufacture

In particular, the disclosure is directed to systems and methods solving various technical problems with filament deposition systems such as FFF-based systems that use polymer filaments, polymer filaments with a continuous fiber core, or simultaneously impregnate polymer filaments with a continuous fiber core, polymer filaments that include chopped fiber (each of the foregoing an exemplary “modified polymer filament (“MPF”)” also referenced to herein as an MPF-based material or that deposit, print, flatten, iron, deform, or otherwise modify a MPF to generate a part from the foregoing materials or combinations thereof. In various embodiments, references to FFF-based systems and materials as disclosed herein can also be used to operate and transform MPF to fabricate various parts and combination parts as disclosed herein. In one embodiment, a combination part may include a prepreg tape suitable for use with an automated fiber or tape placement can be used with an MPF material to fabricate a combination part.

In some embodiments, MPF materials can be operated upon using a high speed vibrator such as an ultrasonic vibrator or other material to selectively flatten or change the structure of such materials. In addition, these materials may be treated with UV light, chemicals, irons, stamps, sanders, crushers, and other automated mechanical apparatuses to modify the shape and interface connections of MPF materials. Heating MPF materials and applying one or more secondary mechanical operation can transform them into various tape-like materials and reduce voids between individual MPFs when deposited or otherwise placed to form a part.

Various nozzles and combinations of nozzles or depositors for MPFs can be combined in various arrays and structures for a given print head. In one embodiment, nozzles having width or diameter that ranges from about 1 mm to about 4 mm can be used. Various nozzles and heaters can be used to additively manufacturing composite parts using MPF materials. In various embodiments, the heating source can be provided from IR lamps, laser, LEDs, IR LEDs, metal heat blocks, radiant sources, or some other non-contact heating source.

In various embodiments, a given MPF is formed using a “tow” of carbon fiber which may include from about 1,000 to about 1,500 individual fibers bundled together to form about a 1 mm diameter tow. In one embodiment, such a tow is co-extruded with a thermoplastic matrix to build up layers. In one embodiment, a larger nozzle can be used to co-extrude a larger tow such a 12k tow with 12× the amount of carbon fiber. In various embodiments, a large tow is extruder out of a nozzle to improve both volumetric laydown and fiber volume fraction. In one embodiment, the width of nozzle is matched to width of prepreg tape being used to fabricate a combination composite part. In one embodiment the width of the nozzle of FFF-based print heads ranges from about 5 to about 6 mm.

In various embodiments, multiple FFF extrusion nozzles can be used to increase efficiency of manufacturing. In many embodiments, a larger FFF extrusion nozzle could be used to create a larger tow of carbon fiber. The larger tow of carbon fiber can be co-extruded with a thermoplastic matrix to build up layers. In this embodiment, a larger nozzle could create a 12K tow with twelve times the amount of carbon fiber and extrude that out of a nozzle to improve both volumetric laydown and fiber volume fraction. While the larger diameter nozzle in FFF could cause a loss in resolution and dimensional accuracy, using a larger FFF extrusion nozzle in combination of FFF heads with a low-count carbon fiber tow (i.e., 1K or 1.5K) provides increased efficiency without losing the resolution and dimensional accuracy when needed, such as for smaller parts. Chopped fiber fragments can also be added in various embodiments.

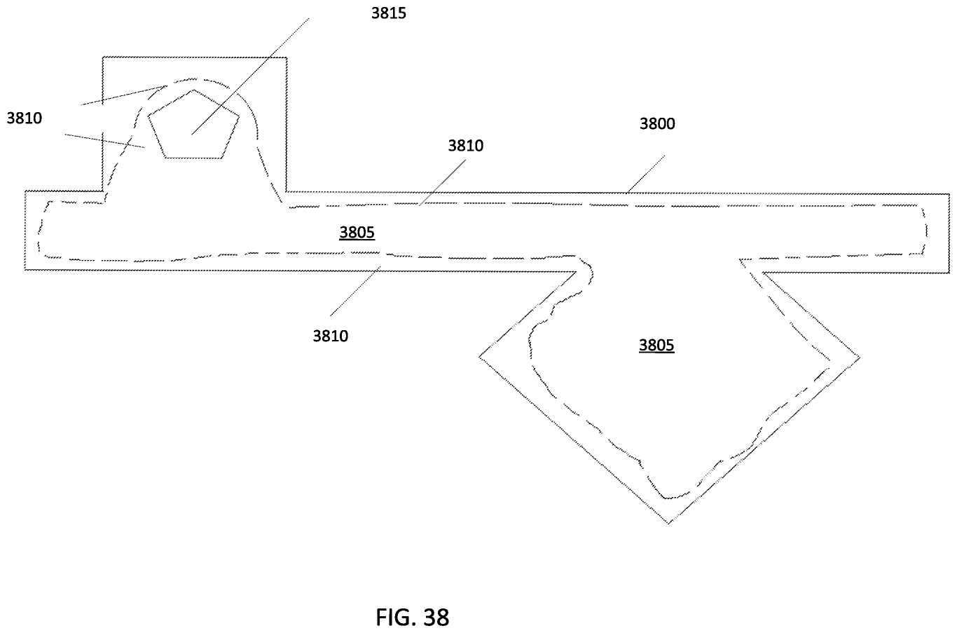

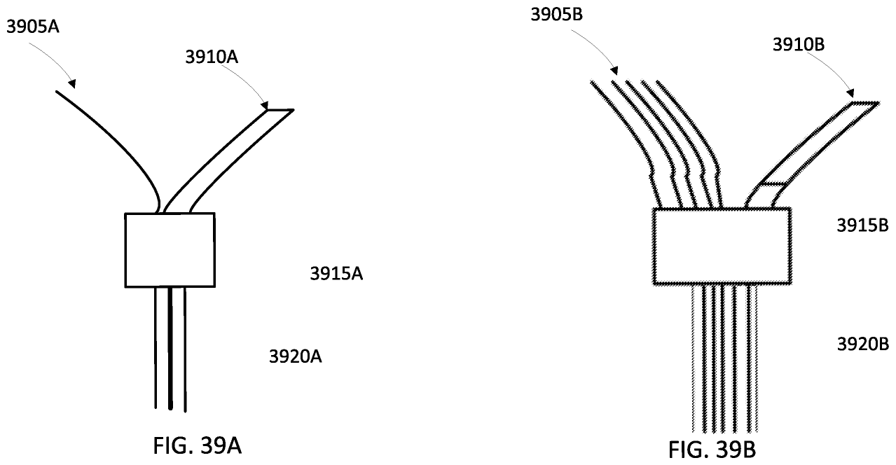

FIG. 38 is a schematic diagram of part that is fabricated with a first and second infill section using a polymer material to incremental print or form constituent layers thereof. The part 3800 can be formed using the various processes disclosed herein. The part 3800 can include a unitary core and include regions formed by tape or be formed in its entirety from FFF or MPF materials. For example, Hole/channels 3815 can be formed in the part 3800. Perimeters 3810 can be formed by tape or formed in its entirety from FFF or MPF type materials. Also, various materials can be used for larger scale MPF infill 3805. The materials used can be co-extruded and impregnated during or just prior to deposition using one or more techniques to combine fibers and polymer materials such as shown and described with regard to FIGS. 39A and 39B.

FIG. 39A is a schematic diagram that depicts a print or deposition process and related head 3915A that receives a carbon fiber 3905A (CF) and a polymer material 3910A, such as FFF-based material and combines them to create a composite material 3920A. FIG. 39B is a schematic diagram that receives multiple carbon fibers 3905B (CF) and a polymer material 3910B, such as FFF-based material, and combines them to create composite materials 3920B. The heads and input materials depicted in FIGS. 39A and 39B can be used to combine or impregnate polymer materials with a single fiber or multiple fibers. In one embodiment, the fiber or fibers and materials are co-extruded and partially combined or fully combined. In one embodiment, the fibers and polymer materials are combined when subjected to compaction on the print bed. The head shown in FIG. 39A and 39B can include one or more nozzles in various embodiments.

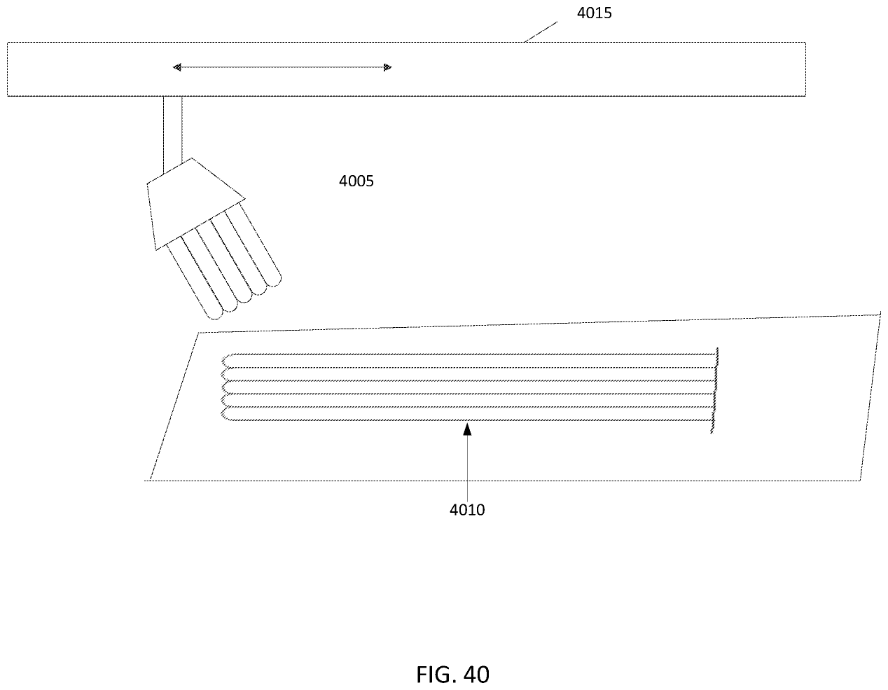

FIG. 40 is a schematic diagram that depicts a multi-nozzle print head 4005 suitable for printing, depositing, or co-extruding polymer materials, chopped fibers, and continuous fibers in accordance with the disclosure. The system of FIG. 40 can be used to incorporate fibers and polymers as shown in FIGS. 39A and 39B.

In one embodiment, a print head 4005 or other deposition head can use both a large nozzle and a small nozzle for manufacturing or multiple nozzles as shown in FIG. 40. The Multi-nozzle print head is capable of outputting polymer with or without chopped or impregnated fiber, shown by arrow 4010. The multi-nozzle print head 4005 is coupled to a gantry 4015 to facilitate movement of the multi-nozzle print head 4005. FIG. 38 shows an exemplary part that is formed in whole or in part with MPF materials. For the perimeters and outer layers, regions near or outside dotted lines, the smaller nozzle is used to preserve dimensional tolerances. The smaller nozzle can also be used in narrow regions such as around hole in part. When infilling the interior of the structure, a larger nozzle can be used. This provides improved efficiency because the larger layers incorporate greater tow fibers and thus increase fiber volume fraction. The increase in fiber volume fraction provide better mechanical properties. In this way, FFF and MPF materials can be used to increase part strength and increase regions of contact there between and otherwise reduce voids.

Refer to FIG. 38, which is an example of system that uses various nozzle sizes for FFF/MPF heads, in accordance with an embodiment of the present disclosure. As shown, the outer edges of the part and any portion of the part that require finer detail is shown in dotted border. When using a combination of a larger and smaller FFF nozzle, the smaller nozzle can be used to print the detailed portions requiring accuracy, while the larger nozzle is used to fill in every other portion of the part. The varied use of the nozzles provides improved or optimized laydown rates and increases or optimizes fiber volume fraction. The various nozzles can be part of one head or system such as that shown in FIG. 40. In one embodiment, existing FFF nozzles are used to build /print perimeters and outer layers such that dimensions are within tolerance. This is performed while the interior of part (see FIG. 38) has an increased or optimized or augmented fiber volume fraction and reduced porosity.

Further, in many embodiments, another advantage is that with features like holes, a smaller FFF nozzle has the accuracy and ability to reinforce the hole as shown in FIG. 8. Specifically, in these embodiments, an FFF nozzle can circle around a hole to reinforce that hole, such as hole/channel shown in FIG. 8, whereas with prepreg tape is limited by the minimum bend radius of the tape. Also, the wider the tape, the harder it is to bend a tight radius. Thus, with the availability of various tools, 3D printing nozzles can be used for continuous fiber reinforced plastic and be able to reinforce around a hole while using tape in the middle portion of the part to obtain desirable mechanical properties. Thus, tape deposition heads can be used with various MPF/FFF embodiments.

In another embodiment, multiple separate spools of lower-fiber count carbon fiber (about 3 k tow) for an MPF can simultaneously be feed into the thermoplastic material. The result might be the same diameter bead that is currently extruded, but instead of 10% fiber and 90% matrix, there could be 50% fiber and 50% matrix. An example of this approach is shown in FIGS. 9A and 9B. Low-count fiber refers to an MPF that includes less than or equal to about 1,500 fibers dispersed in an FFF-based filament. In one embodiment, bead refers to the heated FFF or MPF material that is deposited from a nozzle or other source attached to a moveable head. The materials can be used to link, combine, or impregnate a polymer with a higher volume of continuous fibers.

FIG. 39A represents an implementation that uses a low-count carbon fiber (CF) with plastic, coextruded. In contrast, FIG. 39B co-extrudes the same way, but takes multiple low-count carbon fibers (CF) and co-extrudes with the plastic. Other fibers can be used to replace carbon fibers without limitation. With regard to FIG. 39B, the resulting extruded bead, block or chunk of transformed MPF incorporates greater fiber volume fraction. In one embodiment, the fiber used in embodiment of FIG. 39A is a higher-count fiber such as a 6K tow. In one embodiment, a nozzle has a diameter that ranges from about 0.2 mm to about 6 mm is used or multiple nozzles are used.

To address the void issue, the larger nozzles could be brought closer to the bed such that there is a higher pressure that squeezes the extruded bead down to a mostly flat bead that might be representative of prepreg tape. The distances from nozzles to print bed can range from about 0.03 mm to about 0.1 mm. Such a close proximity extrusion process can be used for internal layers of a part to improve mechanical property maximization versus dimensional accuracy. The nozzle can be heated or the work area can be heated to extrude at a higher-than-normal temperature to enable greater flow of the matrix. In various embodiments, the temperature ranges for heating FFF-based material depends on the material.

In one embodiment, the temperature ranges is from about 50° C. and to about 100° C. The distances from nozzle to print bed is adjusted to mitigate flow back into the nozzle in order to prevent or mitigate jams. Excess FFF-based material can surround or cool inside nozzle and create unwanted jams if distance from print head is not adjusted accordingly. This can be performed using a camera or other metrology tools. The distance is also set to mitigate material oozing out of the sides of nozzle or printing region, which may result in damaged, weakened, noncompliant, or unappealing parts. In one embodiment, the pressure and distance are set to flatten the bead of FFF-based material while reducing side flow, jams and unwanted part characteristics.

In general, the temperature is selected to be higher than the melting point of the material. For example, if the FFF-based material is PEEK, for one embodiment, the filament is heated to value equal to a threshold (X)+melting point of temperature. Thus, for a given fabrication session, the system temperature for heating FFF-based material may be set to extrude at 450° C. to increase flow or spreading of filament, even though melting temp is about 385° C. Nylon has a melting temperature of about 270° C. In one embodiment, the system heats a Nylon filament such that it can be extruded at about 350° C. As an upper limit, the temperature is set below a burn, smoke, or other degradation point such that the FFF-based material does not get too hot and burn.

In one embodiment, the material is heated to a temperature greater than the melting point by a threshold X. In one embodiment, X is about 10% greater than the melting point temperature. In one embodiment, X ranges from about 10% of melting point to about 35% of melting point of material. In one embodiment, X is less than about 40% of melting point of material. The print surface/bed can be heated in one embodiment to increase MPF flow. This combination of higher temperature and greater pressure, together with greater-tow fiber, can result in a part with higher fiber volume fraction and reduced porosity. This follows because the extruded MPF materials form blocks or chunks that are adjacent to each other both in-plane and out-of-plane.

The issue of voids at junctions that appear as “diamond voids” or voids in general when cylinder-like shaped MPF are stacked or joined, can be mitigated by enabling greater flow of the matrix such that it fills those voids. In one embodiment, heat and pressure allow the matrix to fill in gaps and create a continuous section. Such an approach is calculated using one or more models and typically balances dimensional accuracy and printability as a trade-off for void mitigation. In various embodiments, the systems and methods are controlled with one or more feedback loops and/or mechanical guards or systems to facilitate printability. These can be used to prevent material from oozing off the sides of the nozzle, which can interfere with the ability to print a sufficient amount of material. Sideways or other flow losses from nozzle can result in a failure to satisfy target part tolerances and also results in unappealing part appearance/aesthetics.

In one embodiment, the use of larger nozzle or multiple nozzles improves faster deposition speed for MPF materials and better properties because of more fibers. In some embodiments, it is desirable to size the carbon fibers with the MPF material such that it enables the surrounding matrix, nylon or other material, to bond to it effectively.

FIG. 40 shows a multi-nozzle FFF-based print head and the associated transport system to move it for 3D printing. The polymer output with multiple rows of simultaneously joined or fused polymer runs is also shown. This configuration can be used with fibers and polymer filaments as inputs or filaments or filaments with chopped fibers. The use of a multi-nozzle apparatus offers various advantages. In one embodiment, the system includes one or more of a mechanical, ultrasonic wave generator, agitator, and vibration generator suitable to level or flatten recently deposited MPF materials. In various embodiments, heat can be applied and re-applied at various intervals.

In one embodiment, the system is configured to extrude at normal parameters/conditions, and then perform one or more passes over the deposited, printed, and/or printed materials with a first subsystem. The first subsystem applies additional heat and/or pressure to flatten the layers. The first subsystem applies force to facilitate polymer flow and fill voids between polymer materials including FFF-based material to FFF-based material junctions and junctions between FFF-based material and a tape-based material and between tape-based material junctions. In one embodiment, the subsystem may include a tape head or an element attached thereto. In one embodiment, the subsystems may perform one or more pass with a contactless heater such as an IR heater and compaction roller to facilitate polymer materials to flow and flatten. In this way, FFF-based materials can be modified after initial printing to have a cross-sectional profile that has reduced voids and greater surface area contact with other part materials. In part, the method and systems increase areas of contact between similar or dissimilar materials such as FFF, MPF, and prepreg tapes as part of part fabrication using the systems and methods disclosed herein. In various embodiments, consumables/disposables, such as FFF filament or tape, such as a thermoplastic tape, for use with the various applicators are selected such that one or more of their properties vary along different dimensions or directions. In various embodiments, a first anisotropic FFF material is used in conjunction with a second anisotropic tape material.

In one embodiment, the composite tape includes a group of reinforcing fibers disposed in a carrier material. The ratio of the volume of the reinforcing fibers to the carrier materials is greater than about 0.3 in one embodiment. In one embodiment, volume fraction ratio ranges from about 0.4 to about 0.6. In one embodiment, volume fraction ratio ranges from about 0.5 to about 0.6. In one embodiment, the volume fraction ratio is less than about 0.7. In one embodiment, volume fraction ratio (VFR) ranges from about 0.5 to about 0.7.

In various embodiments, the carrier is a polymeric material. In one embodiment, the carrier includes one or more components selected from the group consisting of a polymer, a cross-linking agent, a resin, a thermoset material, a thermoplastic material, and a catalytic agent.

Any fiber suitable for the desired impregnation into a tape may be used. Examples of suitable fibers impregnated into the tape include, but are not limited to, carbon fibers (e.g., AS4, IM7, IM10), metal fibers, glass fibers (e.g., E-glass, S-glass), and Aramid fibers (e.g., Kevlar). Multiple different types of fibers may be impregnated into the tape, in accordance with certain embodiments. Suitable pre-impregnated tapes can be purchased from a variety of commercial vendors, including Toray/TenCate, Hexcel, Solvay, Barrday, Teijin, Evonik, Victrex, or Suprem.

In some embodiments, the tape has a certain width. In some embodiments, the width is greater than or equal to about 1 mm, greater than or equal to about 1.5 mm, greater than or equal to 2.0 mm, greater than or equal to about 2.5 mm, or greater than or equal to about 3.0 mm. In some embodiments, the width of the pre-impregnated tape is less than or equal to about 20.0 mm, less than or equal to about 15.0 mm, less than or equal to about 10.0 mm, less than or equal to about 8.0, less than or equal to about 6.0 mm, less than or equal to about 5.0 mm, or less. Combinations of the above ranges are possible, for example, in some embodiments, the width of the tape is greater than or equal to about 1 mm and less than or equal to about 20.0 mm. The tape may be wound on to a spool or cassette prior to being introduced to a tape receiver or routing mechanism. In one embodiment, a first roller is used to receive the tape.

In one embodiment, the systems and methods of the disclosure can be used with various fiber reinforced tows. A given tow includes M continuous fibers that are arranged within a carrier or matrix of the tow. The fibers in the tow can include any of the fibers disclosed herein and can have various cross-sectional geometries. Typically, each fiber in a tow has a substantially cylindrical cross-section and ranges from about 1 to about 20 micrometers in diameter. The number of fibers in a given tow is typically in the thousands (K). Accordingly, a 9K tow has approximately 9,000 fibers that are adjacent each other, disposed in a carrier/matrix and span the length of the tow or a given section thereof. Notwithstanding the foregoing, tows that include reinforcing fibers in the range of about 100 to about 1000 can be used with various system embodiments.

In one embodiment, the dimensions of a given workpiece, whether composite or composite core with FFF shell, range from about 10 mm to about 300 mm for each of height, width, and length)for a given workpiece. In one embodiment, build region of the systems disclosed herein will range from about 200 mm to about 300 mm in a given X, Y, or Z direction. In one embodiment, the build region will be about 300 mm (X)×about 200 mm (Y)×about 200 mm (Z).

The terms “about” and “substantially identical” as used herein, refer to variations in a numerical quantity that can occur, for example, through measuring or handling procedures in the real world; through inadvertent error in these procedures; through differences/faults in the manufacture of materials, such as composite tape, through imperfections; as well as variations that would be recognized by one in the skill in the art as being equivalent so long as such variations do not encompass known values practiced by the prior art. Typically, the term “about” means greater or lesser than the value or range of values stated by 1/10 of the stated value, e.g., ±10%.

For instance, applying a length of composite tape of about 12 inches to an element can mean that the composite tape is a length between 10.8 inches and 13.2 inches. Likewise, wherein values are said to be “substantially identical,” the values may differ by up to 5%. For instance, a strip of composite tape is a long rectilinear shape, both before and after the application of heat, even though applying heat can affect the shape of the composite tape. Whether or not modified by the term “about” or “substantially” identical, quantitative values recited in the claims include equivalents to the recited values, e.g., variations in the numerical quantity of such values that can occur, but would be recognized to be equivalents by a person skilled in the art. In various embodiments, tape segments maintain a substantially identical rectangular shape before and after processing in various embodiments subject to some minor variations as described herein.

The use of headings and sections in the application is not meant to limit the disclosure; each section can apply to any aspect, embodiment, or feature of the disclosure. Only those claims which use the words “means for” are intended to be interpreted under 35 USC 112, sixth paragraph. Absent a recital of “means for” in the claims, such claims should not be construed under 35 USC 112. Limitations from the specification are not intended to be read into any claims, unless such limitations are expressly included in the claims.

When values or ranges of values are given, each value and the end points of a given range and the values there between may be increased or decreased by 20%, while still staying within the teachings of the disclosure, unless some different range is specifically mentioned.

Throughout the application, where compositions are described as having, including, or that includes specific components, or where processes are described as having, including or that includes specific process steps, it is contemplated that compositions of the present teachings also consist essentially of, or consist of, the recited components, and that the processes of the present teachings also consist essentially of, or consist of, the recited process steps.

In the application, where an element or component is said to be included in and/or selected from a list of recited elements or components, it should be understood that the element or component can be any one of the recited elements or components and can be selected from a group consisting of two or more of the recited elements or components. Further, it should be understood that elements and/or features of a composition, an apparatus, or a method described herein can be combined in a variety of ways without departing from the spirit and scope of the present teachings, whether explicit or implicit herein.

The use of the terms “include,” “includes,” “including,” “have,” “has,” or “having” should be generally understood as open-ended and non-limiting unless specifically stated otherwise.

The use of the singular herein includes the plural (and vice versa) unless specifically stated otherwise. Moreover, the singular forms “a,” “an,” and “the” include plural forms unless the context clearly dictates otherwise. In addition, where the use of the term “about” is before a quantitative value, the present teachings also include the specific quantitative value itself, unless specifically stated otherwise.

It should be understood that the order of steps or order for performing certain actions is immaterial so long as the present teachings remain operable. Moreover, two or more steps or actions may be conducted simultaneously.

Where a range or list of values is provided, each intervening value between the upper and lower limits of that range or list of values is individually contemplated and is encompassed within the disclosure as if each value were specifically enumerated herein. In addition, smaller ranges between and including the upper and lower limits of a given range are contemplated and encompassed within the disclosure. The listing of exemplary values or ranges is not a disclaimer of other values or ranges between and including the upper and lower limits of a given range.

It is to be understood that the figures and descriptions of the disclosure have been simplified to illustrate elements that are relevant for a clear understanding of the disclosure, while eliminating, for purposes of clarity, other elements. Those of ordinary skill in the art will recognize, however, that these and other elements may be desirable. However, because such elements are well known in the art, and because they do not facilitate a better understanding of the disclosure, a discussion of such elements is not provided herein. It should be appreciated that the figures are presented for illustrative purposes and not as construction drawings. Omitted details and modifications or alternative embodiments are within the purview of persons of ordinary skill in the art.

It can be appreciated that, in certain aspects of the disclosure, a single component may be replaced by multiple components, and multiple components may be replaced by a single component, to provide an element or structure or to perform a given function or functions. Except where such substitution would not be operative to practice certain embodiments of the disclosure, such substitution is considered within the scope of the disclosure.

The examples presented herein are intended to illustrate potential and specific implementations of the disclosure. It can be appreciated that the examples are intended primarily for purposes of illustration of the disclosure for those skilled in the art. There may be variations to these diagrams or the operations described herein without departing from the spirit of the disclosure. For instance, in certain cases, method steps or operations may be performed or executed in differing order, or operations may be added, deleted or modified.

What is claimed is:

1. A method of fabricating a three-dimensional object, the method comprising:
transporting a first material, in a first state, the first material comprising a thermoplastic matrix and M reinforcing fibers, wherein the first material has a first cross-sectional profile;
depositing, heating, and consolidating a segment of the first material such that it is placed in a second state having a second cross-sectional profile; and
repeating the foregoing steps until a unitary composite object has been formed by M segments of the first material.

2. The method of claim 1, wherein voids or channels are limited by placing the M segments of first material such that the first and second cross-sectional profiles are majority of M segments are substantially identical.

3. The method of claim 1, wherein consolidation is performed to achieve a porosity of less than about 2%.

4. The method of claim 1, wherein a ratio of volume of the reinforcing fibers to matrix first material ranges from about 0.5 to about 0.7.

5. The method of claim 1, wherein M is less than about 300.

6. The method of claim 1 further comprising selecting a first temperature to be X % greater than a melting point temperature of a second material;
heating the second material to the first temperature; and
delivering, using a first nozzle, the heated second material to a print bed.

7. The method of claim 6, wherein the diameter of the first nozzle ranges from about 0.2 mm to about 6 mm.

8. The method of claim 6, wherein X % ranges from about 10% to about 30%.

9. The method claim 1, wherein consolidating the segment of the first material is performed using a roller, wherein the roller is positioned to receive heat from a heat source upon a first side of the roller, the method further comprising rotating the roller such that a second side is positioned to consolidate a segment of the first material.

10. The method of claim 9 wherein the second side of the roller is cooler than the first side of the roller when the second side initially contacts the first material.

11. The method of claim 1 further comprising:
forming, with an FFF-based applicator, a first support comprising one or more layers of a second material, the first support defines a first surface; and
forming, with an FFF-based applicator, a second support comprising one or more layers of a second material, the second support defines a top surface, wherein the unitary composite object is sandwiched between the first support and the second support.

12. The method of claim 1, wherein the first material is transported from a spool, through a bore and out from an applicator head, wherein the spool rotates about a spindle and about a first axis.

13. The method of claim 12, further comprising synchronizing rotation of spool and applicator head about the first axis.

14. The method of claim 1, wherein the second material is selected to resist deformation from consolidation of the first material relative to the second material, wherein a physical property measured in a first direction relative to the second material has a value that differs by an amount greater than P % when compared to the same physical property measured in a second direction relative to the second material.

15. The method of claim 14, wherein P is greater than about 10.

16. The method of claim 15, wherein a physical property measured in a first direction relative to the first material has a value that differs by an amount greater than Q % when compared to the same physical property measured in a second direction relative to the first material.

17. The method of claim 16, wherein Q is greater than about 10.

18. The method of claim 1 wherein depositing the segment of the first material of is performed relative to a print bed that receives one or more segments of the first material.

19. The method of claim 18 further comprising measuring changes in one or more of a consolidation force or a consolidation pressure relative to consolidation of first material by a roller.

20. The method of claim 19 further comprising adjusting position of roller or height of print bed relative to a region of the first material in response to measured consolidation force or a consolidation pressure deviating from a range of acceptable values.

21. The method of claim 19 further comprising adjusting position of roller or height of print bed to prevent gaps between a first segment of deposited first material and a second segment of the first material about to be deposited relative to the first segment.
